(19) United States
(12) Patent Application Publication
(10) Pub. No.: US 2004/0178634 A1
(43) Pub. Date: Sep. 16, 2004

(54) Power generating system of the gravity and leaf springs

(76) Inventor: Ashraf Makrm Eskandr, Newark, NJ (US)

Correspondence Address: Ashraf Makrm Dawoud Eskandr, Apt. # 24, 333 Park Ave., Newark, NJ, 07107, US

(21) Appl. No.: 10/386,539

(22) Filed: Mar. 13, 2003

(51) Int. Cl. H02P 9/04

(52) U.S. Cl. 290/1 R

(57) ABSTRACT

The present invention provides a power generating system by two equal weights and or leaf springs for driving a vehicle and AC generator. This system includes two levers are be suspended by an U-joint for each lever, so each lever is free to move reciprocally to up and down. A weight with or without leaf springs installed to the long arm of each lever. Upon the movement of long arm of one lever from up to down, the short arm of this lever imparts rotary motion to a gearbox having an automatic transmission mechanism for imparting kenetic energy to the second lever through a mechanical linkage for lift the second lever's long arm from down to up and so on the reciprocative movement of the two levers is continuous on the running of the system. Two arms with two ratchet means can be used instead of said two levers.

### CROSS REFERENCE TO RELATED APPLICATION

Not applicable.

### STATEMENT REGARDING FEDERALLY SPONSORED RESEARCH OR DEVELOPMENT

Not applicable.

### REFERRENCE TO A MICROFICHE APPENDIX

Not applicable.

### BACKGROUND OF THE INVENTION

The present invention to a mechanical system for generating rotary motion of the gravity and leaf springs. The said system converts the gravity and the force of the leaf springs to continuous rotary motion by two equal weights and two assemblages of the leaf springs to drive a car, an airplane, a ship, and to generate electric power with constant rate. The second objective of the said system is conversion the force of two assemblages of the leaf springs to rotary motion to drive an airplane, a car, and a ship instead of using any weights to be the said system having a right weight and great momentum. The third objective of the said system is conversion the gravity to rotary motion with constant rate by two equal weights to generate electric power.

The advantage of the present invention is creation a solution for the problem of the environmental pollution because the gasoline using which releases the element of the lead. The second advantage of the present invention is protection the human health because the atmospheric oxygen is be exhausted by increase the fuel using that causes ruin to the human respiratory system also CO2 which contributes in the global climatic change and formation unhealthful component of smog so the present invention is a critical solution to over come the problem of the pollution which is going up year after year and causes silent death. On the other hand the prior art can not performance a power generating system by the gravity having small size to be suitable to drive a small car or AC generator. Also the using nuclear power method can be used to generate considerable energy but the nuclear waste is hard to treat. The present invention is the first invention succeeded to convert the straining force of the leaf springs to rotary motion to drive an airplane.

Also the present invention is so safe for the following reasons, the fuel tank in any vehicle or an airplane is the biggest risk threatens the boarders if happened accident because the fuel tank will be changed to an incendiary bomb because of the sudden crash on the tank.

The second reason is because the customers in U.S.A. prefer use the natural gas for the household uses because of the prices of the natural gas are lower than the prices of the electricity but the most of the American houses are made of the wood therefore there are many of the fires happen every year because of using the natural gas in houses.

The present invention make possible building a vehicle having strong body to protect the boarders if happened accident and also to support the airplane with rescue sets as parachutes without increasing of the operating's cost specially U.S.A. imports about 56% of its daily consumption of the petroleum. It will create new businesses which are impossible be set up by the oil price, which are going up.

### THE BRIEF SUMMARY OF THE INVENTION

An objective of the present invention is to provide a system having a small size to convert the gravity and the straining of the leaf springs to rotary motion to drive a vehicle and an airplane or generating an electric power.

Another objective of the present invention is to provide a system can convert the straining of the leaf springs to rotary motion to be the said system having right weight and great momentum to be fit to drive an airplane.

The further objective of the present invention is to provide a system for generating rotary motion without environmental pollution.

In accordance with the present invention, the present invention having three designs. The system's first design comprises, two identical levers each lever is be suspended by an U-joint to be the both long and short arms of each lever are free to move to up and down in form of reciprocative movement. Two equal weights, each weight is installed on the long arm of a lever. One additional lever or more than one can be installed with each essential lever and these additional levers are optional for increase the system's torque. The body of the system. A gearbox having an automatic transmission mechanism for regulation the reciprocative movement of the both two levers. A rockshaft interconnecting the gearbox with two drive pulleys which are installed on the other end of the said rockshaft. A working shaft. Two chains interconnecting the said two drive pulleys and the said two long arms of the two levers. An electric starter having a battery. An alternator gets rotary motion from a drive pulley is installed on the working shaft for engaging the battery of the electric starter. A worm installed on the long arm of each lever by two bearings. An U-joint for suspension each lever to be the distance between the point of the suspension and the system's base is about one foot or suitable distance. Two connecting rod, to convert the reciprocative motion of the short arm of each lever to rotary motion of the crankshaft which is installed to the said gearbox. The said two weights are identical and may be of any suitable size and kind and each weight is installed on the long arm of a lever and because of each lever is be suspended by an U-joint so the long arm with the weight of each lever are free to move to up and down. The distance of the reciprocative movement of the both two long arms not more than 40% of the length of the long arm of each lever. Upon the descent of one weight with the long arm of a lever to down the short arm of the same lever moves from down to up as an arciform movement and for imparting this arciform movement, the short arm of each lever is jointed with the lower end of a connecting rod and the upper end of the said connecting rod is installed with a crank journal of the crankshaft which is installed to the said gearbox for conversion the arciform movement of the lever's short arm to rotary motion of the crankshaft. The rotary motion of the said crankshaft will be imparted to the gearbox and the said gearbox having an automatic transmission mechanism for imparting kenetic energy to any weight reached to the system's base for lifting it from down to up and the said kinetic energy will be imparted from the said automatic transmission mechanism to the said weight by a rockshaft, a drive pulley is mounted on the end of the said rockshaft, and a chain interconnecting the said drive pulley with the long arm which is bearing the said weight. Upon lifting one weight from down to up, the second weight is descendant from up to down and the said automatic transmission mechanism is the regulator of the reciprocative movement of the both two weights to up and down. The kinetic energy of the gearbox is be imparted to a vehicle or an AC generator by a working shaft for utilization the said momentum for useful work. An additional lever or lever, can be used with each essential lever this idea is optional for increasing the system's momentum. The said additional levers are interconnected with each other and with the essential lever by transfer linkages. The two essential levers each one of them having a worm is installed on the lever by two bearings and the said worm is engaging with one weight and each worm is be rotated by a boom for increase or decrease the distance between the said weight and the suspension's point of the lever for controlling to the system's momentum. The system's body having a base for installation the said gearbox and two stands each one of them having U-joint for suspension the said two levers and an alternator. The system's body consisting of a vertical post is installed on the system's base for bearing an horizontal bar having two pulleys one of them is installed on its right end and the second pulley is installed on its left end. A chain having one end is mounted on a rockshaft's drive pulley and the said chain is trained on the said right pulley of the said horizontal bar and the second end of the said chain is installed to the said right lever's long arm for lifting the said right lever's long arm from down to up by the rotation of the rockshaft's drive pulley upon the dropping of the long arm of the left lever to down and there is a second chain interconnecting the second drive pulley of the said rockshaft with the left lever's long arm and this chain is trained on the said left pulley of the said horizontal bar for lifting the said left lever's long arm from down to up during this time the right lever's long arm is descendant from up to down. Two guiding devices each one of them consisting of a rectangular frame is installed on the system's base for limitation the reciprocative movement of the long arm of the lever upon its movement to up and down. A braking device is installed on the gearbox's body and a brake disk is installed on the said crankshaft for stop the system's work. A flywheel is installed on the said working shaft for stabilizing the system's momentum. A ring gear is installed on the said flywheel for imparting kinetic energy of the pinion gear of the electric starter upon the beginning of the system's work and after the system started, the operator turns the starter off for disengagement the pinion gear of the electric starter and the flywheel's gear. The first step to start the system's work, the two weights are be slided into the free end of the long arm of the both two levers by a boom or manual mechanism to rotate the both two worms which are engaged with the two weights.

The second step, the operator turns on the electric starter's switch to engage the starter's pinion gear with the flywheel's gear for imparting kinetic energy of the said electric starter to the gearbox through the said flywheel and the working shaft, after the system started, the operator turns of the starter's switch.

On the work, the kinetic energy of the said starter which is be imparted to the said gearbox will rotate the rockshaft to unwind the chain which interconnecting one drive pulley with the left long arm if the left weight with the left lever's long arm are having the upper extreme position or the said rockshaft will rotate to the opposite direction if the left lever's long arm having lower extreme position and the right lever's long arm having upper extreme position because the automatic transmission mechanism which inside the said gearbox is the regulator of the rockshaft's rotary direction. On the descent of the right lever's long arm to down must be the left lever's long arm is be lifted to up by the rotation of the said rockshaft and the short arm of the right lever will push to up the crank journal of the said crankshaft by the connecting rod to rotate the said crankshaft and on the distance between the said right weight and the system's base is about one inch or a suitable distance, the rotary direction of the said rockshaft will be turned to the opposite rotary direction by the automatic transmission mechanism and because of the said two chains which are interconnecting the said two drive pulleys of the rockshaft with the two long arms of the two levers, this interconnection through a coil spring for each chain so during the right weight is descendant to down, the left coil spring which is interconnecting the left chain and the left lever's long arm will be extended about one inch or a suitable distance by the straining of the left chain and this coil spring is gauged to extend one inch or a suitable distance upon the straining of the said chain is equal to three times of the total weights which include the said weight plus the weight of the long arm of the lever or levers in case of a plurality of the additional levers are be utilized so the short arm of the left lever will drive the crank journal to down by the left connecting rod which interconnecting the U-joint of the left lever's short arm and the crankshaft so the real momentum which drives the working shaft is equal to three times the weight which drives the right lever's long arm to down. The operator to stop the system, there is a brake is installed on the said gearbox and a brake disk is installed on the said crankshaft and also to stop the system, the said two worms can be used by the operator for sliding the said two weights toward, the two suspension points of the two levers.

The second design of the present invention comprises, two levers each one of them is suspended with an U-joint to be the long arm of each lever is free to move to up and down with reciprocative movement upon the work of the system. Two identical weights each one of them is installed on a long arm of a lever. One worm is installed on the long arm of each lever and the said worm having approximately the same length of the said long arm or the lever or little shorter than the length of the long arm of the lever and the said worm is engaged with the said weight which is installed on the long arm of the lever for changing the distance between the said weight and the suspension point of the lever by using a boom for rotation the said worm. An U-joint for suspension each lever to be the distance among the point of the suspension and the system's base about one foot or a suitable distance. Two identical leaf springs each one of them having acute angle one of them is installed to the long arm of the left lever by one end and its other end is installed to the stand of suspension the said lever, the second leaf spring is installed to the long arm of the right lever by one end and its other end is installed to the stand of the right lever's suspension and the said two leaf springs for driving the long arms of the both two levers from up to down and also to prevent the shaking of the long arm of each lever to up during the work of the vehicle. One additional lever or more can be used with each essential lever for increase the system's momentum. The system's body consisting of a base for installation the two levers and there are two vertical posts are installed on the system's base for bearing a horizontal post and four pulleys are installed on the said horizontal post and two pulleys are installed on the system's base. Two identical arciform gears one of them is installed on the free end of the short arm of a lever and the second arciform gear is installed on the short arm of the second lever and the said two arciform gears for conversion the arciform reciprocative movement of the short arm of each lever to rotary motion of the working shaft of the system's gearbox through a gear is engaged with the arciform gear and the said gear is be interconnected with the said working shaft by a ratchet mean for rotation the working shaft to one rotary direction only on the movement of the short arm of the lever from down to up and the second arciform gear of the second lever is also engaged with a gear is interconnected with the said working shaft by a ratchet device for rotation the said working shaft to one direction only. A gearbox having a working shaft for imparting the arciform movement of the both two short arms of the two levers and convert the said arciform movement to rotary motion by the said two gears which are interconnected with the said working shaft by a ratchet mean for each gear and there is a brake is installed on the body of the said gearbox and a brake rotary member is installed on the said working shaft for stop the system or controlling to the vehicle's speed also the said gearbox having an automatic transmission mechanism for regulation the reciprocative movement of the both two long arms of the two levers to be a long arm of a lever is descendant to down must be the long arm of the second lever is be lifted to up and this kinetic energy is be imparted of the said gearbox to the two long arms of the two levers by two rockshafts. Two rockshafts one of them is installed on the right side of the said gearbox for imparting rotary motion of the said gearbox to a drive pulley which is installed on the end of the said rockshaft and the said drive pulley is interconnected with the long arm of the left lever by a chain having two branches for each end, one branch of the right end of the said chain is fixed to the said drive pulley and this branch coils on the said right drive pulley on its rotation for lifting the long arm of the left lever from down to up by one branch of the left end of the said chain on the descent of the said right weight from up to down, the second rockshaft is installed on the left side of the said gearbox for imparting the rotary motion of the said gearbox to a drive pulley installed on the end of the said rockshaft for rotation the said drive pulley to coil one branch of the left end of the said chain round the said left drive pulley for lifting the long arm of the right lever to up during the descent of the left lever's long arm to down and there is an automatic transmission mechanism inside the said gearbox for regulation the rotary motion and the rotary direction of the both two drive pulleys because the two pulleys rotate opposite to each other because of the both two long arms of the two levers are moving reciprocally opposite to each other so during the right weight is descendant from up to down the left weight is be lifted from down to up. The said chain its right part is trained on the right pulley which is installed on the system's base and the right end having two branches, one branch is trained on one pulley which is installed on the said horizontal bar and also it's trained on a pulley is installed on the system's base and this branch is interconnected with the said right drive pulley of the said right rockshaft and the second branch of the chain's right end is trained on the second right pulley which is installed on the said horizontal bar and the free end of the second branch is fixed with the free end of the right lever's long arm and the left end of the said chain having two branches, one of them is trained on one pulley which is installed on the horizontal bar and the free end of the said branch is fixed on the long arm of the left lever and the second branch is trained on the second left pulley which is installed on the horizontal bar and also trained on a pulley is installed on the system's base and it's interconnecting with the said left drive pulley which is installed on the left rockshaft of the said gearbox and the said chain having four branches for lifting to up any long arm of a lever which reached to the system's base during the long arm of the other lever is descendant to down by the gravity and the straining of the said leaf spring.

On the work, this design of the present invention does not need electric starter for starting its work like the first design. The first step to start the system's work, the braking device is be used to wedge into the brake disk by the operator so the brake disk can not be rotated. The said right ratchet device which is installed on the said working shaft of the gearbox having a small handle is used for change the work of the said ratchet device to be the said ratchet device can rotate the said working shaft to the both two rotary directions on the stop of the system so before the system starts its work must be the said small handle is be rotated by the operator for change the work of the right ratchet mean to be the said ratchet mean can rotate the said working shaft to one direction only, the same work of the left ratchet mean. The third step to operate the system, the braking shoes are be withdrawn off the braking disk gradually to start the system its work. At the beginning of the system's work, the long arm of the left lever having upped extreme position and the long arm of the right lever having lower extreme position so the long arm of the left lever with the left weight descend to down by the gravity so the left arciform gear which is installed on the short arm of the left lever moves an arciform movement from down to up to drive the said left gear which is interconnected with the said working shaft by a ratchet device for rotation the working shaft which impart rotary motion to the automatic transmission mechanism inside the said gearbox for imparting rotary motion of the said automatic transmission mechanism to the left rockshaft for rotation the left drive pulley to coil one branch of the chain's left end round the said left drive pulley for training the said two right branches of the said chain, one branch of them to lift the long arm of the right lever to up and the second branch of the chain's right end dive the said right drive pulley to rotate to the reverse rotary direction than that of the said left rockshaft because the said automatic transmission mechanism disimpart the rotary motion to the right rockshaft during the long arm of the left lever is descendant from up to down. One inch or a suitable distance before the long arm of the left lever reaches to the system's base must be the long arm of the right lever with the right weight reached to the upper extreme position and also they started the movement from up to down by the gravity because the said automatic transmission mechanism is designed to impart rotary motion to the both two rockshafts before the end of the effective stroke of one lever and on the beginning of the effective stroke of the second lever for stabilizing the system's momentum and for continuation the running of the system, for this reason the said chain having a coil spring at its middle and this coil spring is be gauged to extend two inches or a suitable distance upon the training of the said chain is equal to three times the total weights which effect on the long arm of any lever include the said weight and the weight of the long arm of the lever and the force of the leaf spring which is installed on the long arm of the lever and the stand of the lever's suspension. Upon the reaching of the left lever's long arm to the system's base, the rotary motion of the left rockshaft is be disimparted by the said automatic transmission mechanism and at the same time the said automatic transmission mechanism is still imparting a rotary motion to the right rockshaft so the said right drive pulley which is installed on the right rockshaft rotates to train one branch of the chain's right end for training the both two left branches of the chain for lifting the long arm of the left lever to up and driving the said left drive pulley which is installed on the left rockshaft to be rotating to the reverse rotary direction than that of the said right rockshaft for unwinding a branch of the left end of the said chain. After the system operated, the said working shaft imparts kenetic energy to a load such as a machine of a car. Also in the second design of the present invention, two arms can be used instead of the said two levers and one end of each arm is be interconnected with the said working shaft by a ratchet mean for rotation the said working shaft to one direction only upon the movement of the free end of the said arm from up to down but on the lifting of the said free end from down to up the said working shaft remain stationary and each arm having a weight and assemblage of the leaf springs for dropping the free end of the arm to down and each arm having a worm is engaged with the said weight and on the rotation of the said worm manually by a boom the said weight slides on the said arm to change the distance between the weight and the end of the said arm which is installed on the said ratchet mean for controlling to the system's momentum. For stop the system, the braking device can be used by the operator for stop the rotation of the working shaft and the operator turns the small handle of the right ratchet mean for change the rotary direction of the working shaft to be the said ratchet device can rotate the said working shaft to the both two directions so the said working shaft remain stationary after the operator leave the pedal of the braking device.

The third design of the present invention is similar the second design in the following parts.

A gearbox. A braking device. Two levers or two arms. Two worms. Two arciform gears if two levers are be used instead of two arms. Two ratchet means. Two weights and or two assemblages of leaf springs.

The third design of the present invention is different than the second design in the following. The body of the third design having two posts are installed on the system's base, one of them is installed on the right beside the free end of the long arm of the right lever or the right arm if an arm is used instead of a lever and the second post is installed on the left beside the free end of the left lever's long arm. Two pulleys one of them is installed on the top of the said right post and the second pulley is installed on the top of the said left post. A chain fixed on the pulley of the right rockshaft by one end and the second end of this chain is fixed with the long arm of the right lever and the said chain is trained on the said pulley which is installed on the said right post for lifting the long arm of the right lever from down to up upon the rotation of the said right drive pulley of the right rockshaft upon the descent of the long arm of the left lever from up to down and the second chain fixed on the said left drive pulley of the left rockshaft by one end and its second end of the said chain is fixed on the long arm of the left lever and the said chain is trained on the said pulley which is installed on the top of the left post for lifting the long arm of the left lever from down to up upon the descent of the long arm of the right lever from up to down. Two coil springs, one of them is connecting the end of the right chain with the long arm of the right lever and the second coil spring is connecting the end of the left chain with the long arm of the left lever and each coil spring is gauged to extend one inch or a suitable distance on the straining of the chain is equal to three times the total weights which effect on the long arm of the lever plus the force of the leaf spring which is installed on the long arm of the lever by one end and its second end is installed on the stand of the lever's suspension and the both two coil springs for making sure that any long arm of a lever on its movement from down to up must reaches to the upper extreme position for remaining the distance between the upper extreme position and the lower extreme position is steady upon the work of the system and this distance is about 40% of the long arm of the lever and because the two levers having equal length so the distance of the reciprocative movement of the both two long arms of the two levers is equal. Two guiding devices each one consisting of a rectangular frame is fixed on the said post and the said two guiding devices for protection the two long arms of the two levers and also for limitation the reciprocative movement of the both two levers or arms if two arms are be used instead of the said two levers and a ratchet mean interconnecting the said arm with the working shaft of the gearbox instead of the arciform gear method. For example as practical application of the present invention if the power generating system of the gravity and leaf springs is be used for operating a bus and this bus having the same length and width of the usual bus, will be the said system having one additional lever with each essential lever this mean there are two levers for each weight and the length of the long arm of each lever is about 15 feet and each weight plus the weight of the long arm are are 300 LBS. and the force of the leaf spring is equal to the weight of 100 LBS. This mean the total powers which effect on the part of the long arm of each additional lever are equal to the weight of 400 LBS. The length of the short arm of each lever is about five inches. The additional lever generates momentum of the weight which is dropping from up to down equal to 400,000 LBS. and the essential lever generate momentum equal to a weight of 4,000,000 LBS., about seven thousands horsepowers but in case of a connecting rod is be used to impart the reciprocative movement of the short arm of the lever and conversion this reciprocative movement to rotary motion of the crankshaft of the gearbox instead of the arciform gear method for generation horsepowers three times more than the arciform gear method because when one weight is descendant to down the second weight is lifted to up by the chain with momentum equal to three times more than that of the weight of the descendant weight so the momentum of the said system will be about 21 thousands horsepowers while the engine of the usual bus is about 800 to 1000 horsepowers so the momentum of the said system is enough to drive a big bus and also it make possible building a bus having a strong body to protect the boarders if happened accident.

The distance of the movement of the long arm of each lever is about two feet and all levers will be at the left hollow wall of the bus, under the left window of the bus or the said levers or arms are installed in the first floor of the bus and the second floor for the boarders so the high of the said bus is increased about 2½ feet than that of the usual bus. If two arms and two assemblages of the leaf springs each one of them is installed to an arm for driving the said arm to down instead of the said weight to be this system having the same size of the usual bus's engine and the said two arms their length about three feet and this method is suitable for building a truck. The bus's speed is be controlled by three methods,

The first method is using the system of the present invention for generation electric power and using this electric power for running an electric motor to drive the said bus so be this easy method the speed of the said bus or truck can be controlled by an electric device.

The second method by using a gearbox and a clutch, so the operator can select the desire speed and this gearbox having five speeds,

The first speed 5 miles/H. The second speed 20 miles/H.

The third speed 50 miles/H. The fourth speed 80 miles/H.

The fifth speed 120 miles/H.

The said worm of each lever can be used to decrease the distance between the said weight and the lever suspension to decrease the speeds of the said gearbox. For example will be the speeds of the said gearbox as following,

The first speed 2 miles/H. The second speed 10 miles/H.

The third speed 25 miles/H. The fourth speed 40 miles/H.

The fifth speed 60 miles/H. So the operator can adjust the speeds of the said gearbox according to his desire.

The third method to control the bus's speed, by using a hydraulic device.

### BRIEF DESCRIPTION OF THE SEVERAL VIEWS OF THE INVENTION

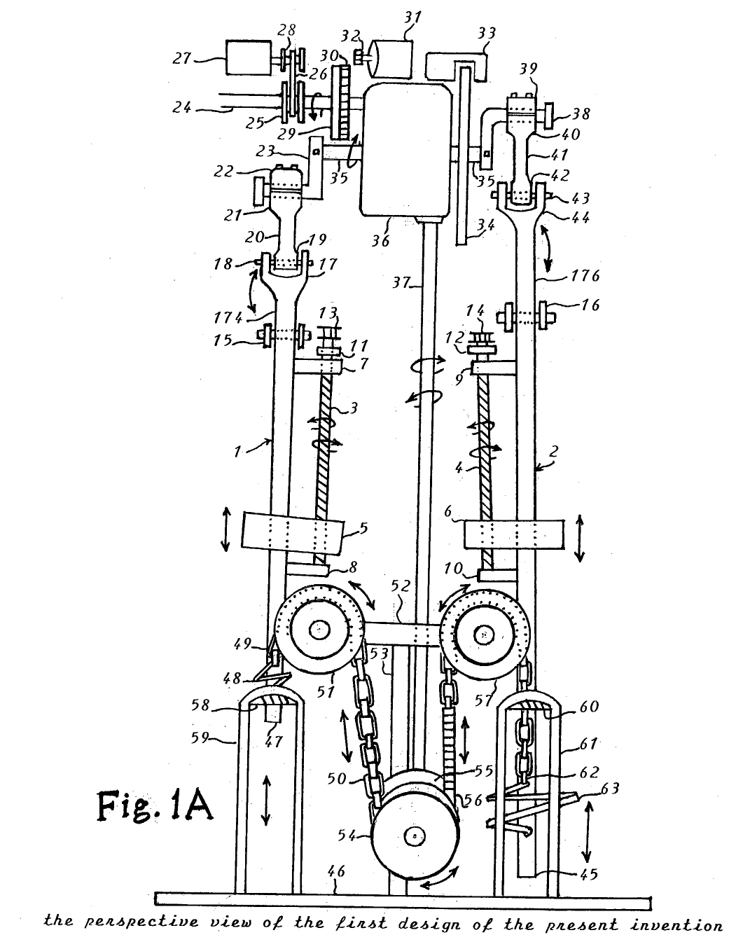

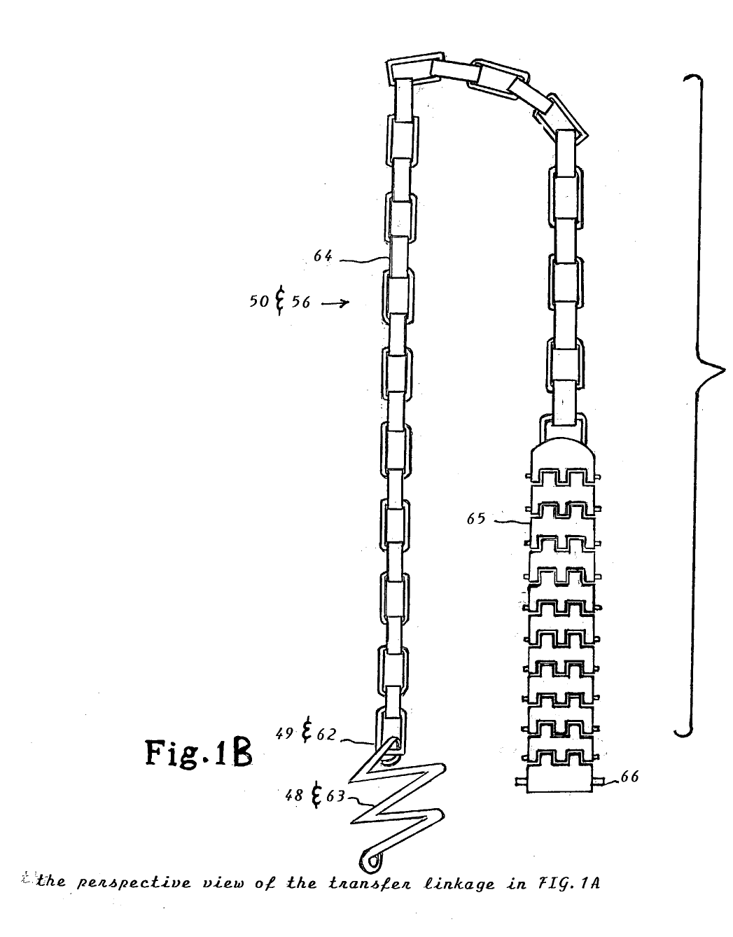

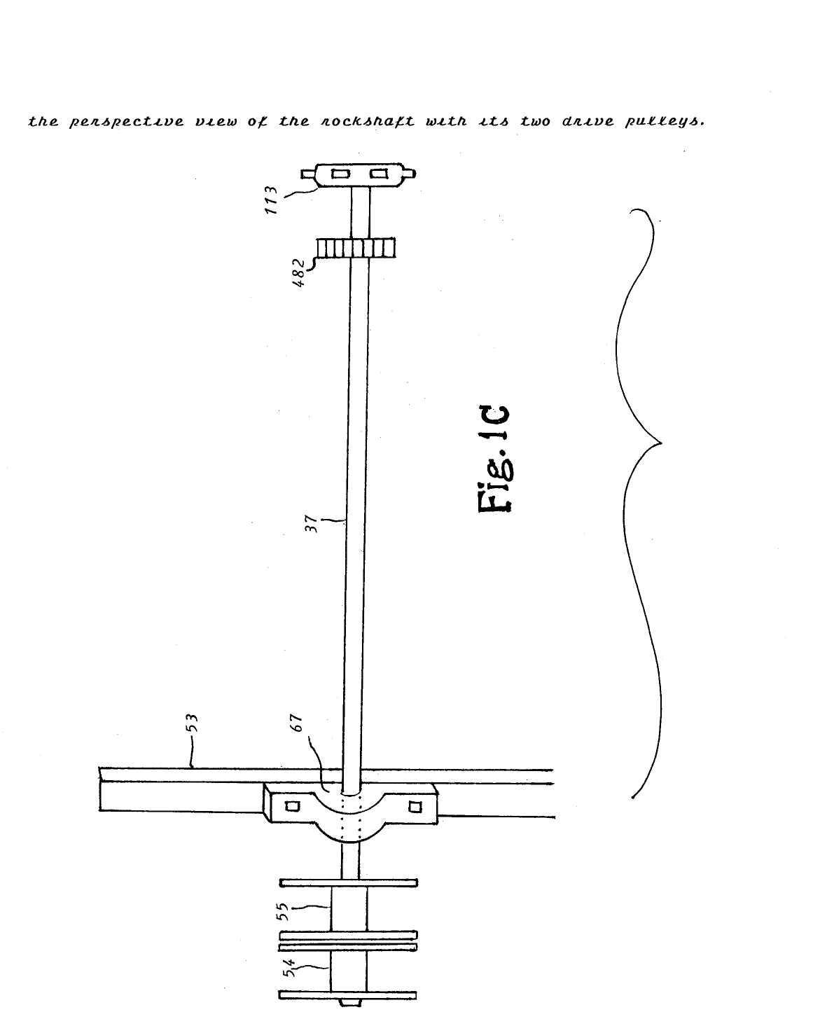

FIG. 1a—is a perspective view of the first design of the power generating system of the gravity and leaf springs.

FIG. 1b—is a perspective view of the transfer linkage in FIG. 1a.

FIG. 1c—is a perspective view of the rockshaft with its two drive pulleys in FIG. 1a.

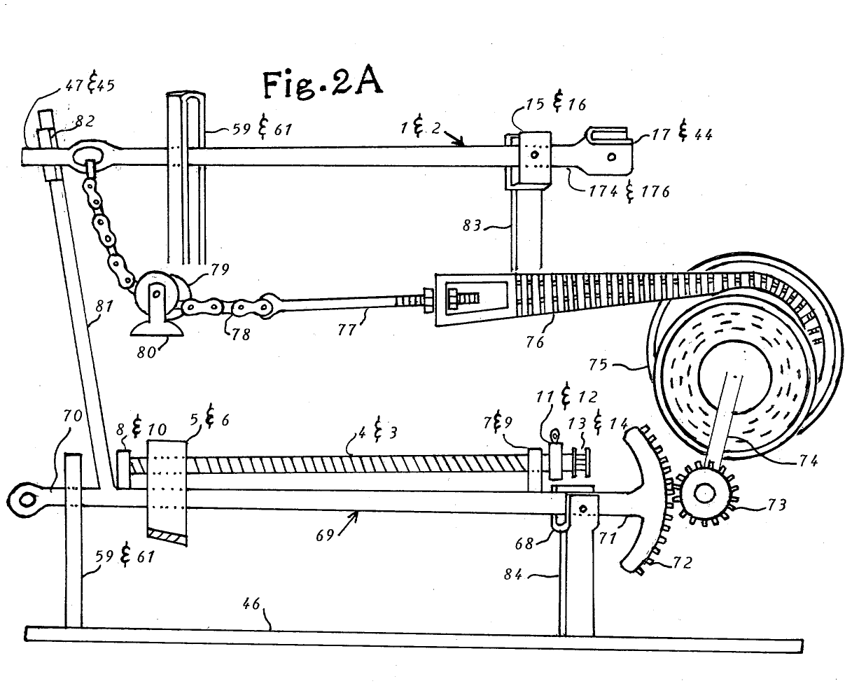

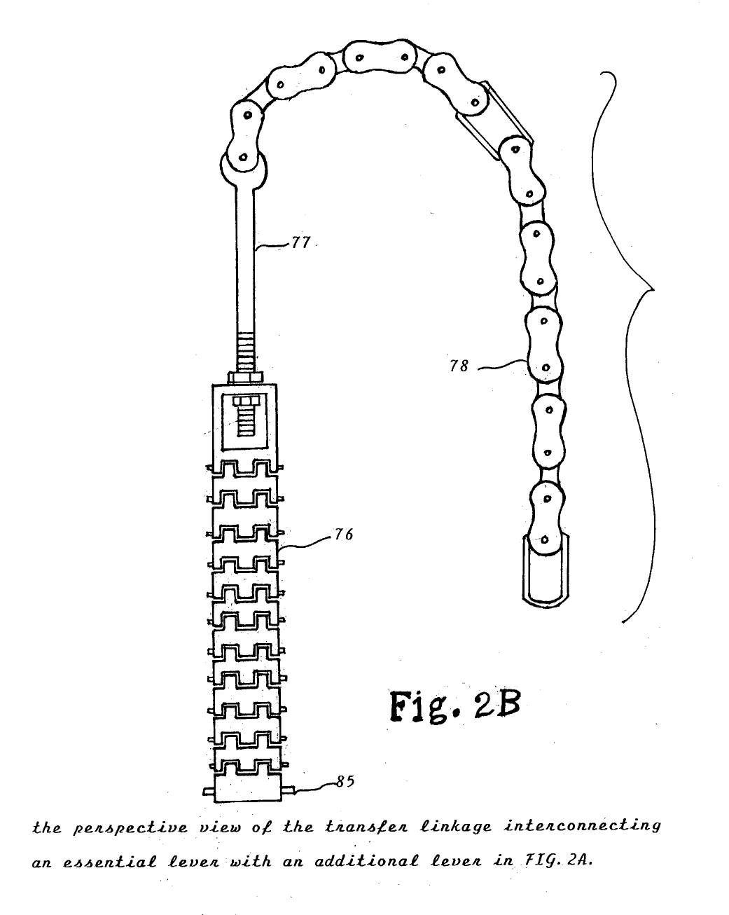

FIG. 2a—is a perspective view of an additional lever is be interconnected with an essential lever by a transfer linkage.

FIG. 2b—is a perspective view of the transfer linkage among an essential lever and an additional lever in FIG. 2a.

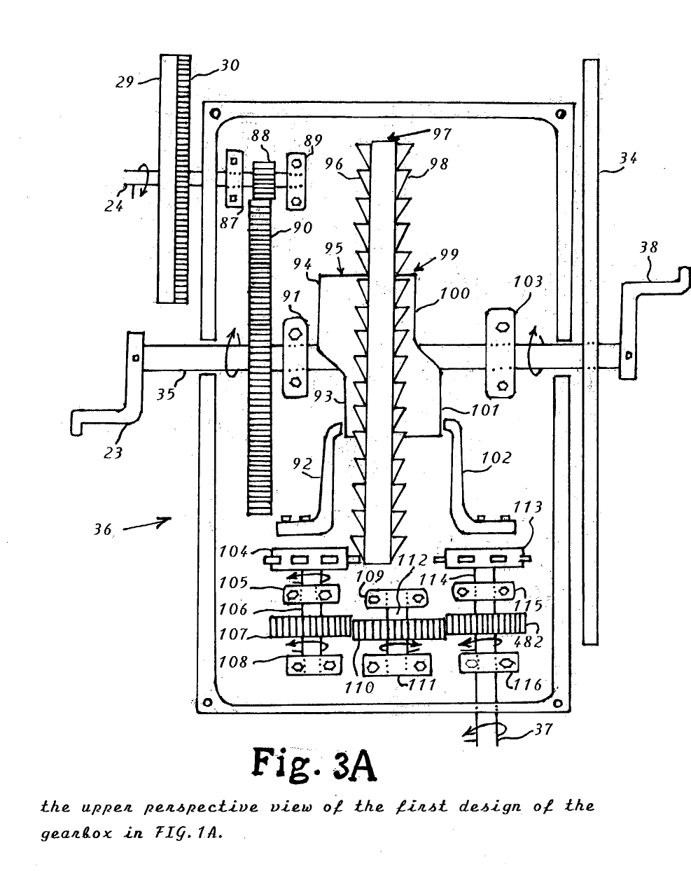

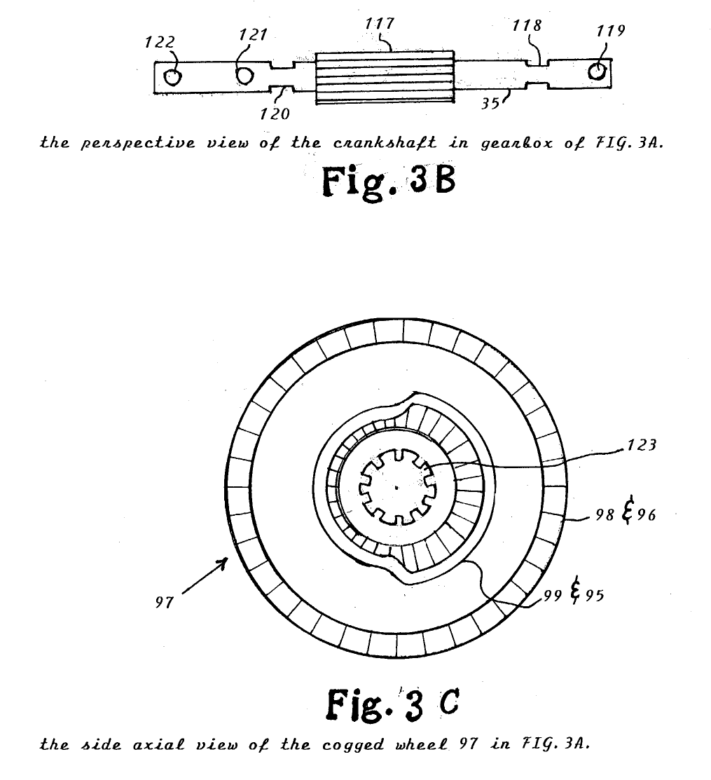

FIG. 3a—is the upper perspective view of the first design of the gearbox in FIG. 1a.

FIG. 3b—is the perspective view of the crankshaft of the gearbox in FIG. 3a.

FIG. 3c—is the side, axial, perspective view of the automatic transmission gear in FIG. 3a.

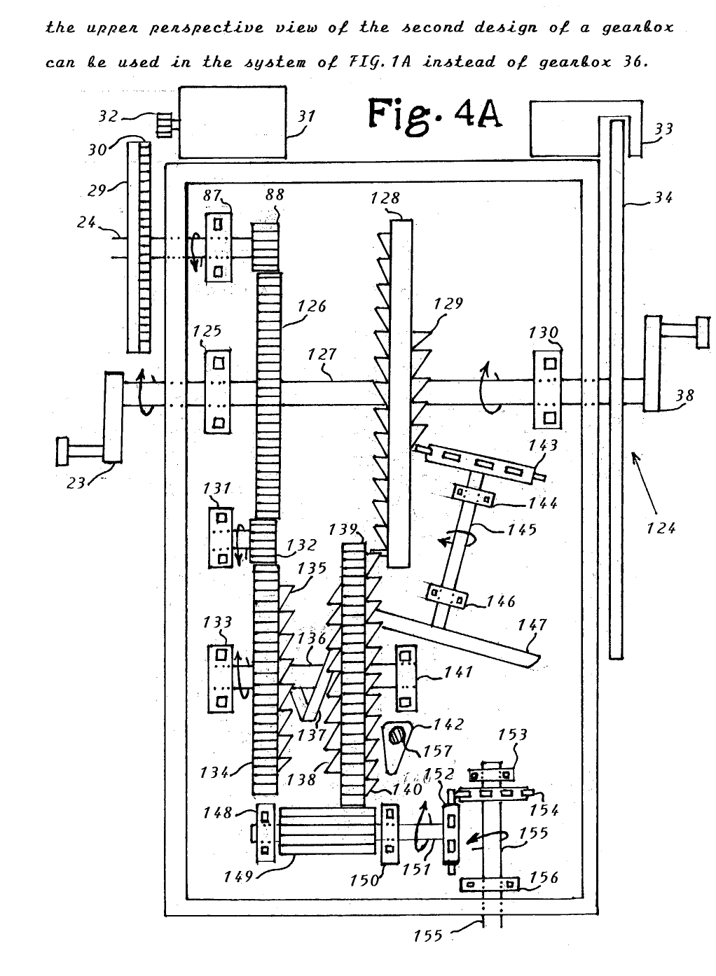

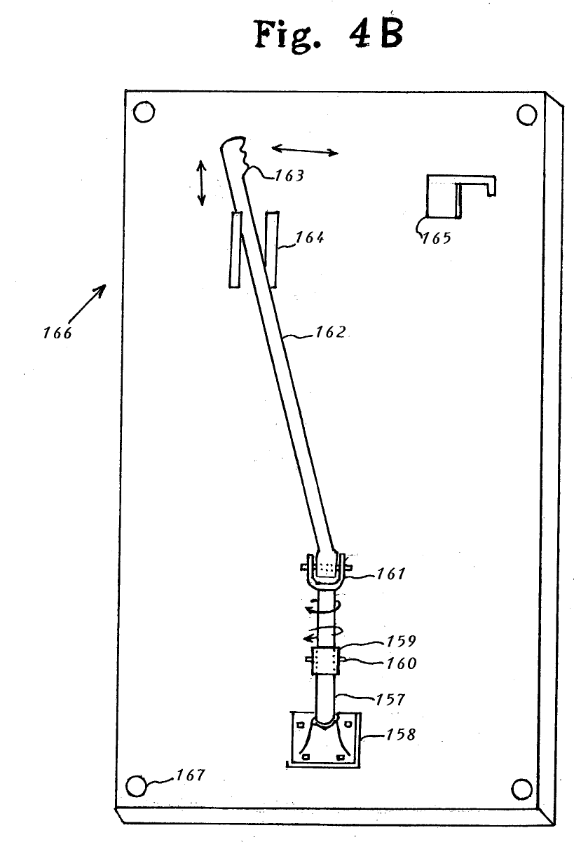

FIG. 4a—is the upper perspective view of the second design of a gearbox can be used in FIG. 1a instead of gearbox of FIG. 3a.

FIG. 4b—the perspective view of the upper cover of the gearbox in FIG. 4a.

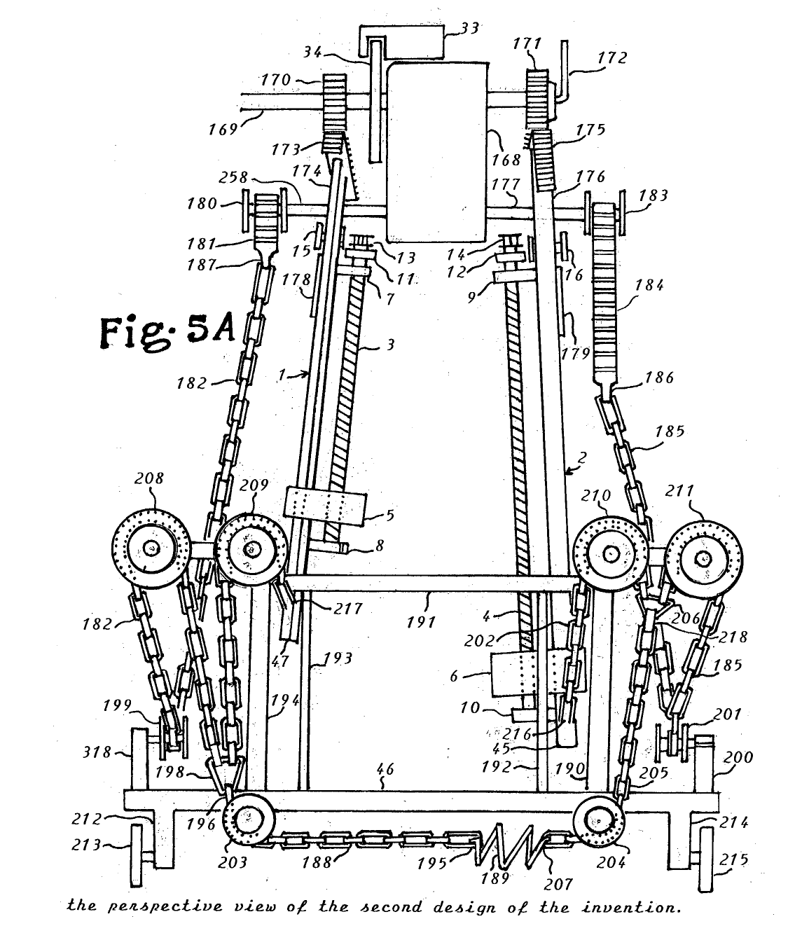

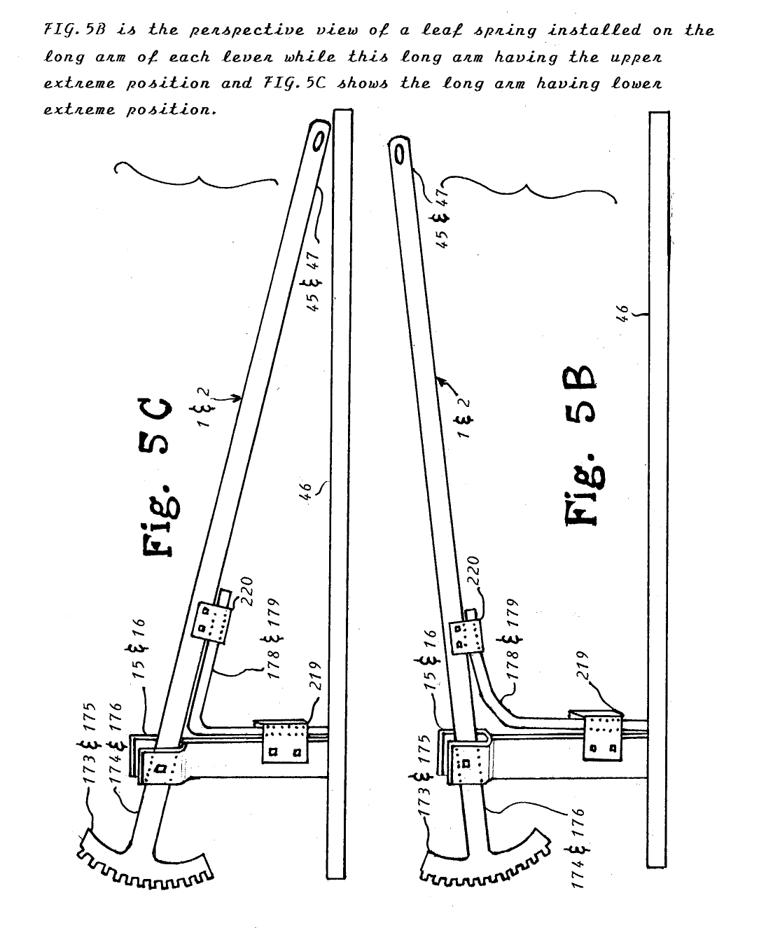

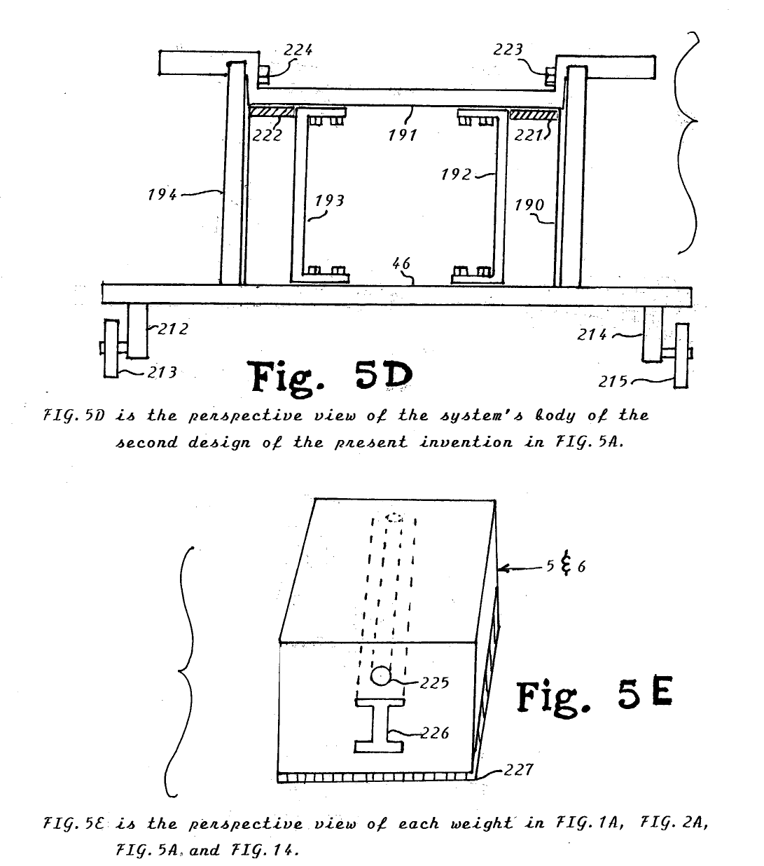

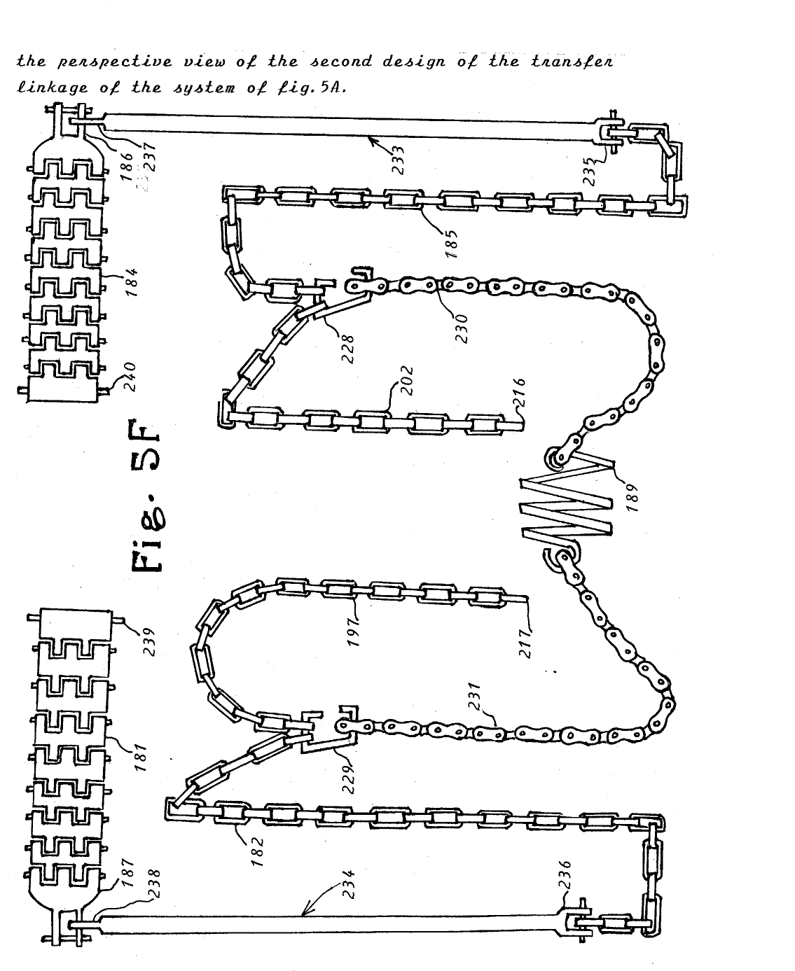

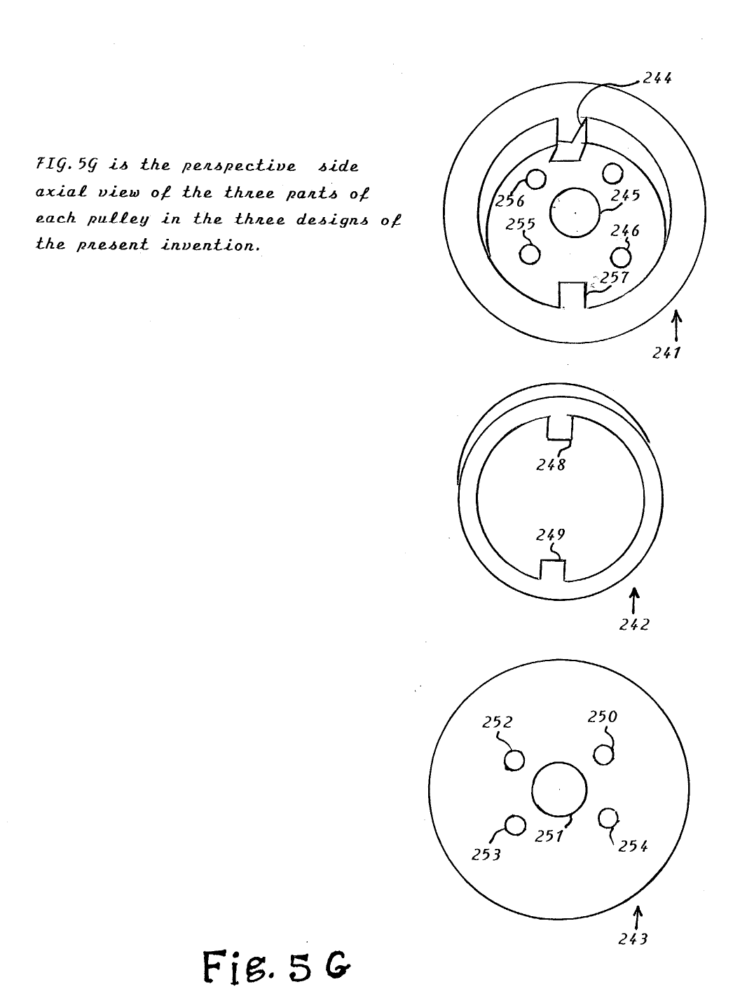

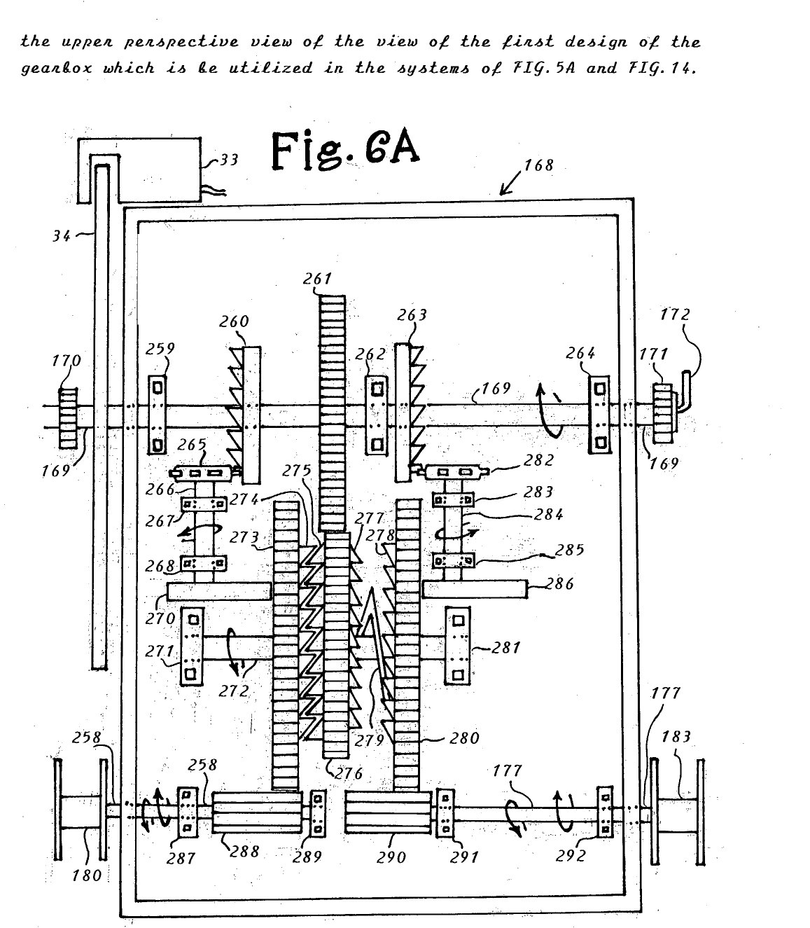

FIG. 5a—is the perspective view of the second design of the present invention.

FIG. 5b—is the perspective view of a leaf spring is installed on the long arm of each lever while this long arm having upper extreme position.

FIG. 5c—is the perspective view of the leaf spring in FIG. 5b while the long arm of the lever having the lower extreme position.

FIG. 5d—is the perspective view of the system's body of the second design of the present invention in FIG. 5a.

FIG. 5e—is the perspective view of each weight in FIG. 1a, FIG. 2a, FIG. 5a and FIG. 14.

FIG. 5f—is the perspective view of the second design of the transfer linkage of the system in FIG. 5a.

FIG. 5g—is the perspective view of the three parts of each pulley in the three designs of the present invention.

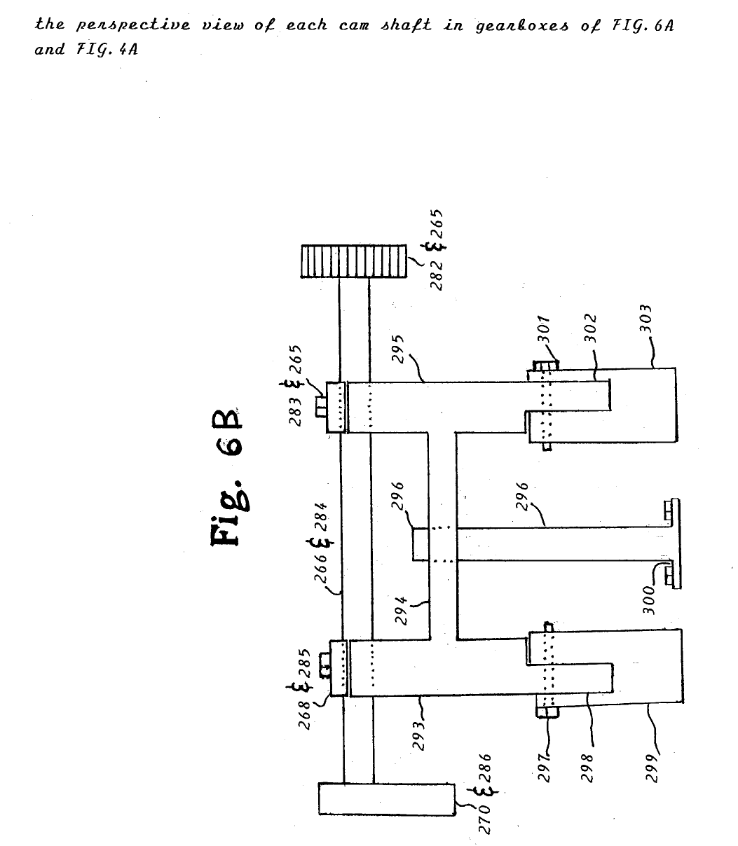

FIG. 6a—is the upper perspective view of the first design of a gearbox can be used in the systems of FIG. 5a and FIG. 14.

FIG. 6b—is the perspective view of the cam shaft with its components in gearbox of FIG. 6a.

FIG. 6c—is the plan view of a ring is installed in gearbox of FIG. 6a and gearbox of FIG. 4a.

FIG. 6d—is the side axial view of the two cams in gearbox of FIG. 6a.

FIG. 6e—is the perspective view of a coil spring having two end plate, and this spring is installed in gearbox of FIG. 4a and FIG. 6a.

FIG. 6f—is a side axial view of an end plate of the coil spring in FIG. 6e.

FIG. 7—is the perspective view of the cogs of some gears in gearboxes of FIG. 3a, FIG. 4a and FIG. 6a.

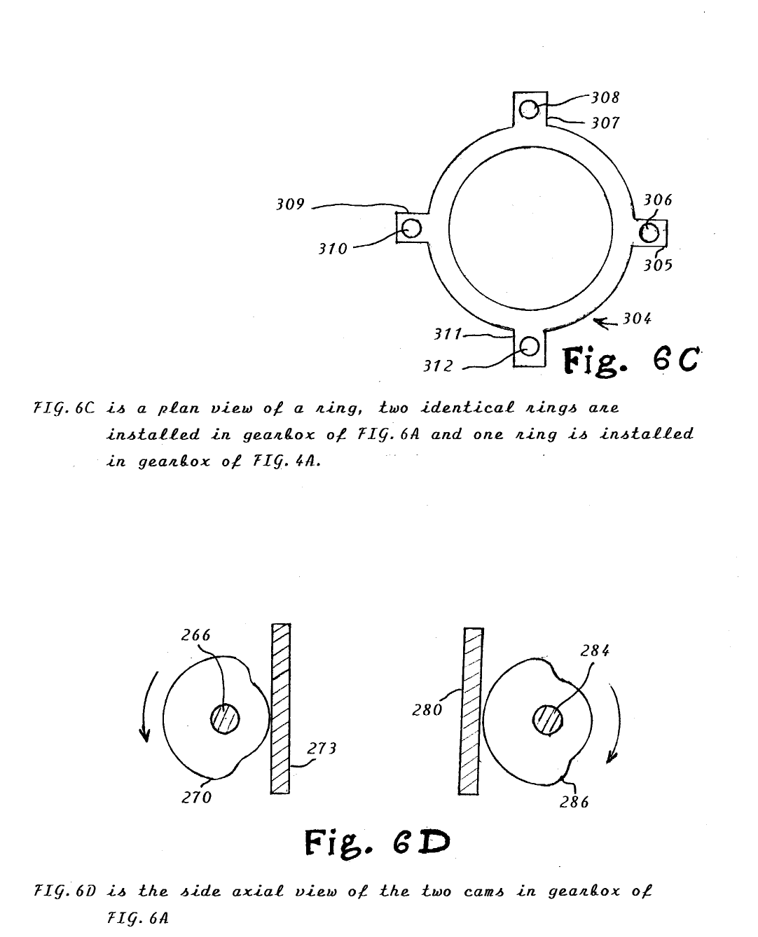

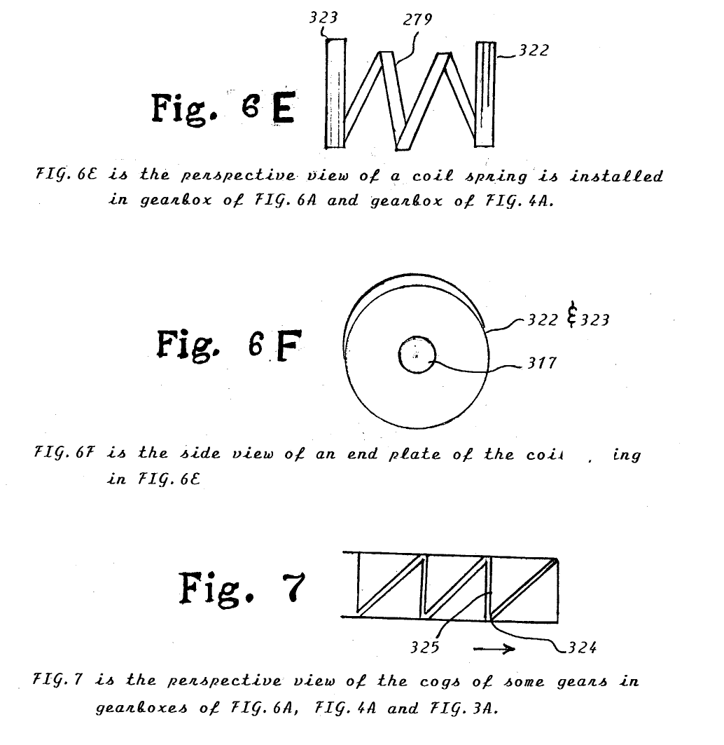

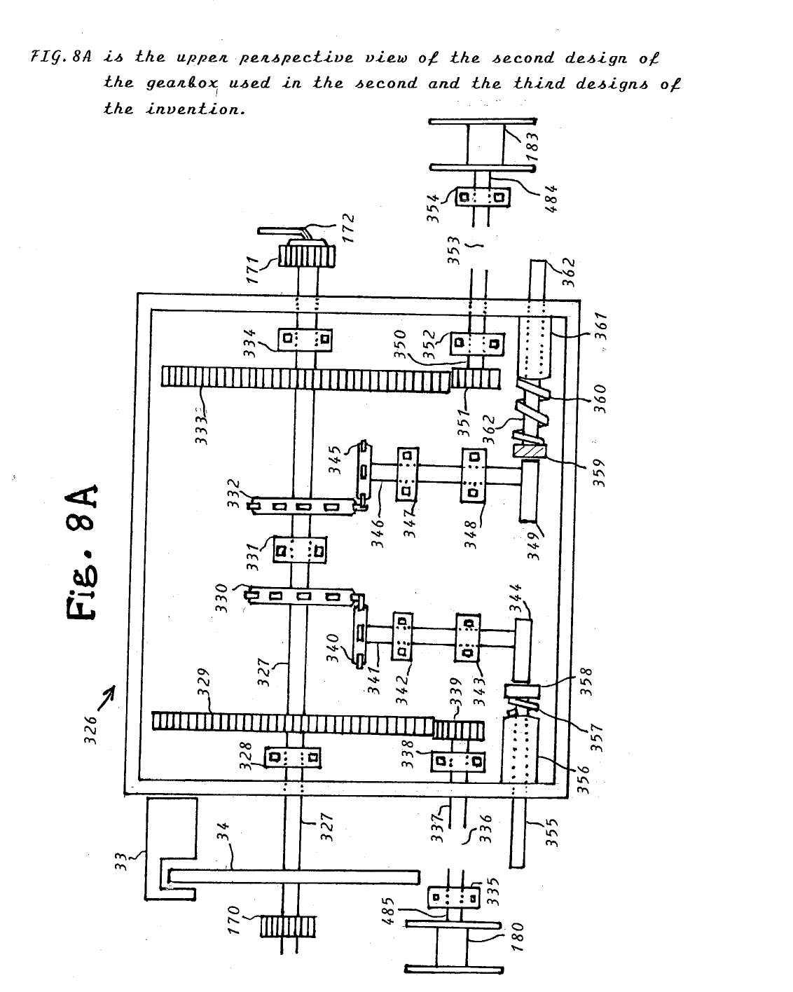

FIG. 8a—is the upper perspective view of the second design of the gearbox which installed in the second and the third designs of the present invention in FIG. 5a and FIG. 14.

FIG. 8b—is the perspective view of a plate is installed on each cam plate in FIG. 8a.

FIG. 9a—is a view of two straining leaf springs can be used for driving the long arm of each lever to down.

FIG. 9b—is a perspective view of the leaf springs can be used with or without weight to descend the long arm of the lever to down.

FIG. 9c—is the perspective view to show six leaf springs can be used with the weight which is installed on the long arm of the lever.

FIG. 10—is the perspective view to show that each lever may be having different shape according to the general form of the vehicle's body.

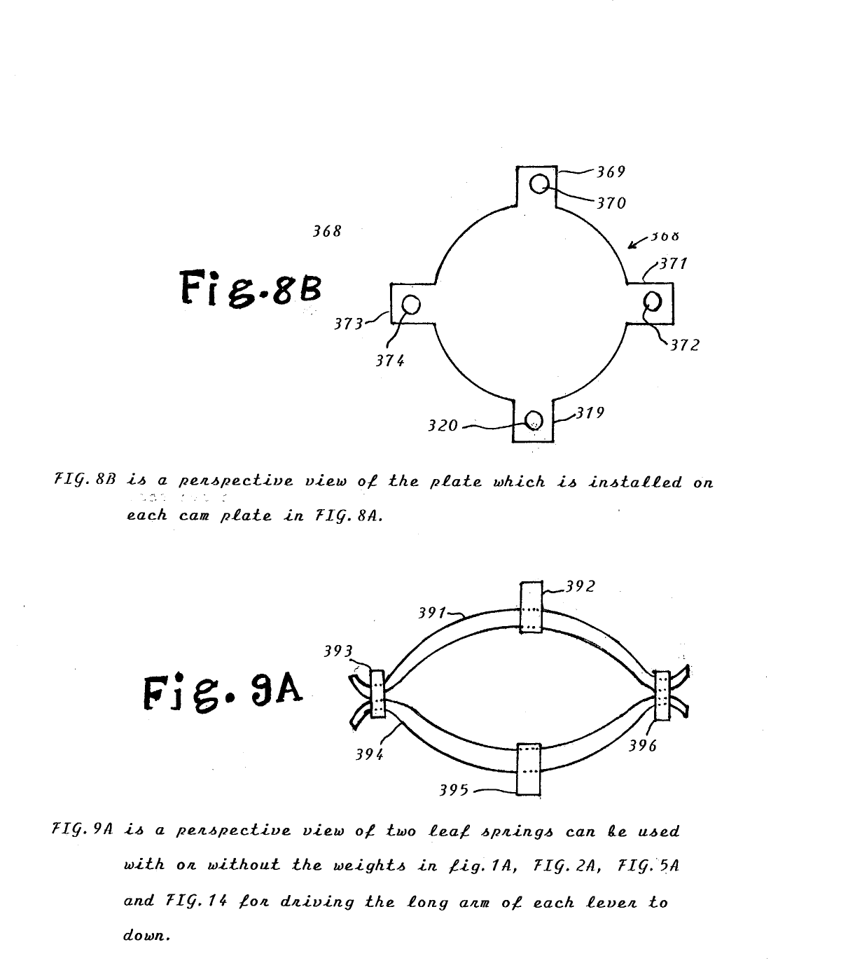

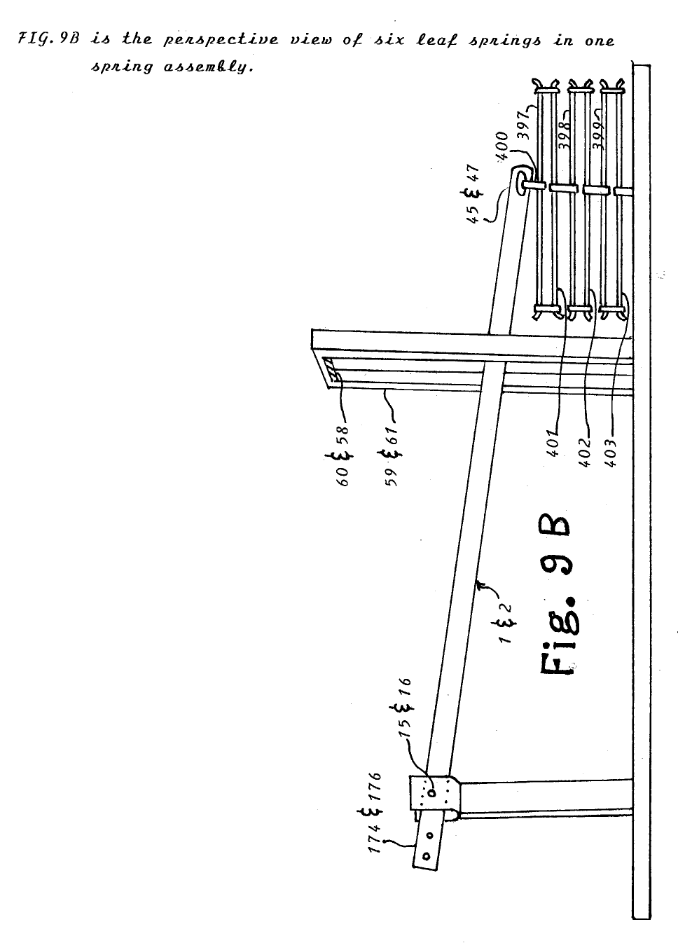

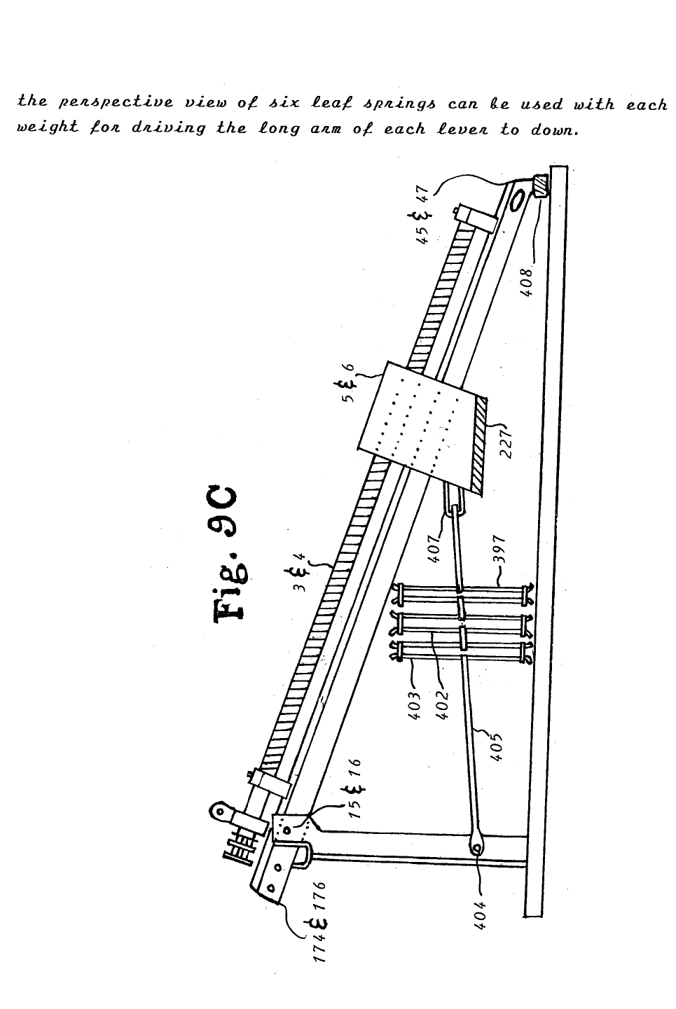

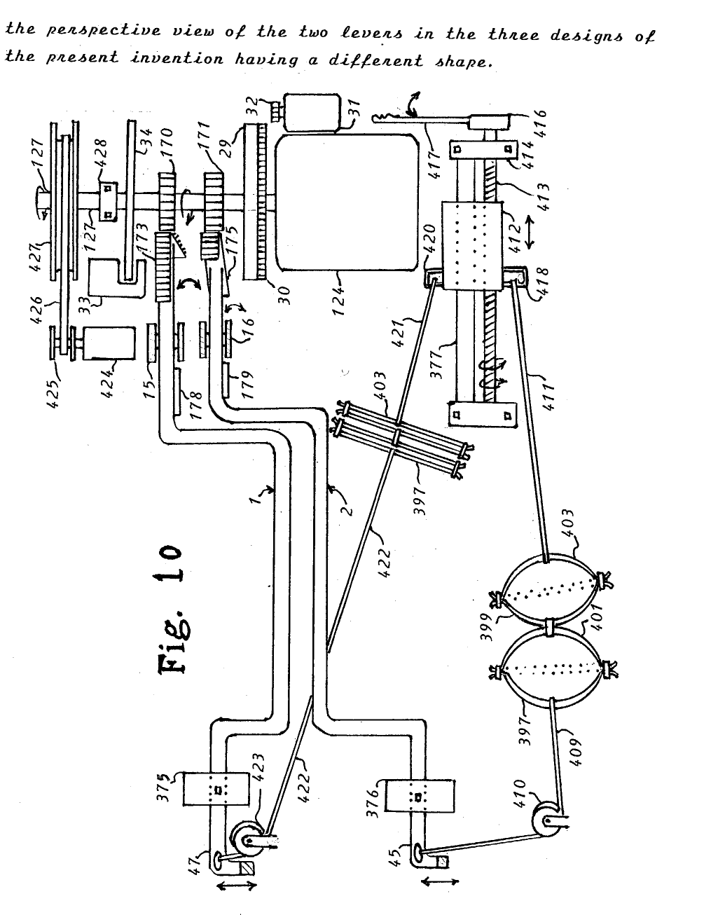

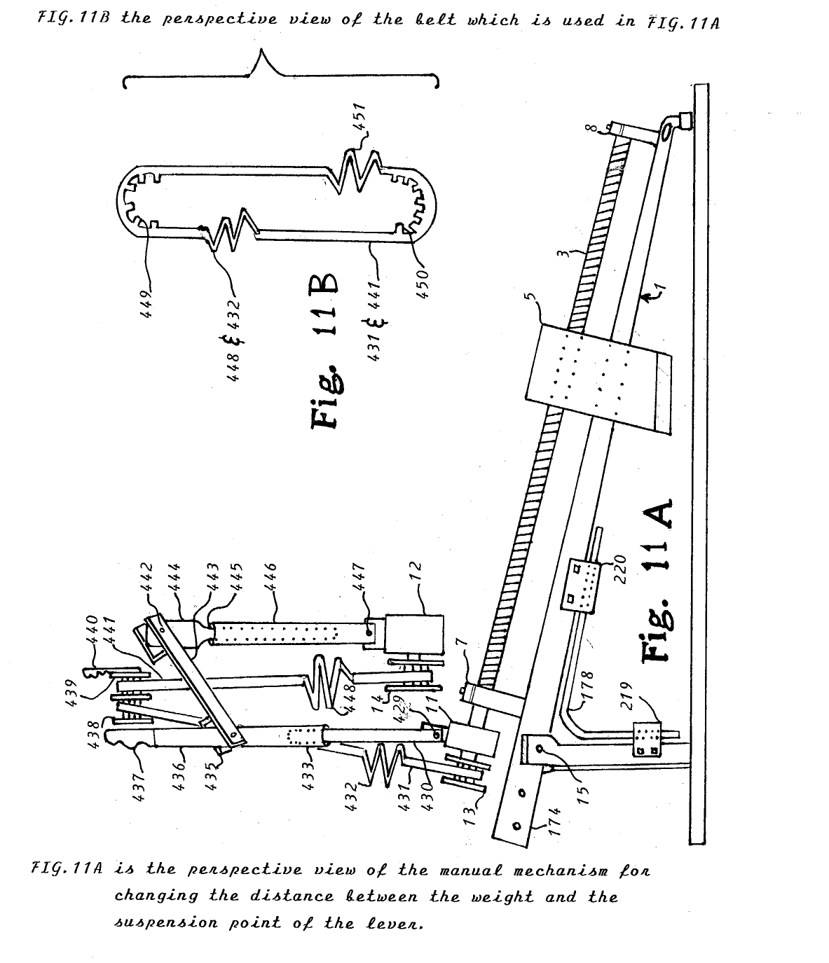

FIG. 11a—is the perspective view to show the mechanism for change the distance between the weight and the suspension point of the lever.

FIG. 11b—is the perspective view of the belt which is used in the mechanism of FIG. 11a.

FIG. 12—is the perspective view of the two arms can be used instead of two levers in the systems of FIG. 5a, FIG. 10 and FIG. 14.

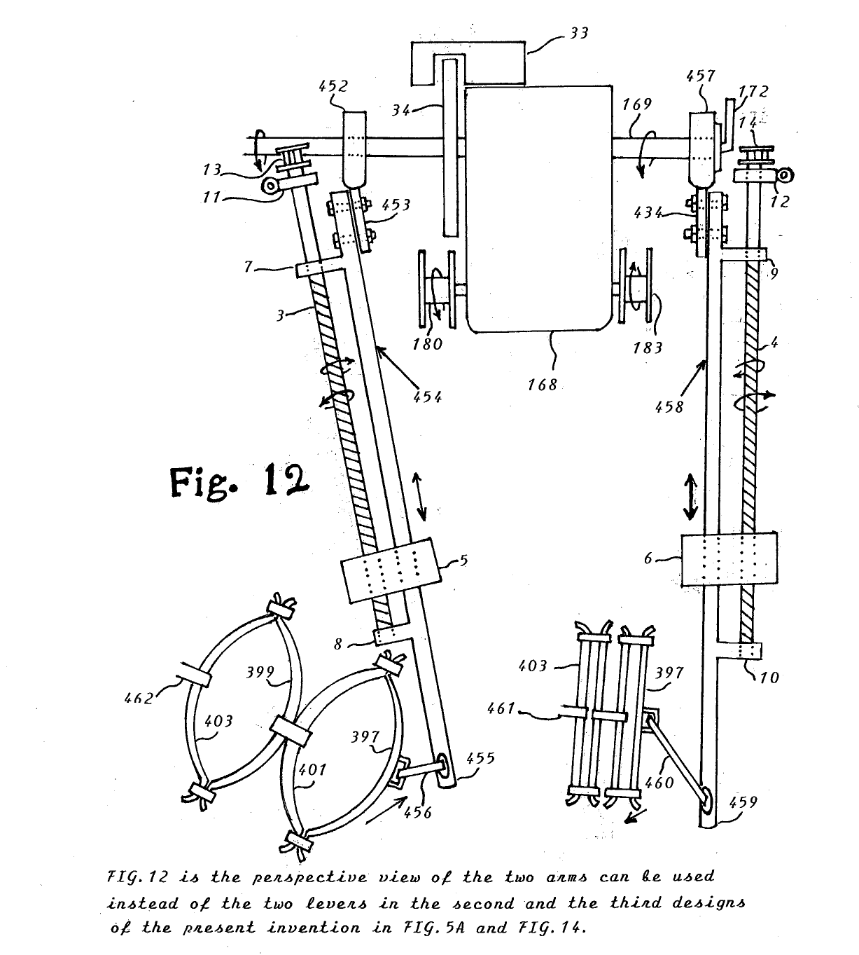

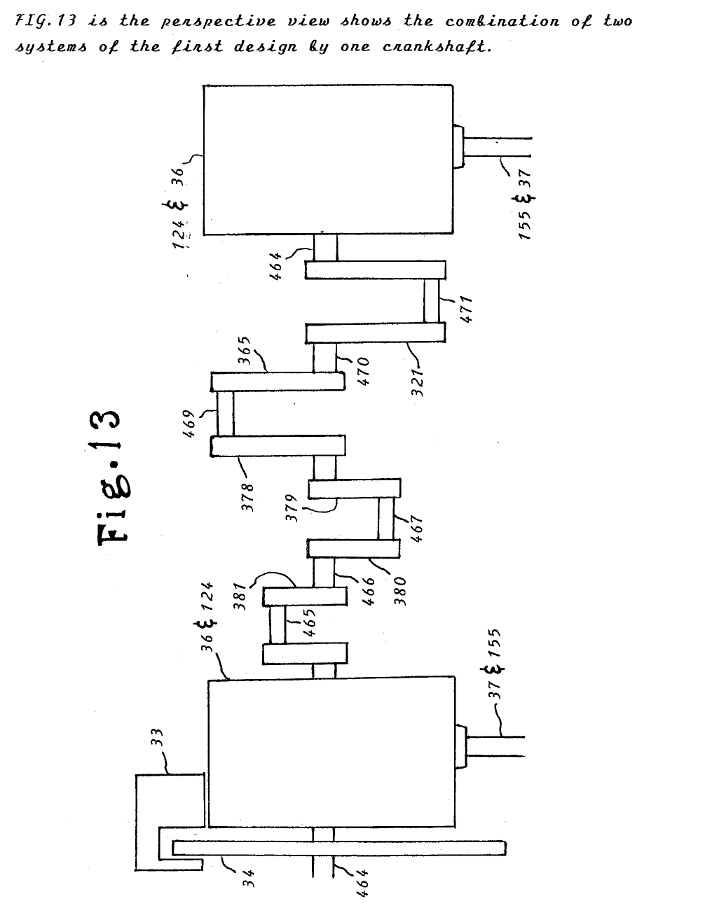

FIG. 13—is the perspective view of two systems of the first design in FIG. 1a can be combined together by one crankshaft.

FIG. 14—is the perspective view of the third design of the present invention.

### DETAILED DESCRIPTION OF THE INVENTION

Referring to FIG. 1a,

FIG. 1a is a perspective diagram shows the parts of the first design of the power generating system of the gravity and leaf springs according to the present invention includes. Two identical levers, lever 1 and lever 2. Two identical worms, worm 3 and worm 4. Two identical weights, weight 5 and weight 6. Two bearings 7 and 8 for installation worm 3 on lever 1. Two bearings 9 and 10 for installation worm 4 on lever 2. U-joint 15 for suspension lever 1. U-joint 16 for suspension lever 2. Short arm 174 of lever 1. Short arm 176 of lever 2. Long arm 47 of lever 1. Long arm 45 of lever 2. U-joint 17 is installed on the short arm 174 of lever 1. U-joint 44 is installed on the short arm 176 of lever 2. Ratchet mean 11 is installed on the worm 3 for rotation the said worm 3 by a boom as the mechanism of FIG. 11a shows for change the distance between weight 5 and the suspension point by U-joint 15 of lever 1 for controlling to the system's momentum. Gear 13 for change the rotary direction of worm 3 by ratchet mean 11 as FIG. 11a shows. Gear 14 for change the rotary direction of worm 4 by a ratchet mean 12 as FIG. 11a shows. Lever 1 is suspended by U-joint 15 to be the distance between the suspension point of lever 1 and the system's base about one foot or a suitable distance so the long arm 47 and the short arm 174 of lever 1 are free to move to up and down with reciprocative movement. Lever 2 is suspended by U-joint 16 to be the distance between the suspension point of lever 2 and the system's base about one foot or a suitable distance so the long arm 45 and the short arm 176 of lever 2 are free to move to up and down with reciprocative movement. Guiding device 59 is a rectangular frame is installed on the system base for limitation the movement of the long arm 47 and to protect the long arm 47. Guiding device 61 is a rectangular frame having the same size of the guiding device 59 and the both two guiding devices their length not more than 40% of the length of the long arm 47 or the long arm 45 to be the said system generates powerful momentum and the said guiding device 61 for limitation the reciprocative movement of the long arm 45 and also for protection the long arm 45 of lever 2. Rubber pad 58 acts as silencer. Rubber pad 60 acts as silencer and the both two rubber pads 60 and 58 are identical. Connecting rod 20 interconnecting the U-joint 17 with the crank 23 for conversion the reciprocative movement of the short arm 174 to rotary motion of the crankshaft 35 which imparts this rotary motion to the gearbox 36. Cup 22 for installation the upper end 21 of the connecting rod 20 with the crank 23 of the crankshaft 35. Pin 18 for fixing the lower end 19 of connecting rod 20 with the U-joint 17. Connecting rod 41 interconnecting the U-joint 44 with the crank 38 of crankshaft 35 for conversion the reciprocative movement of the short arm 176 of lever 2 to rotary motion of crankshaft 35 which imparts this rotary motion to the gearbox 36. Pin 43 for installation the lower end 42 of the connecting rod 41 with U-joint 44. Cup 39 for installation the upper end 40 of connecting rod 41 with crank 38. Crankshaft 35 is installed to gearbox 36 for imparting the rotary motion of crank 23 and crank 38 to gearbox 36. Gearbox 36 having automatic transmission mechanism as FIG. 3a shows for imparting rotary motion from the said crankshaft 35 to rockshaft 37 which impart rotary motion to drive pulleys 55 and 54 which are installed on the end of rockshaft 37 and they are driven to be rotating by rockshaft 37. Vertical post 53 is installed on the system's base for bearing the horizontal post 52. Pulley 57 is free to rotate to the both two directions and it is installed on the right end of the horizontal post 52 and chain 56 is trained on pulley 57 and also 57 having a rubber frame is installed on the pulley 57 as FIG. 5g shows for prevention the noise. Pulley 51 is installed on the left end of the horizontal post 52 and pulley 51 is free to rotate into the both two directions and chain 50 is trained on pulley 51 and pulley 51 having a rubber frame as FIG. 5g shows for prevention the noise on the operation of the system. The vertical post 53 having a bearing for installation the rockshaft 37 as FIG. 1c shows. Chain 56 is be fixed on pulley 55 by one end and the second end 62 is fixed to one end of a coil spring 63 and the second end of coil spring 63 is fixed on the long arm 45 of lever 2 and chain 56 lifts 45 to up upon the descent of long arm 47 to down, on the rotation of drive pulley 55 which is installed on rockshaft 37 to the rotary direction thereby chain 56 coils round drive pulley 55 to lift the long arm 45 to up and on the rotation of drive pulley 55 to the opposite rotary direction the chain 56 uncoil to let long arm 45 and weight 6 descend to down by the gravity and because the drive pulley 54 is coaxially mounted with drive pulley 55 so during the drive pulley 55 is rotating to any direction also drive pulley 54 is rotating to the same direction for lifting the long arm 47 to up by chain 50 which coil round drive pulley 54. Upon the lifting of long arm 47 to up by chain 50 the coil spring 48 extends about one inch or a suitable distance upon the training of chain 50 is equal to three times the total weights which drive the long arm 47 to down and upon the distance between long arm 47 and rubber pad 58 is one inch or a suitable distance and the distance between long arm 45 and the system's base 46 is one inch or a suitable distance the said automatic transmission mechanism inside gearbox 36 change the rotary direction of rockshaft 37 to the reverse direction so the both two drive pulleys 55 and 54 rotate to the opposite direction so chain 50 and coil spring 48 slack to let the long arm 47 descend to down and chain 56 is be trained by drive pulley 55 to coil round pulley 55 for lifting the long arm 45 to up for reverse the movement of the both two long arms 45 and 47 on the running of the system. The system's base 46. End 49 of chain 50 connecting a chain 50 with a coil spring 48. End 62 of chain 56 is connecting the chain 56 with a coil spring 63. Braking device 33 is installed on the body of the gearbox or on the system's base 46 and brake disk 34 is mounted on the crankshaft 35 and the both two braking device 33 and braking disk 34 for stop the system. Electric starter 31 is installed on the body of gearbox 36 or on the base 46 of the system. Pinion gear 32 of an electric starter 31. Ring gear 30 is installed on the flywheel 29. 32 engages with ring gear 30 of flywheel 29 for starting the work of the system and after the system started, the operator must turns the electric starter off so the pinion gear 32 disengage off ring gear 30. Flywheel 29 is mounted on working shaft 24 for stabilizing the momentum inertia of the working shaft 24. Working shaft 24 for imparting rotary motion of gearbox 36 to a vehicle or a machine for utilizing this kinetic energy to useful work. Drive pulley 25 mounted on working shaft 24 for imparting rotary motion of working shaft 24 to the pulley 28 of alternator 27 by a drive belt 26. Alternator 27 for charging the battery of the electric starter 31.

On the operation, the first step for running the system, the operator must turns the electric starter on so the pinion gear 32 engage with ring gear 30 for imparting rotary motion to crankshaft 35 and rockshaft 37 through working shaft 24 and gearbox 36 as FIG. 3a shows and the rotary direction of rockshaft is according to the position of the both two long arms 47 and 45, if the long arm 47 having the upper extreme position and the long arm 45 having the lower extreme position so the automatic transmission mechanism inside gearbox 36 rotates rockshaft 37 to the rotary direction thereby unwinding the chain 50 off drive pulley 54 for descent a long arm 47 from up to down by the gravity, U-joint 17 moves from down to up, connecting rod 20 imparts the movement of U-joint 17 to crank 23 for rotation crankshaft 35 and also drive pulleys 55 and 54 rotate to the same rotary direction so chain 56 coil round drive pulley 55 for lifting the long arm 45 from down to up for movement the short arm 176 and U-joint 44 from up to down and the connecting rod 41 impart the movement of 176 to crank 38 for rotation the crankshaft 35 and the winding speed of chain 56 round drive pulley 55 is faster than the speed of lifting the long arm 45 so the spring 63 is be gauged to strain about one inch or a suitable distance on the training of chain 56 is equal to three times the total weights on the long arm 45 or long arm 47 because the two levers and the two weights 5 and 6 are identical, the said automatic transmission mechanism inside gearbox 36 changes the rotary direction of rockshaft 37 into the opposite rotary direction upon the distance between the lifting long arm 45 and the rubber pad 60 is one inch or a suitable distance and the distance between the long arm 47 and the system's base 46 is one inch or a suitable distance, the chain 50 coils round drive pulley 54 for lifting the long arm 47 from down to up and chain 56 unwind off drive pulley 55 for descent the long arm 45 from up to down and the reciprocative movement of the two long arms 47 and 45 and the two short arms 174 and 176 is continuous on the operation of the system and the operator uses the braking device 33 and a braking rotary member 34 for stop the rotation of the crankshaft 35 to stop the system.

Connecting rod 20 which for convenience may also be referred to as a first connecting rod.

Connecting rod 41 which for convenience may also be referred to as a second connecting rod.

Crank 23 which for convenience may also be referred to as a first crank.

Crank 38 which for convenience may also be referred to as a second crank.

Lever 1 which for convenience may also be referred to as a first lever.

Lever 2 which for convenience may also be referred to as a second lever.

U-joint 17 which for convenience may also be referred to as a first U-joint.

U-joint 44 which for convenience may also be referred to as a second U-joint.

U-joint 15 which for convenience may also be referred to as a third U-joint.

U-joint 16 which for convenience may also be referred to as a fourth U-joint.

Worm 3 which for convenience may also be referred to as a first worm.

Worm 4 which for convenience may also be referred to as a second worm.

Weight 5 which for convenience may also be referred to as a first weight.

Weight 6 which for convenience may also be referred to as a second weight.

Pulley 51 which for convenience may also be referred to as a first pulley.

Pulley 57 which for convenience may also be referred to as a second pulley.

Drive pulley 55 which for convenience may also be referred to as a third drive pulley.

Drive pulley 54 which for convenience may also be referred to as a fourth drive pulley.

Coil spring 48 which for convenience may also be referred to as a first coil spring.

Coil spring 63 which for convenience may also be referred to as a second coil spring.

Guiding device 59 which for convenience may also be referred to as a first guiding device.

Guiding device 61 which for convenience may also be referred to as a second guiding device.

Long arm 47 which for convenience may also be referred to as a first long arm.

Long arm 45 which for convenience may also be referred to as a second long arm.

Chain 50 which for convenience may also be referred to as a first chain.

Chain 56 which for convenience may also be referred to as a second chain.

Referring to FIG. 1b

FIG. 1b is the perspective view of the both two identical chains 50 and 56 of FIG. 1a. Each chain consisting of two parts, part 65 having a big width for winding a chain 50 on drive pulley 54 or winding a chain 56 on drive pulley 55. Pin 66 for fixing a part 65 with drive pulley 55 or drive pulley 54. Part 64 of chain 50 or chain 56 is trained on pulley 57 or pulley 51. The free end 62 of chain 56 is connected with a coil spring 63 and the free end 49 of chain 50 is connected with a coil spring 48.

Referring to FIG. 1c and FIG. 1a.

FIG. 1c is the perspective view of rockshaft 37 which is interconnecting a gearbox 36 and two drive pulleys 55 and 54 in FIG. 1a. Bearing 67 for installation rockshaft 37 on the vertical post 53. Rockshaft 37 is free running on bearing 67. Gear 482 and gear 113 for imparting rotary motion of gearbox 36 to drive pulleys 55 and 54 and the both two gears 482 and 113 are detailed described in FIG. 3a.

Referring to FIG. 2a.

FIG. 2a is the perspective view of an additional lever is be interconnected with an essential lever by a mechanical linkage. The additional lever 69 is mounted with the essential lever 1 and lever 2 in the systems of FIG. 1a, FIG. 5a, FIG.10 and FIG. 14 and also lever 69 can be mounted with arm 258 and arm 454 in FIG. 12 for increase the system's momentum. May also be more than one additional lever can be mounted with each essential lever, lever 1 or lever 2 having the same number of the additional levers for stabilizing the system's momentum. Weight 5 or weight 6 are mounted on the additional lever 69 instead of lever 1 or lever 2. If one or more than one of the leaf springs are be used with the system, with or without weight 5 and weight 6 as in the systems of FIG. 5a, FIG. 10, FIG. 12 and FIG. 14 in this case the leaf springs are mounted on the long arm of the additional lever only. Ujoint 68 articulated with an additional lever 69 for suspension 69 to be a suitable distance between 69 and the system's base 46. Stand 84 for bearing U-joint 68. Long arm 70 of lever 69. Short arm 71 of an additional lever 69. Worm 3 or worm 4 are installed on the additional lever 69. Arciform gear 72 mounted on the short arm 71 of lever 69 and 72 engaged with gear 73 for conversion the arciform movement of the arciform gear 72 to rotary motion of gear 73 which is installed on the rockshaft 74 which imparts the rotary motion of gear 73 to drive pulley 75 which is installed on rockshaft 74. Chain 76 is mounted on drive pulley 75 by one end and the second end of chain 76 is fixed on the end of connecting rod 77. Chain 78 is fixed on the end of connecting rod 77 by one end and the second end of 78 is fixed on the long arm 47 or 45 of the two essential levers 1 and 2 and chain 78 trained on pulley 79 which is mounted on bearing 80 which is installed on the system's base 46. Side arm 81 is fixed on the long arm 70 and its free end is touched with the under surface of the long arm 47 or 45 and rubber pad 82 is installed on the free end of 81 for prevention the noise because of 81 touches 47 or 45 on the running of the system. Upon the descent of long arm 70 with weight 5 or weight 6 from up to down, an arciform gear 72 moves to up and rotate gear 74 which rotate rockshaft 74 and drive pulley 75, drive pulley 75 trains chain 76 which coil round drive pulley 75 so the long arm 47 or 45 is be driven to down by chain 78 for movement the U-joint 17 or U-joint 44 to up and on the movement of the long arm 70 from down to up, the arciform gear 72 moves from up to down to rotate gear 73 to the reverse rotary direction so the rockshaft 74 and drive pulley 75 rotate to the reverse rotary direction so the chain 76 unwind to let the long arms 47 and 45 are be lifted to up by the side arm 81.

Drive pulley 75 which for convenience may also be referred to as a first drive pulley.

Pulley 79 which for convenience may also be referred to as a second pulley.

Arciform gear 72 which for convenience may also be referred to as a first arciform gear.

Gear 73 which for convenience may also be referred to as a second gear.

U-joint 15 which for convenience may also be referred to as a first U-joint.

U-joint 68 which for convenience may also be referred to as a second U-joint.

Referring to FIG. 2b and FIG. 2a

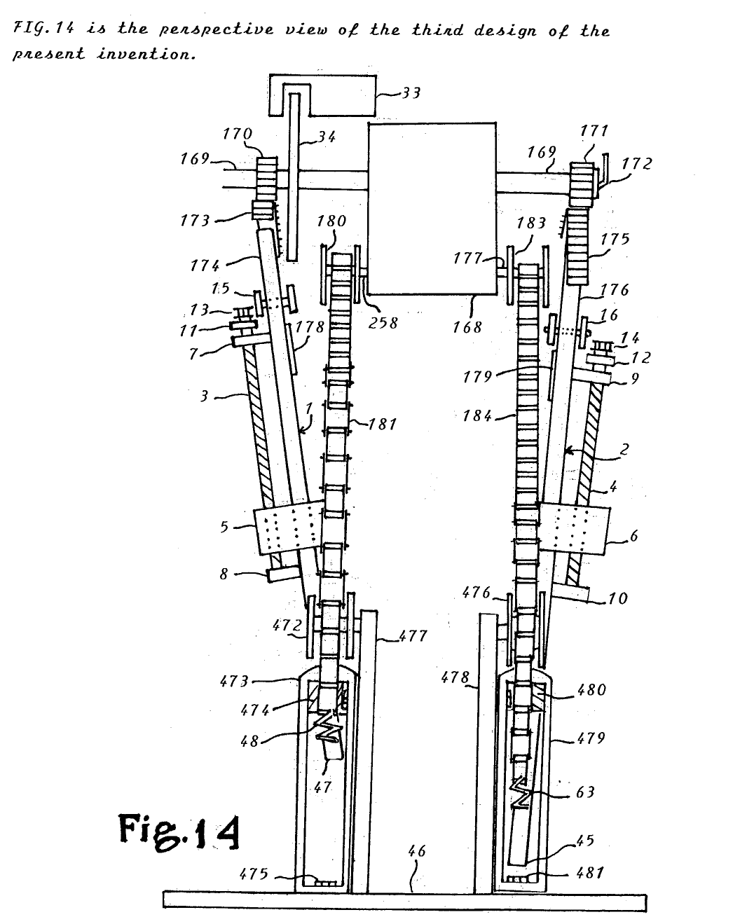

FIG. 29 is a perspective view of the transfer linkage which is interconnecting the drive pulley 75 with the long arm 47 or long arm 45. Pin 85 for installation chain 76 on drive pulley 75. Connecting rod 77 having a turnbuckle for fixing 77 with chain 76 and for decrease or increase the length of the mechanical linkage and the second end of 77 is connected with chain 78. Chain 76 having a big width so it can coil round drive pulley 75.

Referring to FIG. 3a, FIG. 1a, FIG. 3b and FIG. 3c

FIG. 3a is the upper perspective view of gearbox 36 in FIG. 1a. crank 23 and crank 38 are installed on crankshaft 35 for conversion the reciprocative movement of the two short arms of the both two levers 1 and 2 to rotary motion of crankshaft 35. Crankshaft 35 is installed to gearbox 36 by shaft bearings 91 and 103 so crankshaft 35 is free running. Cogged wheel 97 is cogged on the right side to form gear 98 and 97 is cogged on its left side to form gear 96. In FIG. 3e crankshaft 35 having gear 117 for the engagement with gear 123 of 97 in FIG. 3c so the cogged wheel 97 rotates by crankshaft 35 and also cogged wheel 97 is axially slidable to the right or the left on gear 117 of FIG. 3c. Cylindrical cam 99 is installed on the right surface of cogged wheel 97 and cam 99 is a cylinder is installed on the right surface of cogged wheel 97 by one flat end and the second end of 99 having 50% toe 101 and 50% heel 100 and cam 99 is contacting with the guiding device 102 which pushes the toe 101 on the rotation of crankshaft 35 and because of the cogged wheel 97 is free to slide to the left on gear 117 of FIG. 3b for engagement gear 96 with gear 104 for imparting rotary motion of gear 96 to gear 104. Cylindrical cam 95 it's a cylinder its flat end is installed on the left surface of the cogged wheel 97 and the peripheral end having 50% toe 94 and 50% heel 93. The peripheral board of cylindrical cam 95 is contacted with the guiding device 92 which pushes the toe 94 for sliding 97 to the right for disengagement gear 96 and gear 104 and at the same time engagement gear 98 with gear 113 for imparting rotary motion to gear 113 on the rotation of crankshaft 35. Guiding device 92 is an arm its upper end is little bent towards the edge of cam 95 and the guiding device 92 acts as leaf spring, if happened a difficulty on the engagement of leaf 96 and gear 104 the arm of 92 slant to the left to avoid the breakage of the cogs of the both two gears. The base of 92 is be fixed on the body of gearbox 36 by bolts and each bolt having a rubber washer to let the bent top of the guiding device 92 can slant to the left if happened a difficulty upon the engagement of gear 96 and gear 104. Guiding device 102 having a base for fixing 102 to the body of gearbox 36 by bolts and the guiding device 102 acts as leaf spring so it can slant to the right to avoid the breakage of the cogs of the both gears and each bolt having a rubber washer to let the bent top of the guiding device 102 can slant to the right on happening a difficulty on the engagement of gear 98 and gear 113 and the both two guiding devices 92 and 102 are identical. Gear 90 having a big diameter, 90 installed on the crankshaft 35 so on the rotation of 35 causes the rotation of gear 90, 90 engaging with gear 88 for imparting rotary motion to the working shaft 24 with faster rotational speed. Working shaft 24 having two shaft bearings 89 and 87 for installation working shaft 24 to gearbox 36. Gear 88 is mounted on working shaft 24 for imparting rotary motion of crankshaft 35 through gear 90 to a vehicle or AC generator for utilizing this rotary motion to useful work. Flywheel 29 mounted on working shaft 24 for stabilizing the momentum inertia of the working shaft 24 and flywheel 29 rotates with faster rotational speed more than the rotational speed of crankshaft 35. Ring gear 30 is installed on the flywheel 29 for imparting rotary motion of pinion gear 32 of electric starter 31. Rockshaft 106 having two shaft bearings 105 and 108 for installation 106 on the body of gearbox 36, 106 is free running on its bearings. Gear 104 is installed on rockshaft 106, 104 engaging with gear 96 on the contacting of guiding device 102 with toe 101 of cam 99 so the cogged wheel 97 is be slided to the left for engagement gear 96 and gear 104 which imparts rotary motion of crankshaft 35 to rockshaft 37 through gear 96, rockshaft 106, gear 107, gear 110 and gear 482. Gear 110 is installed on axle shaft 112, 112 having two shaft bearings 109 and 111 for installation axle shaft 112 to gearbox 36, gear 110 is free running, 110 engaged with gear 107 and gear 482 so gear 110 acts as reverse gear to reverse and impart the rotary motion of gear 107 to the rockshaft 37 through gear 482. Rockshaft 37 having two shaft bearings 115 and 116 for installation 37 to gearbox 36. Gear 113 is installed on the end of rockshaft 37 for imparting rotary motion of crankshaft 35 through gear 98 to the rockshaft 37 on the engagement of gear 98 with gear 113 because the guiding device 92 pushes the toe 94 of cylindrical cam 95 for sliding 97 to the right for disengagement gear 104 and gear 96 and engagement a gear 98 with gear 113 for imparting the reverse rotary motion which is shown in FIG. 3a. The cogs of gear 96, gear 98, gear 104 and gear 113 their shape as FIG. 7 shows to be the momentum imparted from gear to another gear by the right side of the cogs for prevention the over press on the guiding device 92 or guiding device 102 for prevention the disengagement of the gears on the imparting of rotary motion from gear to another gear and also is preferable if the crankshaft 35, rockshaft 106 and rockshaft 37 are at the same level. Brake disk 34 having a big diameter to be the braking device 33 having enough brake horsepowers to stop the system. The installation of the two cylindrical cams 99 and 95 must be opposite to each other so if the heel 100 is up must be the heel 93 of cam 95 is down. The installation of the both two cams must be the two ramps of the both two cylindrical cams 99 and 95 are at the same level as FIG. 3a shows, the ramp of each cam must touches the guiding device before any crank journal reach to the upper extreme position or the lower extreme position because the change of the rotary direction of rockshaft 37 happen before the descendant long arm of any lever reach to the system base with space about one inch or a suitable distance.

Gear 30 which for convenience may also be referred to as a first gear.

Gear 88 which for convenience may also be referred to as a second gear.

Cogged wheel 97 which for convenience may also be referred to as a third cogged wheel.

Gear 96 which for convenience may also be referred to as a fourth gear.

Gear 98 which for convenience may also be referred to as a fifth gear.

Gear 90 which for convenience may also be referred to as a sixth gear.

Gear 104 which for convenience may also be referred to as a seventh gear.

Gear 107 which for convenience may also be referred to as a eighth gear.

Gear 110 which for convenience may also be referred to as a ninth gear.

Cylindrical cam 95 which for convenience may also be referred to as a first cylindrical cam.

Cylindrical cam 99 which for convenience may also be referred to as a second cylindrical cam.

Guiding device 92 which for convenience may also be referred to as a first guiding device.

Guiding device 102 which for convenience may also be referred to as a second guiding device.

Gear 482 which for convenience may also be referred to as a tenth gear.

Gear 113 which for convenience may also be referred to as a eleventh gear.

Working shaft 24 which for convenience may also be referred to as a first shaft.

Rockshaft 106 which for convenience may also be referred to as a first rockshaft.

Axle shaft 112 which for convenience may also be referred to as a second shaft.

Rockshaft 37 which for convenience may also be referred to as a second rockshaft.

Referring to FIG. 3band FIG. 3a.

FIG. 3b is the respective view of the crankshaft of gearbox 36. Gear 117 of crankshaft 35. Cogged wheel 97 is installed on gear 117, 117 engaged with gear 123 in FIG. 3c of the cogged wheel 97, 97 rotates by crankshaft 35 and also cogged wheel 97 is free sliding to the both directions by guiding devices 92 and 102. Crankshaft journals 120 and 118 for installation crankshaft 35 on two shaft bearings 91 and 103 in gearbox 36. Hole 122 for installation crank 23 on crankshaft 35 by a pin. Hole 121 for installation gear 90 on crankshaft 35 by a pin. Hole 119 for installation crank 38 by a pin.

Gear 117 which for convenience may also be referred to as a twelfth gear.

Referring to FIG. 3c and FIG. 3a.

FIG. 3c is a side axial perspective view of cogged wheel 97 in FIG. 3a. Gear 123 for installation cogged wheel 97 on gear 117 of crankshaft 35.

Gear 123 which for convenience may also be referred to as a thirteenth gear.

Referring to FIG. 4a and FIG. 1a.

FIG. 4a is the upper perspective view of the second design of a gearbox can be used in the system of FIG. 1a instead of gearbox 36, gearbox 124 having crankshaft 127 with two cranks 23 and 38 for conversion the reciprocative movement of the both two short arms of the two levers to rotary motion of crankshaft 127. Crank 38 is installed on the right end of crankshaft 127. 38 is interconnected with the upper end 40 of connecting rod 41 in FIG. 1a and crank 23 is interconnected with the upper end 21 of connecting rod 20. Rockshaft 155 of gearbox 124 for imparting rotary motion of gearbox 124 to drive pulleys 55 and 54 which are installed on the end of rockshaft 155 instead of rockshaft 37 of FIG. 1a. Crankshaft 127 is installed to gearbox 124 by two shaft bearings 125 and 130, crankshaft 127 is free running on 125 and 130 for imparting rotary motion of cranks 38 and 23 to gear 128 and gear 126. Gear 128 is installed on 127, 128 is rotating by crankshaft 127. The shape of each cog of 128 is right-angled triangle for engagement with gear 140 for imparting rotary motion of crankshaft 127 to rockshaft 155 through gear 139, gear 149, rockshaft 151, gear 152 and gear 154 for rotation a rockshaft 155. May gear 128 be a ring gear is installed on a wheel. Gear 129 is installed on the right surface of gear 128, upon the rotation of gear 128 causes the rotation of gear 129, 129 engaging with gear 143 of cam shaft 145 for imparting rotary motion of gear 128 to cam wheel 147 through cam shaft 145 for rotation cam wheel 147 a half revolution on the rotation of crankshaft 127 a half revolution because the diameter of gear 129 is the same diameter of gear 143 and may gear 129 be a ring gear. Cam wheel 147 is an incomplete plate having 50% toe and 50% heel with suitable thickness. Cam wheel 147 contacting with the right surface of gear 139 for sliding gear 139 to the left because 139 is free to slide into the left by the toe of cam wheel 147, 139 is free to slide into the right by the force of coil spring 137 which is installed among gear 139 and gear 134 on axle shaft 136, upon contacting the toe of cam wheel 147 with the right surface of gear 139 causes sliding a gear 139 to the left for disengagement a gear 140 and gear 128, gear 138 which is installed on the left surface of gear 139 engage with gear 135 which is installed on the right surface of gear 134 for imparting a reverse rotary motion from crankshaft 127 to the rockshaft 155 through gear 126, gear 132, gear 134, gear 135, gear 138, gear 139, gear 149, rockshaft 151, gear 152 and gear 154 to drive the rockshaft 155 to the reverse rotary direction after the crankshaft 127 and cam wheel 147 rotated a half revolution. The change of the rotary direction of rockshaft 155 before the descendant long arm of any lever reaches to the system's base with one inch or suitable distance. May gear 140 be a ring gear. Gear 126 is mounted on crankshaft 127, 126 rotates by crankshaft 127, 126 engaged with gear 88 for imparting rotary motion of crankshaft 127 to the working shaft 24 which impart a kinetic energy of gearbox 124 to a machine or a vehicle for useful work. Gear 88 having a small diameter so it acts as speed-increasing device for rotation the working shaft 24 in a faster speed than that of crankshaft 127. Shaft bearing 87 for installation working shaft 24 to gearbox 124. Flywheel 29 is installed on working shaft 24 for stabilizing the momentum inertia of working shaft 24. Ring gear 30 is installed on flywheel 29 for imparting rotary motion of the electric starter 31 through pinion gear 32, on starting the system, the pinion gear 32 engages with gear 30 for imparting rotary motion of 31 to gearbox components 124 for starting the system and after the system started the operator turns the electric starter off for disengagement the pinion gear 32 and 30. Gear 132 having a small diameter and its axle shaft is installed to gearbox 124 by shaft bearing 131, 132 is engaged with gear 126 and gear 134 for imparting kenetic energy of gear 126 to gear 134 which rotates to the same rotary direction of gear 126, on the contacting of the toe of cam wheel 147 with gear 139 for disengagement gear 140 and gear 128 and engagement gear 138 with gear 135 for imparting kenetic energy with the same rotary direction of crankshaft 127 so gear 139 impart rotary motion of gear 134 to rockshaft 155 through gear 135, gear 138, gear 139, gear 149, rockshaft 151, gear 152 and gear 154 to change the rotary direction of rockshaft 155. Cam short components 145 having the same design of FIG. 6b so if happened a difficulty on the engagement of gear 138 and gear 135, the two shaft bearings 144 and 146 can slant to the right for avoidance the breakage of the two gears 135 and 138. The automatic transmission mechanism includes, a reverse gear 132, gear 134, gear 135, gear 139, gear 138, gear 140, a coil spring 137, gear 149, gear 152, cam wheel 147, cam shaft 145, gear 143 of cam shaft 145. The automatic transmission mechanism is be designed for three reasons, the first reason to impart rotary motion of crankshaft 127 to rockshaft 155 to rotate the drive pulleys 54 and 55 of FIG. 1a for list the long arm of any lever reached to the lower extreme position. The second reason to change the rotary direction of rockshaft 155 for regulation the reciprocative movement of the both two levers. The third reason to increase the rotational speed of rockshaft 155 so on the rotation of crankshaft 127 a half revolution causes rotation a rockshaft 155 several times. Axle shaft 136 having two shaft bearings 133 and 141 for installation 136 to the body of gearbox 124. 136 is free to rotate on the two shaft bearings 141 and 133 by the rotation of gear 134. Gear 135 is a part of gear 134 or may gear 135 be a ring gear is installed on the right surface of gear 134 and the shape of each cog of gear 135 is a right triangle and gear 135 having the same diameter of gear 138, may 138 be a ring gear is installed on the left surface of gear 139. Coil spring 137 having two end plates for installation 137 on axle shaft 136 as FIG. 6e and FIG. 6f show for sliding gear 139 towards cam wheel 147 for remaining the right surface of gear 139 contacting with cam wheel 147 all the time and coil spring 137 disengages gear 135 and gear 138 on the contacting of the heel of cam wheel 147 with gear 139, at the same time 137 to slide gear 139 to the right for engagement gear 140 and gear 128. Gear 139 is free to rotate on axle shaft 136 without rotation 136 and also gear 139 is free to slide into the both directions on its axle shaft 136. Gear 149 engaging with gear 139, 149 having a small diameter acts as speed-increasing device and also 149 having a big width for remaining its engagement with gear 139 on the sliding of gear 139 to any direction. Gear 149 is coaxially mounted with gear 152 on rockshaft 151. Gear 152 is driven to be rotating by gear 149 for imparting rotary motion to rockshaft 155 through gear 154. Gear 149, gear 152 and gear 154 having the same diameter approximately. The diameter of gear 129 is the same diameter of gear 143. Gear 139 having a ring of durable material as FIG. 6c shows and this ring is installed on the right surface of gear 139 for protection gear 139 of wear because of the contacting of cam wheel 147 with gear 139. Cam 142 its cam shaft 157 having shaft bearing on the bottom of gearbox 124 and the upper end of cam shaft 157 having a shaft bearing to the upper cover of gearbox 124 as FIG. 4b shows, the both two shaft bearings of cam shaft 157 are viewless in FIG. 4a and cam 142 is used for stop the system. Upon the rotation of cam 142 manually by a stick articulated with the upper end of cam shaft 157, the toe of cam 142 pushes the right surface of gear 139 so gear 139 can not sliding to the right by the force of coil spring 137 for engagement gear 140 and gear 128 to stop the system. Two shaft bearings 153 and 156 for installation rockshaft 155 to gearbox 124. Braking device 33 is installed on the body of gearbox 124 or on the system's base and brake disk 34 is installed on crankshaft 127 and the both 33 and 34 for stop the system with cam 142. On the operation, please refer to FIG. 1a with FIG. 4a. It's obvious that gearbox 124 will be installed in the system of FIG. 1a instead of gearbox 36 for work the same work of gearbox 36, so the upper end of connecting rod 41 is be interconnected with crank 38 and also the upper end 21 of connecting rod 20 is be interconnected with crank 23 in FIG. 4a and also the two drive pulleys 55 and 54 are be installed on the end of rockshaft 155. After the system is be started by the electric starter 31 as FIG. 1a shows, the long arm 45 is dropping to down by the gravity and the crank journal of crank 38 is moving to up by the movement of the short arm 176 to up and at this time the heel of cam wheel 147 is contacting with the right surface of gear 139 so gear 139 is be slided by a coil spring 137 for engagement gear 140 with gear 128 for imparting rotary motion of crankshaft 127 to rockshaft 155 through gear 128, gear 140, gear 149, rockshaft 151, gear 152 and gear 154 for rotation the rockshaft 155 so the two drive pulleys 55 and 54 are rotating also to the same rotary direction of rockshaft 155 and because the rotary speed of pulley 55 is faster than the speed of the long arm 45 to down so chain 56 is slack to make the movement of 45 to down is easy without any mechanical assistance and also because the rotary speed of pulley 54 is faster than the movement speed of long arm 47 to up this cause training a chain 50 and extension a coil spring 48 about one inch or a suitable distance on the training of chain 50 is equal to three times the total weights which drive 45 to down include a weight 6, a weight of long arm 45, a weight of worm 4 and the force of leaf springs if leaf springs are be used for driving the long arm 45 to down as FIG. 10b shows so a coil spring 48 is be gauged for this reason. Before the long arm 45 reaches to the system's base 46 with a distance about one inch or a suitable distance and also the distance between 47 and the rubber pad 58 is about one inch or a suitable distance at this time the cam wheel 147 rotated a half revolution and the toe of cam wheel 147 is contacting with the right surface of gear 139 so 139 is be slided by cam wheel 147 for disengagement gear 128 and gear 140, at the same time gear 138 engages with gear 135 for change the rotary direction of rockshaft 155 and also the both two drive pulleys 55 and 54 are rotating to the reverse rotary direction and on reaching of 47 to upper extreme position and 45 to the lower extreme position the both two chains are slack then 47 starts its descent from up to down, at this time a flywheel 29 is stabilizing the momentum inertia of the working shaft 24 and crankshaft 127 for imparting rotary motion of crankshaft 127 to rockshaft 155 through gear 126, gear 132, gear 134, gear 135, gear 138, gear 139, gear 149, rockshaft 151, gear 152 and gear 154 for rotation the both two drive pulleys 55 and 54 to the reverse rotary direction so drive pulley 55 trains a chain 56 which wind round pulley 55 for lifting the long arm 45 from down to up and a coil spring 63 is strained about one inch or a suitable distance because coil spring 63 is gauged to be strained one inch or a suitable distance on the training of chain 56 is equal to three times the total forces which drive the long arm 47 to down and because the rotational speed of pulley 54 is more than the speed of descendant 47 to down therefore a chain 50 is slack. The reciprocative movement of the both two long arms is continuous on the working of the system. The operator to stop the system, cam 142 can be rotated by an arm is interconnected with the upper end of 157 as FIG. 4b shows, the toe of cam 142 pushes the right surface of gear 139, gear 140 and gear 128 unable to engage with each other and also the braking device 33 can be used to stop the system with cam 142.

A working shaft 24 which for convenience may also be referred to as a first shaft.

A cam shaft 145 which for convenience may also be referred to as a first cam shaft.

An axle shaft 136 which for convenience may also be referred to as a second shaft.

A cam shaft 157 which for convenience may also be referred to as a second cam shaft.

A rockshaft 151 which for convenience may also be referred to as a first rockshaft.

A rockshaft 155 which for convenience may also be referred to as a second rockshaft.

A ring gear 30 which for convenience may also be referred to as a first gear.

A gear 88 which for convenience may also be referred to as a second gear.

A gear 126 which for convenience may also be referred to as a third gear.

A gear 128 which for convenience may also be referred to as a fourth gear.

A gear 129 which for convenience may also be referred to as a fifth gear.

A gear 143 which for convenience may also be referred to as a sixth gear.

A reverse gear 132 which for convenience may also be referred to as a seventh gear.

A gear 134 which for convenience may also be referred to as a eighth gear.

A gear 135 which for convenience may also be referred to as a ninth gear.

A gear 138 which for convenience may also be referred to as a tenth gear.

A gear 139 which for convenience may also be referred to as an eleventh gear.

A gear 140 which for convenience may also be referred to as a twelfth gear.

A gear 149 which for convenience may also be referred to as a thirteenth gear.

A gear 152 which for convenience may also be referred to as a fourteenth gear.

A gear 154 which for convenience may also be referred to as a fifteenth gear.

A crank 23 which for convenience may also be referred to as a first crank.

A crank 38 which for convenience may also be referred to as a second crank.

A cam wheel 147 which for convenience may also be referred to as a first cam wheel.

A cam 142 which for convenience may also be referred to as a second cam.

Referring to FIG. 4b.

FIG. 4b is a perspective view of the upper cover of gearbox 124 in FIG. 4 a. Cover 166 is fixed on gearbox 124 by bolts. Hole 167 for installation 166 on the body of gearbox 124 by bolt. Bearing 158 for supporting cam shaft 157 of cam 142 in FIG. 4a and cam shaft 157 is free rotating to the both two directions. Female 159 for installation U-joint 161 on cam shaft 157 by a pin 160 so upon the rotation of U-joint 161 causes the rotation of cam shaft 157. U-joint 161 for interconnecting arm 162 with cam shaft 157. Handle 163 is installed on arm 162, 163 is be used by the operator for driving arm 162 to the left or the right and handle 163 is free movement to up and down by the operator. U-form 164 for supporting arm 162 on the working of the system. Catch 165 for fixing arm 162 on the stop of the system. For stop the system, the operator takes handle 163 and move it to up then to the right and fixing the arm 162 under the horizontal arm of catch 165 so arm 162 remain in this position on the stop of the system.

Referring to FIG. 5 a.

FIG. 5a is the perspective diagram of the second design of the power generating system of the gravity and leaf springs. According to the present invention includes. Two identical levers 1 and 2 with equal length. Two identical worms 3 and 4. Two identical weights 5 and 6. Two bearings 7 and 8 for installation worm 3 on lever 1. Two bearings 9 and 10 for installation worm 4 on lever 2. U-joint 15 for suspension lever 1 to be a suitable distance between lever 1 and the system's base 46, the long arm is free movement to up and down with a reciprocative movement. U-joint 16 for suspension lever 2 to be a suitable distance between the point of the suspension and the system's base 46. Short arm 174 of lever 1. Short arm 176 of lever 2. An arciform gear 173 is installed on the short arm 174 of lever 1, 173 is engaged with gear 170. An arciform gear 175 is installed on the short arm 176 of lever 2, 175 is engaged with gear 171. Gear 170 is be interconnected with working shaft 169 by a ratchet device so gear 170 to one direction only causes the rotation of working shaft 169 and on the rotation of gear 170 to the opposite direction the working shaft 169 remain stationary so gear 170 convert the arciform movement of an arciform gear 173 on the movement of 173 from down to up into rotary motion of working shaft 169. Gear 171 is be interconnected with the working shaft 169 by a ratchet device so gear 171 to one direction only causes the rotation of working shaft 169 and on the rotation of gear 171 to the opposite direction the working shaft 169 remain stationary so gear 171 convert the arciform movement of the arciform gear 175 on the movement of 175 from down to up into rotary motion of working shaft 169. Arm 172 is be used by the operator for stop the system, after the operator stopped the rotation of working shaft 169 by the braking device 33 and brake disk 34 then the operator turns arm 172 for turning the rotary direction of the said ratchet device which interconnecting a gear 171 with working shaft 169 to be the said ratchet device can rotate 169 to the both directions or to the opposite rotary direction of the other ratchet device which interconnecting a gear 170 with working shaft 169 for remaining 169 stationary then the operator withdraw the brake. Brake disk 34 is installed on the working shaft 169. Gearbox 168 which having an automatic transmission mechanism as FIG. 6a shows for imparting rotary motion of working shaft 169 to a rockshaft 258 and rockshaft 177 for regulation the reciprocative movement of the both two long arms 47 and 45 with the interconnection of two rockshafts 177 and 258 with the two long arms 47 and 45 by chain 181, chain 182, chain 197, chain 188, chain 205, chain 202, chain 185, drive pulley 183 and drive pulley 180. System's base 46 for installation the following parts of the system, gearbox 168, U-joint 15, U-joint 16, the vertical post 194, a vertical post 190, a guiding device 193, guiding device 192, bearing 318 of pulley 199, bearing 200 of pulley 201, pulley 203 and pulley 204. The system's body includes, a vertical post 194 is installed on the system base 46 for bearing an horizontal post 191, vertical post 190 for bearing the right part of horizontal post 191. A guiding device 193 is a vertical post its upper end is fixed in the horizontal post 191 and its lower end is fixed on the system's base 46 as FIG. 5d shows, 193 for limitation the reciprocative movement of the long arm 47 and protection 47. A guiding device 192 is a vertical post its upper end is installed to the horizontal post 191, the lower end of 192 is installed on the system's base 46 and 192 for protection the long arm 45 and limitation the reciprocative movement to up and down of the long arm 45. Pulley 208 is installed on the horizontal post 191 and chain 182 is trained thereon, 208 is free rotating on its axle. Pulley 209 is installed on the horizontal post 191 and chain 197 is trained thereon and 209 is free rotating on its axle. Pulley 210 is installed on the horizontal post 191 and chain 202 is trained thereon, 210 is free rotating on its axle. Pulley 211 is installed on the horizontal post 191 and chain 185 is trained thereon, 211 is free rotating on its axle. Pulley 199 is be installed on the system's base 46 by a bearing 318 and chain 182 is trained thereon, 199 is free rotating on its axle. Pulley 201 is be installed on the system base by a bearing 200 and chain 185 is trained thereon, pulley 201 is free rotating on its axle. The system's base 46 having two legs 212 and 214 and wheel 213 is installed on leg 212, wheel 215 is installed on leg 214 for convection the system from site to another site if this system is be used for husbandry or industrial purposes. Chain 188 is trained on pulley 203, end 195 of chain 188 is fixed with the end of a coil spring 189 and the other end 196 of chain 188 is fixsd with link 198. Chain 205 is trained on pulley 204, end 207 of chain 205 is fixed with the right end of coil spring 189, end 218 of chain 205 is connected with link 206. Chain 182 is trained on pulleys 208 and 199, chain 182 is connected with link 198 by one end and the other end is connected with end 187 of chain 181. Chain 181 is be fixed on pulley 180 by one end and the second end 187 of chain 181 is connected with the end of chain 182 and chain 181 coils round pulley 180 upon the rotation of pulley 180 for training chain 182. Chain 197 is connected with link 198 by one end and the other end 217 is connected with long arm 47 and chain 197 trained on pulley 209 for lifting the long arm 47 to up. Chain 202 is trained on 210 and it's connected with link 206 by one end and its other end 216 is connected with long arm 45. Chain 185 is trained on pulleys 211 and 201 and it's connected with link 206 by one end and its other end is connected with end 186 of chain 184. Chain 184 is be fixed to pulley 183 by one end and its other end 186 is connected with chain 185. On the rotation of pulley 183, chain 184 winds round pulley 183 for pulling chain 185 for lifting the long arm 47 to up. Leaf spring 178 having an acute angle is fixed on the long arm 47 by one end and its second end is installed to the stand of U-joint 15 for driving the long arm 47 to down and to prevent any shaking to up of the long arm 47 upon its descent from up to down while the vehicle is running to remain the regulation of the reciprocative movement of the both two long arms 47 and 45 constant as FIG. 5b and FIG. 5c show. Leaf spring 179 and leaf spring 178 are identical and 179 is installed on long arm 45 by one end and its other end is installed on the stand of U-joint 16 as FIG. 5b and FIG. 5c show. May the two identical weights 5 and 6 be of any suitable size and kind. On the operation, before the system starts its work the long arm 47 is reached to upper extreme position and the long arm 45 is reached to the lower extreme position. The operator wedges the brake disk 34 by the brake shoes of the braking device 33 to prevent the rotation of the working shaft 169 suddenly then the operator turns an arm 172 for change the work of the said ratchet device which is interconnecting a gear 171 and working shaft 169 to be gear 171 can rotate 169 to one direction only upon the movement of the arciform gear from down to up but on the rotation of gear 171 to the opposite direction the working shaft 169 remain stationary. May arm 172 be fixed on the ratchet device or it can be loosed by the operator after the turning of the rotary direction of working shaft 169 then the brake is be released gradually by the operator so the working shaft 169 rotate because of descent the long arm 47 and weight 5 from up to down by the gravity and the force of leaf spring 178 which drives 47 to down, 47 descend from up to down without any strength of chain 197 which is slack because the automatic transmission mechanism as FIG. 6a shows impart rotary motion to the rockshaft 258 which rotate pulley 180 to train chain 181 which coil on pulley 180, 181 to train chains 182, 188, 205 and 202 which lift the long arm 45 to up, chain 185 and chain 184 to drive pulley 183 to be rotating to the opposite rotary direction than that of 180 because the automatic transmission mechanism in gearbox 168 as FIG. 6a shows disimpart the rotary motion to rockshaft 177 and pulley 183 which is installed on the end of 177. Before the long arm 47 reaches to the lower extreme position with one inch or a suitable distance to the system's base 46 must be the long arm 45 reached to the upper extreme position by the horizontal post 191 and also 45 started its movement from up to down by the gravity and leaf spring 179 because the automatic transmission mechanism in gearbox 168 impart rotary motion to rockshaft 177 for rotation a rockshaft 177 to the same rotary direction of rockshaft 258, so pulley 183 rotate also to the same rotary direction of pulley 180 for training a chain 184 which coils round pulley 183 for training chains 185 and 205 so chain 202 is slack to let the long arm 45 descend to down without strength of a chain 202 therefore a coil spring 189 is installed and connected a chain 188 with a chain 205 to be 189 extended about two inches or a suitable distance upon the training of the both two chains 188 and 205 is equal to three times the total weights which drive one long arm to down, these weights include weight 5 or weight 6 plus the weight of worm 3 or worm 4 and the weight of the long arm 47 or 45 also the force of the leaf spring 178 or leaf spring 179 is included so spring 189 is gauged for this reason. After the long arm 47 reached to the system's base 46, gearbox 168 disimparts the rotary motion to rockshaft 258 and pulley 180 at the same time gearbox 168 is still imparting rotary motion to rockshaft 177 and pulley 183 so the long arm 47 is be lifted to up by the training of chain 197, pulley 180 is driven to be rotating to the reverse rotary direction by the training of chain 181, chain 182, chain 188, chain 205, chain 185 and chain 184. The reciprocative movement of the two long arms 47 and 45 is continuous on the running of the system. For stopping the system, the operator uses the braking device 33 to stop the rotation of the working shaft 169 and then he turn the arm 172 to change the work of the said ratchet device to be gear 171 can rotate 169 to the both two directions so 169 remain stationary, and then the operator withdraw the brake. Gear 170 which for convenience may also be referred to as a first gear.

Gear 171 which for convenience may also be referred to as a second gear.

Cogged pulley 13 which for convenience may also be referred to as a first cogged pulley.

Cogged pulley 14 which for convenience may also be referred to as a second cogged pulley.

Arciform gear 173 which for convenience may also be referred to as a first arciform gear.

Arciform gear 175 which for convenience may also be referred to as a second arciform gear.

Lever 1 which for convenience may also be referred to as a first lever.

Lever 2 which for convenience may also be referred to as a second lever.

Short arm 174 which for convenience may also be referred to as a first short arm.

Long arm 47 which for convenience may also be referred to as a first long arm.

Short arm 176 which for convenience may also be referred to as a second short arm.

Long arm 45 which for convenience may also be referred to as a second long arm.

U-joint 15 which for convenience may also be referred to as a first U-joint.

U-joint 16 which for convenience may also be referred to as a second U-joint.

Drive pulley 180 which for convenience may also be referred to as a first drive pulley.

Drive pulley 183 which for convenience may also be referred to as a second drive pulley.

Pulley 208 which for convenience may also be referred to as a third pulley.

Pulley 209 which for convenience may also be referred to as a fourth pulley.

Pulley 210 which for convenience may also be referred to as a fifth pulley.

Pulley 211 which for convenience may also be referred to as a sixth pulley.

Pulley 199 which for convenience may also be referred to as a seventh pulley.

Pulley 201 which for convenience may also be referred to as a eighth pulley.

Pulley 203 which for convenience may also be referred to as a ninth pulley.

Pulley 204 which for convenience may also be referred to as a tenth pulley.

Chain 181 which for convenience may also be referred to as a first chain.

Chain 182 which for convenience may also be referred to as a second chain.

Chain 197 which for convenience may also be referred to as a third chain.

Chain 188 which for convenience may also be referred to as a fourth chain.

Chain 205 which for convenience may also be referred to as a fifth chain.

Chain 202 which for convenience may also be referred to as a sixth chain.

Chain 185 which for convenience may also be referred to as a seventh chain.

Chain 184 which for convenience may also be referred to as an eighth chain.

Worm 3 which for convenience may also be referred to as a second worm.

Worm 4 which for convenience may also be referred to as a second worm.

Weight 5 which for convenience may also be referred to as a first weight.

Weight 6 which for convenience may also be referred to as a second weight.

Leaf spring 178 which for convenience may also be referred to as a first leaf spring.

Leaf spring 179 which for convenience may also be referred to as a second leaf spring.

Ratchet device 11 which for convenience may also be referred to as a first ratchet device.

Ratchet device 12 which for convenience may also be referred to as a second ratchet device.

Referring to FIG. 5b and FIG. 5c.

FIG. 5b is a side perspective diagram of spring 178 or spring 179 of FIG. 5a while the long arm 45 of 47 having the upper extreme position. U-link 220 is installed on lever 1 or lever 2 by bolts for installation the end of leaf spring 178 or leaf spring 179 on the long arm of the lever. U-link 219 is fixed on the stand of U-joint 15 or 16 by bolts for installation the lower end of spring 178 or 179. FIG. 5c shows the long arm 45 or 47 having the lower extreme position.

Referring to FIG. 5d.

FIG. 5d is the perspective view of the system's body in FIG. 5a. Vertical post 194 is installed on the system's base 46 for bearing the horizontal post 191. Vertical post 190 for bearing the right part of the horizontal post 191. Guiding device 193 is installed with the horizontal post by bolts and 193 is fixed on the system base 46 by bolts for limitation the reciprocative movement of long arm 47 and also for protection 47. Rubber pad 222 is fixed on the under surface of the horizontal post 191 for protection the horizontal post 191 and the long arm 47 and prevention the noise. Guiding device 192 is installed on the system's base in bolts and it's fixed with the horizontal post 191 by bolts and 192 for limitation the reciprocative movement of long arm 45 and protection 45. Bolt 224 for fixing 191 with the vertical post 194. Bolt 223 for fixing 191 on the vertical post 190. Rubber pad 221 is fixed on the horizontal post 191 for protection the horizontal post 191 and the long arm 45 and prevention the noise.

Referring to FIG. 5e.

FIG. 5e is the perspective disgram shows the shape of weight 5 or weight 6 in FIG. 1a, FIG. 2a, FIG. 5, FIG. 12 and FIG. 14. Longitudinal hole 225 having internal cogs for engagement with worm 3 or worm 4. Longitudinal hole 226 for installation weight 5 on long arm 47 and weight 6 on long arm 45 and weight 5 or weight 6 are free movement on the long arm to decrease or increase the distance between each weight and the suspension point of the lever by worm 3 and worm 4. Rubber pad 227 acts as silencer because the weight 5 or weight 6 touch the system base 46 on the running of the system.

Referring to FIG. 5f and FIG. 5a.

FIG. 5f is the perspective view of the second design of the transfer linkage for the system in FIG. 5a. Pin 239 for installation chain 181 on pulley 180 in FIG. 5a and end 187 is linked with the end 238 of connecting rod 234 which its other end 236 is linked with chain 182 and link 229 connected a chain 182 with chain 197 which is trained on pulley 209 in FIG. 5a also the end of chain 231 is connected with link 229 and chain 231 is trained on pulley 203 in FIG. 5a, 231 connected with a coil spring 189. End 217 of chain 197 is connected with long arm 47. Chain 230 is trained on pulley 204 and 230 is be connected with a coil spring 189 by one end and its other end is connected with link 228. Chain 202 is trained on pulley 210 and its end 216 is connected with long arm 45. Chain 185 is connected with link 228 by one end and its other end is connected with U-joint 235 of connecting rod 233 and end 237 is connected with chain 184 which is installed on pulley 183 by pin 240.

Connecting rod 234 which for convenience may also be referred to as a first connecting rod.

Connecting rod 233 which for convenience may also be referred to as a second connecting rod.

Referring to FIG. 5g and FIG. 5a.

Pulley 208, pulley 209, pulley 210, pulley 211, pulley 203, pulley 204, pulley 199 and pulley 201 each one of them consisting of three parts. As FIG. 5g shows, the first part 241 having one end plate or flange and two tooth sockets 244 and 257 for engagement with the two cogs 248 and 249 of the rubber pulley 242 for installation the rubber pulley 242 to the first part 241. Axle 245 of the pulley. Holes 256, 255 and 246 for fixing the first part 241 with the third part 243 by bolts. The third part 243 is a plate or flange having four holes 252, 253, 254 and 250 for installation part 243 on part 241 by bolts and hole 251 for the axle of the pulley. A rubber pulley 242 for prevention the noise on the running of the system.

The pulley component 241 which for convenience may also be referred to as a first pulley component.

The rubber pulley 242 which for convenience may also be referred to as a second pulley component.

The plate or flange 243 which for convenience may also be referred to as a third pulley component.

Referring to FIG. 6a.

FIG. 6a is the upper perspective view of the first design of a gearbox is be used in the system-second design in FIG. 5a and the system-third design in FIG. 14. Gearbox 168 is used for regulation the reciprocative movement of the both two long arms 47 and 45 and imparting the kenetic energy of the system to a vehicle or an AC generator for utilization this kenetic energy for useful work. Gearbox 168 includes, a working shaft 169 is mounted on the body of gearbox 168 in three shaft bearings 259, 262 and 264, working shaft 169 is free rotating on its shaft bearings. Gear 170 and gear 171 each one of them is interconnected with working shaft 169 by ratchet device to be 170 and 171 to one direction only cause the rotation of working shaft 169 but on the rotation of 170 and 171 to the reverse rotary direction, the working shaft 169 remain stationary and gear 170 is engaged with arciform gear 173 in FIG. 5a for conversion the arciform movement of 173 on its movement from down to up into rotary motion of the working shaft 169 and gear 171 having the same diameter of gear 170. Gear 171 is engaged with arciform gear 175 for conversion the arciform movement of 175 from down to up into rotary motion of working shaft 169. The ratchet device which interconnecting a gear 171 with working shaft 169 having a small arm 172 which is be used by the operator for change the work of the said ratchet device after 169 is be stopped by the braking device 33 to be the said ratchet device can rotate 169 to the both two directions to stop the system and may small arm 172 remain fixed with the said ratchet device or the operator can loose it before the system starts its work another time. Gear 260 is mounted on 169, 260 is driven to be rotating by the working shaft 169 for imparting rotary motion from working shaft 169 to gear 265 which is engaged with 260 and the diameter of gear 260 is double the diameter of gear 265 and the diameter of gear 265 is the same diameter of gear 170 and gear 171, so upon the rotation of gear 170 or 171 a quarter revolution because of the movement of the descendant long arm from up to down causes the rotation of gear 260 a quarter revolution also and because gear 260 having a double diameter of gear 265, so on the rotation of gear 260 a quarter revolution cause the rotation of gear 265 a half revolution this cause the rotation of cam shaft 266 and cam wheel 270 a half revolution also. The length of the cogs of the both two gears 260 and 265 is one and half to two times more than the length of the cogs of gear 274 and gear 275 to remain the engagement of gear 265 and gear 260 if happened a difficulty on the engagement of gears 274 and 275, the cam shaft 266 can slant to the right as FIG. 6b shows without disengagement of gear 260 and gear 265 for constancy the regulation of the reciprocative movement of the both two levers. Gear 263 having the same diameter of gear 260, 263 is installed on a working shaft 169 so upon the rotation of 169 causes the rotation of gear 263, 263 is engaged with gear 282 for imparting rotary motion of 169 to cam shaft 284 and cam wheel 286. The length of each cog of gears 263 and 282 is one and half to two times more than the length of each cog of gear 277 and gear 278 to remain a gear 263 and a gear 282 engaging with each other. Gear 261 is installed on working shaft 169 so on the rotation of 169 causes the rotation of gear 261, 261 is engaged with gear 276 for imparting rotary motion of working shaft 169 to gear 276 of the automatic transmission mechanism for regulation the reciprocative movement of the both two levers. Braking rotary member 34 is mounted on the working shaft 169 and it's acts as brake disk and flywheel at the same time for stabilizing the momentum inertia of the working shaft 169. Axle shaft 272 is installed to gearbox 168 in two shaft bearings 271 and 281 and axle shaft 272 is free rotating on its two bearings. Gear 276 is mounted on axle shaft 272 so on the rotation of gear 276 causes the rotation of axle shaft 272. Gear 276 is cogged on its right peripheral surface to form gear 277 and the shape of each cog is right triangle and may gear 277 be a ring gear is installed on the right surface of gear 276 and gear 276 is cogged on its left peripheral surface to form gear 275 or may gear 275 be a ring gear is installed on the left surface of gear 276 and the shape of each cog of gear 275 is right triangle and gear 275 engages with gear 274 on the contacting of the toe of the cam wheel 270 with the left surface of gear 273 for pushing a gear 273 to slide into the right on its axle shaft 272 for imparting rotary motion of working shaft 169 to pulley 180 through gear 261, gear 276, gear 275, gear 274, gear 273, gear 288 and rockshaft 258 for rotation pulley 180 which trains chain 181 for lifting the long arm 45 from lower extreme position to the upper extreme position and also for training a chain 184 in FIG. 5a for rotation a pulley 183 to the reverse rotary direction than that of pulley 180 and also rotation the rockshaft 177, gear 290, gear 280 and gear 278 to the reverse rotary direction than that of gear 276, gear 275, gear 274, gear 273, gear 288 and pulley 180 on the contacting of the heel of cam wheel 286 with the right surface of gear 280 so the coil spring 279 which is installed on axle shaft 272 among gear 276 and gear 280 pushes gear 280 which slide on axle shaft 272 to the right for disengagement gear 277 and gear 278. Gear 273 is mounted on axle shaft 272 and on the rotation of 272 does not cause the rotation of gear 273 because 273 is free to slide on 272 to the right by the toe of cam wheel 270 and 273 is free to slide to the left by the force of a coil spring is installed on axle shaft 272 among gear 273 and gear 276 and this the coil spring is like a coil spring 279 but it's viewless because the toe of cam wheel 270 is pushing a gear 273 to slide to the right for engagement gear 274 and gear 275 on the contacting of the heel of cam wheel 286 with the right surface of gear 280. Gear 273 is cogged on its right side to form gear 274 and the shape of each cog of gear 274 is right triangle to be the momentum which is be imparted from gear 275 to gear 274 on the right side of each cog not on the toe of cam wheel 270 and also may gear 274 be a ring gear is installed on the right surface of gear 273. Gear 273 is engaged with gear 288 so gear 288 is driven to be rotating by gear 273 for imparting rotary motion to pulley 180 through rockshaft 258. Gear 280 is mounted on axle shaft 272, 280 is free sliding on its axle to the right by the force of coil spring 279 on the contacting of the heel of cam wheel 286 with the right side of gear 280 and after cam wheel 286 rotated a half revolution to be the toe of cam wheel 286 is contacting with the right side of gear 280 to slide gear 280 to the left on its axle 272 for engagement gear 277 and gear 278 for imparting rotary motion of gear 276 to pulley 183 through gear 277, gear 278, gear 280, gear 290 and rockshaft 177. Gear 280 is cogged on its left surface to form gear 278 or may gear 278 be a ring gear is installed on the left surface of gear 280. The shape of each cog of gear 278 is right triangle to be the momentum of the rotary motion which imparts from gear 277 to gear 278 must be on the right side of each cog not on the toe of cam wheel 286. For protection the right surface of gear 280 and the left surface of gear 273 of the wear because cam wheel 286 is contacting with gear 280 and cam wheel 270 is contacting with gear 273 so a ring can be used for protection each gear and this ring is installed by bolts on the surface of the gear as FIG. 6c shows. Cam shaft 266 is mounted to gearbox 168 by two shaft bearings 267 and 268, cam shaft 266 is free rotating on its bearings for imparting rotary motion of gear 265 to cam wheel 270. Gear 265 is installed on the end of cam shaft 266 and gear 265 is driven to be rotating by gear 260 for rotation cam wheel 270 and the diameter of gear 265 is the same diameter of gear 282 which is installed on cam shaft 284. Cam wheel 270 is mounted on cam shaft 266 so on the rotation of cam shaft 266 causes the rotation of cam wheel 270. Cam wheel 270 its shape is semicircular plate having a suitable gauge and about 57% toe and 43% heel. The two shaft bearings 267 and 268 are designed as FIG. 6b shows if happened a difficulty on the engagement of gear 274 and gear 275, the two bearings can slant into the left to avoid the breakage of the two gears. Cam shaft 284 is mounted to gearbox 168 by two shaft bearings 283 and 285 to be the cam shaft 284 is free rotating on its two bearings and gear 282 is installed on the end of cam shaft 284 and gear 282 is driven to be rotating by gear 263 for imparting rotary motion to cam wheel 286 and the diameter of gear 282 is the same diameter of gears 171, 265 and 170. Cam shaft 284 having the same length of cam shaft 266 and the design of the two shaft bearings 283 and 285 as FIG. 6b shows to be cam shaft 284 can slant to the right if happened a difficulty on the engagement of gears 277 and 278 for avoidance the breakage of the cogs of gears 277 and 278. Cam wheel 286 is mounted on cam shaft 284 so on the rotation of cam shaft 284 causes the rotation of cam wheel 286. Cam wheel 286 is a semicircular plate having a suitable gauge and about 57% toe and 43% heel. Rockshaft 258 is installed to gearbox 168 by two shaft bearings 287 and 289. Rockshaft 258 is free rotating on its bearings for imparting rotary motion of gear 288 to pulley 180 on the engagement of gear 274 and gear 275 and on the disengagement of gear 274 and gear 275, the rockshaft 258 imparts the reverse rotary motion of pulley 180 to gear 288 because the chain 181 in FIG. 5a drive a pulley 180 to be rotating to the reverse rotary direction. Gear 288 is engaged with gear 273 and on the sliding of gear 273 to the left or the right on its axle shaft 272, gear 273 remain engaging with gear 288 because gear 288 having a big width. Rockshaft 177 is be installed to gearbox 168 by two shaft bearings 291 and 292 and rockshaft 177 is free rotating on its bearings. Gear 290 is installed on rockshaft 177 for imparting rotary motion of gear 280 to pulley 183 on the engagement of gear 278 with gear 277 and on the disengagement of gear 277 and gear 278, pulley 183 is driven to be rotating to the reverse rotary direction by the pulling of chain 184 so rockshaft 177, gear 290, gear 280, and gear 278 rotate to the reverse rotary direction also.

On the operation, please refer to FIG. 5a and FIG. 6a.

Before the system starts its work, the toe of cam wheel 270 is contacting with the left surface of gear 273 and gear 274 is engaging with gear 275 and the distance between the long arm 47 and the upper extreme position is about one inch and the long arm 45 having the lower extreme position and gear 277 disengaged with gear 278, after the operator started the work of the system as be mentioned in the description of FIG. 5a, because a chain 197 is slack and chain 182 is trained and a coil spring 189 is strained about two inches or a suitable distance, the long arm 47 descends to down by the gravity and the force of leaf spring 178 so the arciform gear move from down to up in form of arciform movement and gear 170 which is engaging with arciform gear 173 convert this arciform movement to rotary motion of working shaft 169 and gear 261 impart rotary motion to pulley 180 through gear 276, gear 275, gear 274, gear 273, gear 288 and rockshaft 258 so pulley 180 rotate to pull chains 181, 182, 188, 205, 202, 185 and 184 for descent the long arm 47 without strength or mechanical resistance of chain 197 because chain 197 at this time is slack and the long arm 45 is be lifted by chain 202 and pulley 183 is rotating to the reverse rotary direction of 180 so pulley 183, rockshaft 177, gear 290, gear 280, gear 278 their rotation is reverse the rotary direction of pulley 180, rockshaft 258, gear 288, gear 273, gear 274, gear 275, gear 276, gear 277. Gear 260 imparts rotary motion to cam wheel 270 through gear 265 and cam shaft 266. Gear 263 imparts rotary motion to cam wheel 286 through cam shaft 284 and gear 282. Upon the distance between the descendant long arm 47 and the lower extreme position is about one inch or a suitable distance must be the long arm 45 reached to the upper extreme position and the toe of cam wheel 286 touched the right surface of gear 280 for sliding gear 280 to the left for engagement gear 277 and gear 278 so gear 278 imparts rotary motion of gear 277 to pulley 183 through gear 280, gear 290 and rockshaft 177 for rotating pulley 183 to the same rotary direction of pulley 180. Pulley 183 pulls chains 184, 185 and 205 therefore chain 202 is slack to let the long arm 45 descend to down by the gravity and the force of leaf spring 179 and the toe of cam wheel 270 is still contacting with the left surface of gear 273 because the toe of each cam wheel is about 57% or little more and the heel of each cam wheel is about 43% or little less therefore the toe of cam wheel 270 is contacting with gear 273 at the same time the toe of cam wheel 286 is contacting with gear 280, this happen upon the end of the effective stroke of one long arm of a lever and the beginning the effective stroke of the other lever's long arm, till the long arm 47 reaches to the lower extreme position at this time the heel of cam wheel 270 contacted with the left surface of gear 273 to let the coil spring which is installed among gear 273 and gear 276, this coil spring is viewless in FIG. 6a because gear 274 engaging with gear 275, so the said coil spring slides a gear 273 to the left for disengagement gear 274 and gear 275 and because pulley 183 is rotating to train chains 184, 185, 205, 188, 197, 182 and 181 so pulley 180 is driven to be rotating to the reverse rotary direction by chain 181. Long arm 47 is be lifted by chain 197 and upon the distance between the descendant long arm 45 and the system base is about one inch or a suitable distance must be the long arm 47 is reached to the upper extreme position and also started its descent to down for continuation and stabilizing the momentum of the said system. If this system of the present invention is be used for driving a vehicle, the hydraulic line of the braking device 33 is be connected with the main master of the vehicle's brake for increase the brake horsepowers of the vehicle and also another advantage of this design is be used for driving a vehicle, the operator does not need press on the pedal of the clutch with the brake's pedal to stop the vehicle, he uses only the brake's pedal to decrease the car's speed or to stop it.

Gear 170 which for convenience may also be referred to as a first gear.

Gear 171 which for convenience may also be referred to as a second gear.

Gear 260 which for convenience may also be referred to as a third gear.

Gear 261 which for convenience may also be referred to as a fourth gear.

Gear 263 which for convenience may also be referred to as a fifth gear.

Gear 265 which for convenience may also be referred to as a sixth gear.

Gear 282 which for convenience may also be referred to as a seventh gear.

Gear 273 which for convenience may also be referred to as a eighth gear.

Gear 274 which for convenience may also be referred to as a ninth gear.

Gear 275 which for convenience may also be referred to as a tenth gear.

Gear 276 which for convenience may also be referred to as a eleventh gear.

Gear 277 which for convenience may also be referred to as a twelfth gear.

Gear 278 which for convenience may also be referred to as a thirteenth gear.

Gear 280 which for convenience may also be referred to as a fourteenth gear.

Gear 288 which for convenience may also be referred to as a fifteenth gear.

Gear 290 which for convenience may also be referred to as a sixteenth gear.

Cam shaft 266 which for convenience may also be referred to as a first cam shaft.

Cam shaft 284 which for convenience may also be referred to as a second cam shaft.

Cam wheel 270 which for convenience may also be referred to as a first cam wheel.

Cam wheel 286 which for convenience may also be referred to as a second cam wheel.

Working shaft 169 which for convenience may also be referred to as a first common shaft.

Axle shaft 272 which for convenience may also be referred to as a second common shaft.

Drive pulley 180 which for convenience may also be referred to as a first drive pulley.

Drive pulley 183 which for convenience may also be referred to as a second drive pulley.

Rockshaft 258 which for convenience may also be referred to as a first rockshaft.

Rockshaft 177 which for convenience may also be referred to as a second rockshaft.

A coil spring which is installed on axle shaft 272 among gear 273 and gear 276 this coil spring which for convenience may also be referred to as a first coil spring.

A coil spring 279 which for convenience may also be referred to as a second coil spring.

Referring to FIG. 6b and FIG. 6a.

FIG. 6b is a perspective view of the cam shaft components in gearbox 168 of FIG. 6a and gearbox 124 of FIG. 4a. Cam shaft 266 and cam shaft 284 are identical and each one of them is be installed by two shaft bearings on H-frame consisting of two vertical posts 295 and 293 connected with each other by horizontal post 294. The vertical post 293 is be installed on base 299 by joint 297 and the vertical post 295 is be installed on base 303 by joint 301. Leaf spring 296 fixed on the bottom of gearbox 168 by its base 300. Leaf spring 296 is pushing the horizontal bar 294 towards the left surface of gear 273 or towards the right surface of gear 280 so leaf spring 296 acts against the force of the coil spring 279 or the coil spring which is installed among gear 273 and gear 276 and must be the force of leaf spring 296 is three times more than that of coil spring 279 or the other identical coil spring which is installed among gear 273 and gear 276. The vertical post 293 having a projection 298 and the vertical post 295 having a projection 302 for prevention the swing of H-frame towards the right surface of gear 280 or the left surface of gear 273 to be each H-frame stands vertically on the bottom of gearbox 168. Joint 297 and joint 301 let the two vertical posts 293 and 295 can slant towards the right in case of cam shaft 284 in FIG. 6a or cam shaft 145 in FIG. 4a if happened a difficulty on the engagement of gear 277 and gear 278 in FIG. 6a or gear 135 and gear 138 in FIG. 4a and after the engagement of gear 277 and gear 278 in FIG. 6a, the leaf spring 296 pushes the horizontal post 294 towards the right surface of gear 280 for remaining the two posts 293 and 295 stand vertically also joint 297 and joint 301 let the two vertical posts 293 and 295 of cam shaft 266 can slant to the left if happened a difficulty on the engagement of gear 274 and 275, and after the engagement of gear 274 and 275 the leaf spring 296 pushes the horizontal post 294 towards the left surface of gear 273 to remain the two posts 293 and 295 stand vertically.

Vertical post 293 which for convenience may also be referred to as first vertical post.

Vertical post 295 which for convenience may also be referred to as a second vertical post.

Joint 297 which for convenience may also be referred to as a first joint.

Joint 301 which for convenience may also be referred to as a second joint.

Base 299 which for convenience may also be referred to as a first base.

Base 303 which for convenience may also be referred to as a second base.

Referring to FIG. 6c.

FIG. 6c is a perspective plan view of a ring, there being two rings similar this ring are installed in gearbox 168 in FIG. 6a, one of them is installed on the left side of gear 273 for protection the left surface of gear 273 of the wear because the left surface of gear 273 is contacting with cam wheel 270 all the time. Ring 304 having four small arms 307, 309, 305 and 311. Hole 308 for installation arm 307 on the left surface of gear 273 by bolt. Hole 306 for installation an arm 305 by bolt. Hole 312 for installation an arm 311 by bolt. Hole 310 for installation an arm 309 by bolt. Another identical ring is installed on the right surface of gear 280 for protection gear 280 of the wear because its contacting with cam wheel 286. In FIG. 4a an identical ring is installed on the right side of gear 139 of gearbox 124 for protection gear 139 of the wear because its contacting with cam wheel 147.

Referring to FIG. 6d

FIG. 6d is a side axial view of the two cam wheels in gearbox 168 of FIG. 6a upon the contacting of the toe of cam wheel 286 with the right surface of gear 280 and the heel of cam wheel 270 is contacting with the left surface of gear 273 at this position, the long arm 45 is having the middle point between upper and lower extreme position on its descent from up to down while the long arm 47 passed the middle point between upper and lower extreme position on its lifting from down to up.

Referring to FIG. 6e

FIG. 6e i a perspective view of a coil spring 279 in FIG. 6a or a coil spring 137 in FIG. 4a each coil spring of them having two end plates 323 and 322 and each plate having an hole for installation the coil spring on the axle shaft 272 to be each plate is free slide on axle shaft 272.

Referring to FIG. 6f.

FIG. 6f is a side axial view of the end plate 322 or 323 of coil spring 279 in FIG. 6e and coil spring 137 in FIG. 4a. Each plate having a hole 317 for installation a coil spring 279 on axle shaft 272 and installation a coil spring 137 on axle shaft 136 in FIG. 4a.

Referring to FIG. 7, FIG. 3a, FIG. 4a and FIG. 6a.

FIG. 7 is a perspective view shows the shape of the cogs of some gears of gearbox 168, gearbox 36 and gearbox 124. The shape of each cog is right triangle so the momentum is be imparted from any gear to another gear by the right side 325 of each cog. The cog's tip 324. In FIG. 3a there are gear 98, gear 113, gear 96 and gear 104, the shape of their cogs is right triangles. In FIG. 4a there are gear 128, gear 140, gear 138 and gear 135, the shape of their cogs is right triangles. In FIG. 6a there are gear 274, gear 275, gear 277 and gear 278, the shape of their cogs is right triangles, so upon the imparting of the rotary motion from gear to another gear the imparting momentum is on the right side of the cogs not on the leaf springs 296 which is pushing the H-frame towards the neighboring gear as FIG. 6b shows, so this shape of the cogs of the said gears for prevention the disengagement of the said gears upon the imparting of the kinetic energy. Crankshaft 127 in FIG. 4a must be at the same level of axle shaft 136. In FIG. 3a the crankshaft 35, rockshaft 37 and rockshaft 106 must be installed at the same level.

Referring to FIG. 8a.

FIG. 8a is an upper perspective view of the second design of the gearbox which is be used in the second and the third designs of FIG. 5a and FIG. 14 of the present invention. Gearbox 326 having the same work of gearbox 168 in FIG. 5a so any one of gearbox 168 or 326 can be used in the systems of FIG. 5a and FIG. 14. Gearbox 326 includes, a working shaft 327 is installed on the bottom of gearbox 326 by three shaft bearings 328, 331 and 334 to be working shaft 327 is free rotating on its bearings for imparting the rotary motion of gear 171 and gear 170 to a vehicle or an industrial machine for performance useful work. Gear 170 is interconnected with working shaft 327 by a ratchet device so gear 170 to one direction only causes the rotation of working shaft 327 and gear 170 engaging with arciform gear 173 for conversion the arciform reciprocative movement of gear 173 to rotary motion of working shaft 327. Gear 171 having the same diameter of gear 170, 171 is interconnected with working shaft 327 by ratchet mean so gear 171 to one direction only causes the rotation of working shaft 327 but on the rotation of gear 171 to the opposite direction, the working shaft 327 remain stationary, 171 engaging with arciform gear 175 for conversion the arciform reciprocative movement of gear 175 to rotary motion of the working shaft 327. Small arm 172 for change the work of the ratchet device which is interconnecting gear 171 with working shaft 327 to be the ratchet mean can rotate the working shaft 327 to the both two directions after the operator stopped the system by the braking device 33 and brake disk 34 to be the working shaft 327 remain stationary and the system is stopped. Brake disk 34 is installed on the working shaft 327 and the braking device 33 is fixed on the external body of gearbox 326 for control the car's speed if this system is be used to drive a car or to stop the system. Gear 329 is mounted on working shaft 327 and gear 329 is driven to be rotating by working shaft 327 for imparting rotary motion to gear 339 which is engaging with gear 329. Gear 333 is installed on the working shaft 327, on the rotation of 327 causes the rotation of gear 333 which is engaging with gear 351 for imparting rotary motion of the working shaft 327 to gear 351 and gear 333 having the same diameter of gear 329. Gear 330 is installed on working shaft 327 so gear 330 is driven to be rotating by the working shaft 327 for imparting rotary motion to gear 340 which is engaging with gear 330. Gear 332 is coaxially mounted with gear 330 on a working shaft 327 so gear 332 is driven to be rotating by working shaft 327 for imparting rotary motion to gear 345 which is engaging with gear 332, 332 having the same diameter of gear 330. Gear 339 is installed on the spindle shaft 337 for imparting rotary motion of gear 329 to pulley 180 through spindle shaft 337 and clutch 336 which is viewless and rockshaft 485. Gear 339 having a small diameter than that of gear 329 so gear 339 acts as speed-increasing device. Spindle shaft 337 is installed to gearbox 326 by shaft bearing 338 for imparting rotary motion of gear 339 to clutch 336. Clutch 336 is viewless and it may be of suitable known kined and clutch 336 for imparting and disimparting the rotary motion of spindle shaft 337 to the rockshaft 485. Clutch 336 imparts rotary motion for rotation pulley 180 which train a chain 181 as FIG. 5a show for lift the long arm 45 to up and the long arm 47 descend to down and clutch 336 disimpart the rotary motion of spindle shaft 337 to rockshaft 485, pulley 180 rotates to the reverse rotary direction than that of pulley 183 which train chain 184 for lift the long arm 47 which reached to the lower extreme position and the long arm 45 descend to down. Rockshaft 485 is be installed on the system's base by shaft bearing 335, 485 is free rotating on its bearing for imparting rotary motion of clutch 336 to pulley 180. Gear 351 is mounted on spindle shaft 350, 351 is engaging with gear 333 for imparting rotary motion of working shaft 327 to clutch 353 through spindle shaft 350 and the both two gear 351 and 339 are identical, gear 351 having a small diameter so gear 351 acts as speed-increasing device. Spindle shaft 350 is installed to gearbox 326 by shaft bearing 352 to be 350 is free rotating on its shaft bearing for imparting rotary motion of gear 351 to clutch 353. Clutch 353 is viewless and it may be of suitable known kind for imparting and disimparting the rotary motion of spindle shaft 350 to pulley 183 through rockshaft 484. Rockshaft 484 is mounted on the system's base by shaft bearing 354 so rockshaft is free rotating on its bearing. Pulley 183 is installed on rockshaft 484 and pulley 183 is driven to be rotating by rockshaft 484 on the descent of the long arm 45 to down and for lifting the long arm 47 to up. Gear 340 is installed on cam shaft 341 and gear 340 is driven to be rotating by gear 330 which is engaging with 340 and the diameter of gear 340 is the same diameter of gears 170, 345 and 171. Cam shaft 341 is installed inside gearbox 326 by two shaft bearings 342 and 343 to be cam shaft 341 is free rotating on its bearings and cam shaft is driven to be rotating by gear 340. Cam wheel 344 is a semicircular plate with a suitable gauge and it's installed on the end of cam shaft 341 so cam wheel 344 is driven to be rotating by cam shaft 341 for regulation the work of clutch 336 which imparts and disimparts the rotary motion of spindle shaft 337 to rockshaft 485. Cam wheel 344 having 43% toe and 57% heel approximately. Gear 345 is installed on cam shaft 346, 345 is driven to be rotating by gear 332 which is engaging with gear 345. Cam shaft 346 is installed to gearbox 326 by two shaft bearings 347 and 348 to be cam shaft 346 is free rotating on its shaft bearings for imparting rotary motion of gear 345 to cam wheel 349. Cam shaft 346 and cam shaft 341 are identical. Cam wheel 349 is secured on the end of cam shaft 346 and cam wheel 349 is driven to be rotating by cam shaft 346. Cam wheel 344 and cam wheel 349 are identical so the shape of cam 349 is a semicircular plate with a suitable gauge and it having about 43% toe and 57% heel approximately and the installation of cam wheel 349 and cam wheel 344 must be upon contacting the heel of cam wheel 349 with the cam plate 359 which is installed on the end of the connecting rod 362 must be the toe of the other cam wheel 344 is contacting with the cam plate 358 which is installed on the end of the connecting rod 355 for regulation the work of the both two clutches 336 and 353 and the two heels of the two cam wheels are contacting with the two cam plates 359 and 358 at the same time upon the end of the effective stroke of one long arm of a lever and the beginning of the effective stroke of the second long arm of the other lever because the both two cam wheels each one of them having 57% heel. Connecting rod 355 is installed to the body of gearbox 326 by cylindrical bearing 356, to be the connecting rod 355 is free sliding inside 356. Cam plate 358 is a circular plate is fixed on the end of connecting rod 355 for installation a coil spring 357 among the cam plate 358 and the cylindrical bearing 356, upon contacting the toe of cam wheel 344 with the cam plate 358 so the cam plate 358 is be pushed to the left for sliding the connecting rod 355 to the left against the pressure of a coil spring 357 and after cam wheel 344 rotated a half revolution to be the heel of cam wheel 344 is contacting with the cam plate 358 so the coil spring 357 pushes the cam plate 358 to the right for training the connecting rod 355 to the right. The connecting rod 355 imparts the pressure of the toe of cam wheel 344 to the clutch 336 for disimparting the rotary motion of spindle shaft 337 to the rockshaft 485 upon the descent of the long arm 45 to down and lifting the long arm 47 from down to up, after cam wheel 344 rotated about a half revolution to be the heel of cam wheel 344 contacting with cam plate 358 so coil spring 357 pushes cam plate 358 to the right for prevention the pressure on clutch 336 for imparting the rotary motion of spindle shaft 337 to rockshaft 485 for rotation pulley 180. Connecting rod 362 is be installed in gearbox 326 by cylindrical bearing 361 to be the connecting rod 362 is free sliding inside 361 for imparting the pressure of the toe of cam wheel 349 to the clutch 353 for disimparting the rotary motion of spindle shaft 350 to the rockshaft 484. Connecting rods 362 and 355 are identical. Cam plate 359 its shape is a small plate is installed on the end of connecting rod 362 and cam plate 359 is contacting with the edge of cam wheel 349. A coil spring 360 is similar a coil spring 357, 360 is installed on connecting rod 362 among the cam plate 359 and the cylindrical bearing 361 for pushing the cam plate 359 towards the edge of cam wheel 349.

On the operation, please refer to FIG. 5a with FIG. 8a.

Gearbox 326 will be installed at the same place of gearbox 168 and arciform gear 173 engaging with gear 170 and arciform gear 175 engaging with gear 171 and pulley 180 is be connected with the end of chain 181 and pulley 183 is be connected with the end of chain 184. The first step for starting the work of the system, the operator uses the braking device 33 so the working shaft 327 can not be rotated suddenly and then the operator turn the small arm 172 for change the work of the ratchet device which is interconnecting a gear 171 and working shaft 327 to be this ratchet device to one direction only causes the rotation of working shaft 327 and the operator can loose the small arm or leave it installed on this ratchet device, then the operator release the brake device 33 slowly to start the work of the system, at the beginning of the system's work, the long arm 45 having the lower extreme position and the space among the long arm 47 and the upper extreme position is about one inch or a suitable distance so the long arm 47 descends to down and the arciform 173 move to up for rotation gear 170 and working shaft 327 is driven to be rotating by gear 170 and the heel of cam wheel 344 is contacting with the cam plate 358 so the clutch 336 impart rotary motion of working shaft 327 to pulley 180 through gear 329, gear 339, spindle shaft 337 and rockshaft 485 for rotation pulley 180 which train a chain 181 for lifting the long arm 45 from down to up and chain 197 is slack so the long arm 47 is free descent to down by the gravity and the force of leaf spring 178 and before the long arm 47 reaches to the system's base 46 with space about one inch or a suitable distance must be the long arm 45 reached to the upper extreme position and the heel of cam wheel 349 touched the cam plate 359 so the coil spring 360 pushes the cam plate 359 and the connecting rod 362 towards the cam wheel 349 for prevention the pressure of the connecting rod 362 on clutch 353, 353 imparts rotary motion of spindle shaft 350 to the pulley 183 through rockshaft 484 for rotation pulley 183 to the same rotary direction of pulley 180 to coil a chain 184 round pulley 183 so chain 184 train the chains 185 and 205, the training of chain 184 causes the slack of chain 202 to let the long arm 45 descend to down by the gravity and the force of leaf spring 179. Before the long arm 47 reaches to the lower extreme position with a distance about one inch or a suitable distance must be the long arm 45 started the descent from upper extreme position to down by the gravity and the force of the leaf spring 179, on the reaching of the long arm 47 to the system's base 46 the toe of cam wheel 344 contacts the cam plate 358 for pushing the connecting rod 355 to press over clutch 336 for disimparting the rotary motion of spindle shaft 337 to the rockshaft 485 so pulley 180 is driven to be rotating to the reverse rotary direction by the training of chain 184 which is coiled round pulley 183 for pulling the chains 185, 205, 188, 182 and 197, 197 lifts the long arm 47 from down to up and chain 181 drive pulley 180 to be rotating into the reverse rotary direction than that of pulley 183 so the reciprocative movement to up and down of the two long arms 47 and 45 is continuous on the working of the system. The operator can use the braking device 33 to wedge the brake disk 34 so the working shaft 327 can not be rotated and the operator uses the small arm 172 to change the work of the ratchet mean which is interconnecting a gear 171 with working shaft 327 to be this ratchet mean can rotate the working shaft 327 to the both two directions so the working shaft 327 remain stationary.

Gear 170 which for convenience may also be referred to as a first gear.

Gear 171 which for convenience may also be referred to as a second gear.

Gear 329 which for convenience may also be referred to as a third gear.

Gear 333 which for convenience may also be referred to as a fourth gear.

Gear 339 which for convenience may also be referred to as a fifth gear.

Gear 351 which for convenience may also be referred to as a sixth gear.

Gear 330 which for convenience may also be referred to as a seventh gear.

Gear 332 which for convenience may also be referred to as a eighth gear.

Gear 340 which for convenience may also be referred to as a ninth gear.

Gear 345 which for convenience may also be referred to as a tenth gear.

Working shaft 327 which for convenience may also be referred to as a first shaft.

Spindle shaft 337 which for convenience may also be referred to as a second shaft.

Spindle shaft 350 which for convenience may also be referred to as a third shaft.

Rockshaft 485 which for convenience may also be referred to as a first rockshaft.

Rockshaft 484 which for convenience may also be referred to as a second rockshaft.

Drive pulley 180 which for convenience may also be referred to as a first drive pulley.

Drive pulley 183 which for convenience may also be referred to as a second drive pulley.

Connecting rod 355 which for convenience may also be referred to as a first connecting rod.

Connecting rod 362 which for convenience may also be referred to as a second connecting rod.

Coil spring 357 which for convenience may also be referred to as a first coil spring.

Coil spring 360 which for convenience may also be referred to as a second coil spring.

Cam plate 358 which for convenience may also be referred to as a first cam plate.

Cam plate 359 which for convenience may also be referred to as a second cam plate.

Cylindrical bearing 356 which for convenience may also be referred to as a first cylindrical bearing.

Cylindrical bearing 361 which for convenience may also be referred to as a second cylindrical bearing.

Cam wheel 344 which for convenience may also be referred to as a first cam wheel.

Cam wheel 349 which for convenience may also be referred to as a second cam wheel.

Cam shaft 341 which for convenience may also be referred to as a first cam shaft.

Cam shaft 346 which for convenience may also be referred to as a second cam shaft.

Clutch 336 which for convenience may also be referred to as a first clutch.

Clutch 353 which for convenience may also be referred to as a second clutch.

Referring FIG. 8b.

FIG. 8b is a plan view of a plate which is installed on each cam plate in FIG. 8a for protection the cam plate of the wear. Plate 368 having four arms with equal length 369, 371, 319 and 373 and four holes 370, 372, 320 and 374 for installation plate 368 on the cam plate by bolts.

Referring to FIG. 9a.

FIG. 9a is a perspective view of two leaf springs 391 and 394 are strained and connected with each other by two rings 393 and 396. Leaf spring 391 is be installed to the long arms 47 and 45 by ring 392 and the lower leaf spring 394 is be installed on the system's base by ring 395 for driving the long arm of each lever to down with or without the said weight, so the said system of the present invention can convert the force of the leaf springs to rotary motion to be the said system having a light weight and great torque so it can be used for driving an airplane or a small car. The using strong leaf springs will be helpful for production a system having a small size for generation an electric power which can be used to drive an electric motor to drive a small car or an airplane and the speed of the vehicle or the said airplane can be easy controlled by using an electric device or a hydraulic device can be used instead of the said electric method to control the vehicle's speed.

Referring to FIG. 9b.

FIG. 9b is the perspective view of six leaf springs can be used in one spring assembly instead of the weight which is installed on each lever for driving the long arm of each lever to down. Any number of the leaf springs can be used with each lever according to the distance between upper and lower extreme position of the both two long arms 47 and 45 and also the number and the kined of the leaf springs of each lever are identical for stabilizing the momentum of the system. Leaf springs 397 is fixed on the long arms 45 or 47 by ring 400. The two ends of leaf spring 401 and leaf spring 397 are connected with each other by two rings. Leaf spring 401 and leaf spring 398 are connected with each other at the middle by a ring. The two ends of leaf spring 398 and leaf spring 402 are fixed with each other by two rings. Leaf spring 402 is connected with leaf spring 399 by a ring at the middle of the both two leaves. The two ends of leaf spring 399 and leaf spring 403 are connected with each other by two rings. Leaf spring 403 is fixed at its middle with the system's base by a ring.

Referring to FIG. 9c.

FIG. 9c is the perspective view of the six leaf springs can be used with weights 5 and 6 for driving the long arm of each lever to down. Rubber pad 408 is installed on the end of the long arm 47 on 45, 408 acts as silencer. Rubber pad 227 is installed on the weights 5 and 6 for prevention the noise because the both two weights touch the system's base on the operating of the system. Ring 407 for fixing the leaf spring 397 to the weights 5 and 6. Link 405 for connecting the leaf spring 403 with pin 404.

Referring to FIG. 10.

FIG. 10 is a perspective diagram shows that the two levers in the three designs of the present invention of FIG. 1a, FIG. 5a, and FIG. 14 can take any different shape, the system of the present invention can be used for driving a small car so the levers of the said system can move inside a hollow wall on the right or the left side of the vehicle so the levers of the system can take any shape according to the general form of the vehicle. Weight 375 is installed on the long arm 47 by bolt. Weight 376 and weight 375 are identical and weight 376 is installed on the long arm 45 by bolt. Leaf spring 397 is connected with the long arm 47 by a flexible cable 422. Pulley 423 is fixed on the system's base 46 and it's free to rotate on its axle to the both two directions and flexible cable 422 is trained on pulley 423. Leaf spring 403 is connected with link 420 by a flexible cable 421. Link 420 is fixed on the movable part 412 of a vise thereby the straining of the leaf springs can be controlled. Leaf spring 397 is connected with the long arm 45 by a flexible cable 409 which is trained on pulley 410. Pulley 410 is free rotating on its axle and 410 is mounted on the system's base 46. Leaf spring 403 is connected with link 418 by flexible cable 411. Link 418 is fixed on the movable part 412 of a vise thereby the straining of the leaf springs 403, 399, 401 and 397 can be controlled. Worm 413 is engaged with 412 and is installed by bearing 414 and bearing 415 to be worm 413 is free rotating on its bearings. Ratchet device 416 is installed on the end of worm 413 and boom 417 is installed on 416 for rotation the worm 413 to the both two directions by the operator for control to the system's torque by decrease or increase the straining of the two assemblages of leaf springs. The movable part 412 of the vise is installed on shaft 377 to be 412 is free sliding to the right and the left on shaft 377. Gearbox 124 in FIG. 10 is different than gearbox of FIG. 4a because gearbox 124 in FIG. 10 wherein the flywheel 29 is installed on working shaft 127 and a ring gear 30 is installed on 29 for imparting rotary motion of the electric starter 31 to the working shaft 127 on the starting of the system's work. Gear 170 is interconnected with working shaft 127 by ratchet device to be gear 170 to one direction only causes the rotation of the working shaft 127 but on the rotation of gear 170 to the opposite direction, the working shaft 127 remain stationary. Gear 170 is engaged with arciform gear 173 for conversion the arciform movement of gear 173 to rotary motion of working shaft 127. Gear 171 is interconnected with working shaft 127 by ratchet device to be gear 171 to one direction only causes the rotation of working shaft 127 but on the rotation of gear 171 to the opposite direction, the working shaft 127 remain stationary and gear 171 is engaged with arciform gear 175 for conversion the arciform movement of gear 175 to rotary motion of working shaft 127. Brake disk 34 is installed on the working shaft 127 and braking device 33 is installed on the system's base 46 and the both 34 and 33 are be used by the operator for stop the system and controlling to the car's speed if this system is be used to drive a car. Pulley 427 is installed on the working shaft 127 for imparting rotary motion of working shaft 127 to the alternator 424 through a drive belt 426 for recharging the battery of the electric starter 31. Before the operator starts the work of the system must decrease the straining of the leaf springs of the both two levers 1 and 2 by using a boom 417 for rotation worm 413 to decrease the distance between 412 and bearing 415 to be the kenetic energy of the electric starter enough to start the system's work. After the system started its work, the operator increases the straining of the leaf springs by rotation the worm 413 to increase the distance between 412 and bearing 415 for increasing the system's torque. If this system is be utilized to drive a vehicle by generating an electric power and using an electric motor for conversion this electric power to kinetic energy to drive the vehicle for using an electric device to control the car's speed, so the electric current is imparted from alternator 424 to a battery for charging this battery and supplying the electric motor with electricity. Shaft bearing 428 for installation working shaft 127 on the system's base 46. Working shaft 127 imparts the kenetic energy of the system for driving a load such as AC generator at a constant rate.

Referring to FIG. 11a.

FIG. 11a is the perspective view of the manual mechanism for decrease or increase the distance between weight 5 or weight 6 and the suspension point of the lever for control to the system's torque. The objective of this mechanism, upon the using of this system for driving a vehicle having a manual transmission so the mechanism of FIG. 11a can control the distance between each weight and the suspension point of the lever, on the increasing of the distance between each weight and the suspension point of each lever, the torque of the system increases, the speed of each gear in the manual transmission of the vehicle increases. On the decreasing of the distance between each weight and the suspension point of the lever, the torque of the system decreases, the speed of each gear in the manual transmission of the vehicle as well as decreases. If any one of the three designs of the present invention is used to generate electric power at constant rate to drive an electric motor which drives a vehicle and the speed of this vehicle can be controlled by an electric device of known kind, so in this vehicle the mechanism of FIG. 11a is not needed. Worm 3 is mounted on lever 1 by two bearings 7 and 8 to be worm 3 is free rotating on its bearings and worm 3 engaged with weight 5, so weight 5 is free sliding on lever 1 for increase or decrease the distance between 5 and U-joint 15. Ratchet mean 11 is installed on the end on worm 3 for rotation worm 3. Ratchet device 11 is interconnected with the U-joint 429 of boom 430 so ratchet mean 71 is free the reciprocative movement with worm 3 and lever 1. The upper end of boom 430 is a male is connected with female 433 of the lower end of the boom 436 to be the male of boom 430 is free to turn inside female 433. Handle 437 fixed on the upper end of boom 436, the operator uses handle 437 to move ratchet device 11 reciprocally to rotate worm 3 for increase or decrease the distance between weight 5 and U-joint 15. Ratchet device 12 installed on the end of worm 4 of lever 2 for rotation a worm 4 to decrease or increase the distance between weight 6 and the suspension point of lever 2 and the both two ratchet devices 11 and 12 are identical. The lower end of a boom 446 is jointed with ratchet device 12 by U-joint 447 to be ratchet device 12 is free reciprocative movement with lever 2 and worm 4 while boom 446 remains standing vertically. The upper end of boom 446 having a female 445 is engaging with the male of the lower end of boom 444, boom 446 is free to turn reciprocally on the running of the system. The upper end of boom 444 is jointed with U-joint 442 of the linkage arm 443, the other end of the linkage arm 443 is jointed with boom 436 by U-joint 435, as will be obvious, the operator catches a handle 437 and move it reciprocally as the two arrows show for rotation worm 3 and worm 4 at the same time. Cogged pulley 13 mounted on ratchet device 11, 13 is driven to be rotating a half revolution by cogged belt 431 which is trained on cogged pulleys 13 and 438, so on the manual rotation of cogged pulley 438 a half revolution causes the rotation of cogged pulley 13 for turning the rotary direction of worm 3 for increasing or decreasing the distance between weight 5 and U-joint 15. Cogged pulley 14 is installed on ratchet device 12, 14 is driven to be rotating a half revolution by cogged belt 441 which is trained on cogged pulleys 14 and 439 so on the manual rotation of cogged pulley 439 a half revolution causes the rotation of cogged pulley 14 a half revolution for turning the rotary direction of worm 4 of lever 2 for increasing or decreasing the distance between weight 6 and the U-joint 16 of lever 2. Cogged pulley 438 is coaxially mounted with cogged pulley 439 and a small handle 440 is fixed on the pulley 439. Pulleys 438 and 439 are connected with each other and are free rotating on their axle, on the manual rotation of handle 440 causes the rotation of 438 and 439 and the axle of the both two pulleys will be installed on boom 436. Cogged belt 431 having two coil springs one of them is coil spring 432 and the second coil spring is viewless in FIG. 11a and the both two coil springs strain on the reciprocative movement of gear 13 during the running of the system and upon the installation of the cogged belt 431 on cogged pulleys 13 and 438 must be the two coil springs at two different levels for prevention the intertwisting of the two coil springs on the reciprocative movement of a handle 437 by the operator upon the running of the system. Cogged belt 441 is trained on cogged pulleys 439 and 14 and the both two belts 441 and 431 are identical. 441 having two coil springs 448 and the other coil spring is viewless in FIG. 11a, the operator turns handle 440 for turning the rotary direction of the two worms 3 and 4, moving a handle 437 reciprocally for rotation 3 and 4 to increase or decrease the distance between each weight and the suspension point of the lever.

Cogged pulley 13 which for convenience may also be referred to as a first cogged pulley.

Cogged pulley 14 which for convenience may also be referred to as a second cogged pulley.

Cogged pulley 438 which for convenience may also be referred to as a third cogged pulley.

Cogged pulley 439 which for convenience may also be referred to as a fourth cogged pulley.

Ratchet device 11 which for convenience may also be referred to as a first ratchet device.

Ratchet device 12 which for convenience may also be referred to as a second ratchet device.

Belt 431 which for convenience may also be referred to as a first belt.

Belt 441 which for convenience may also be referred to as a second belt.

Boom 430 which for convenience may also be referred to as a fist boom.

Boom 436 which for convenience may also be referred to as a second boom.

Boom 446 which for convenience may also be referred to as a third boom.

Boom 444 which for convenience may also be referred to as a fourth boom.

Handle 437 which for convenience may also be referred to as a first handle.

Handle 440 which for convenience may also be referred to as a second handle.

U-joint 435 which for convenience may also be referred to as a first U-joint.

U-joint 442 which for convenience may also be referred to as a second U-joint.

Worm 3 which for convenience may also be referred to as a first worm.

Worm 4 which for convenience may also be referred to as a second worm.

Weight 5 which for convenience may also be referred to as a first weight.

Weight 6 which for convenience may also be referred to as a second weight.

Lever 1 which for convenience may also be referred to as a first lever.

Lever 2 which for convenience may also be referred to as a second lever.

Referring to FIG. 11b.

FIG. 11b is the perspective view of the belt which is used in mechanism of FIG. 11a. Belt 431 and belt 441 are identical and each belt having cogs 450 for engagement belt 431 with cogged pulley 13 and belt 441 with cogged pulley 14. Cogs 449 for engagement belt 431 with cogged pulley 438 and belt 441 with cogged pulley 439. Belt 431 having two coil springs 432 and 451 with equal force to strain upon the reciprocative movement of the cogged pulley 13. Belt 441 having two coil springs 448 and 451 with equal force to strain upon the reciprocative movement of the cogged pulley 14.

Referring to FIG. 12.

FIG. 12 is the perspective view of the two arms can be used instead of the two levers in the second and the third designs of the present invention in FIG. 5a and FIG. 14. If two arms are be used in the system of FIG. 5a or the system of FIG. 14 for driving an AC generator with a constant rate may be one weight only can be used with each arm for conversion the gravity to rotary motion, but if two arms are be used in the system of FIG. 5a or FIG. 14 for driving a vehicle must be leaf springs are installed with or without the said weight of each arm for driving the free end of each arm to down for driving the system. Arm 454 is installed on the arm 453 of the ratchet device 452 by bolts and the free end 455 of arm 454 is free the reciprocative movement to up and down on the running of the system. Worm 3 is installed on arm 454 by two bearings 7 and 8 to be worm 3 is free rotating on its bearings, 3 engaged with weight 5 for decrease or increase the distance between weight 5 and bearing 7 by rotation the worm 3 for the controlling to the system's torque. Ratchet device 11 is installed on the end of worm 3 for rotation a worm 3 to the both two directions as FIG. 11a shows and cogged pulley 13 is installed on ratchet device 11 for turning the rotary direction of worm 3. Ratchet device 452 is installed on working shaft 169 and 452 to one direction only causes the rotation of working shaft 169 on the movement of the free end 455 from up to down, but on the rotation of ratchet device 452 to the opposite direction, the working shaft 169 remain stationary. Ratchet device 452 having an arm 453 for installation 452 with the end of arm 454. Arm 458 fixedly secured on arm 434 of ratchet device 457 and the free end 459 of arm 458 is free the reciprocative movement to up and down on the running of the system. Worm 4 is installed on arm 458 by two shaft bearings 9 and 10 and worm 4 is free rotating on its two bearings and 4 engaged with weight 6 for decrease or increase the distance between weight 6 and bearing 9 so the operator can control to the system's torque. Ratchet device 12 is installed on the end of worm 4 for rotation 4 to the both two directions as FIG. 11a shows. Cogged pulley 14 is installed on ratchet device 12 for turning the rotary direction of worm 4 as be mentioned in the description of FIG. 11a. Ratchet device 457 is installed on the working shaft 169, 457 to one direction only causes the rotation of working shaft 169 but on the rotation of 457 to the opposite direction, the working shaft 169 remain stationary. Ratchet device 457 having an arm 434 for installation ratchet device 457 with the end of arm 458. An arm 172 is installed on ratchet device 457 for turning the work of ratchet device 457 after the operator stopped the working shaft 169 by the braking device 33 and braking disk 34 so the operator turns arm 172 to be ratchet device 457 can rotate working shaft 169 to the both two directions for remaining the working shaft 169 stationary. The free end 455 is connected with four leaf springs assembly 397, 401, 399 and 403 by link 456 and leaf spring 403 is fixed on the system's base 46 by link 462. The free end 459 is connected with four leaf springs assembly by link 460 and leaf spring 403 is fixed on the system's base 46 by link 461 and the leaf springs of the both two arms are identical. on the operation, please refer to FIG. 5a with FIG. 12, the end 216 of chain 202 is be connected with the free end 459 of arm 458 and the end 217 of chain 197 is be connected with the free end 455 of arm 454 for performance the same work of lever 1 and lever 2 in FIG. 5a.

Referring to FIG. 13.

FIG. 13 is the perspective view shows the combination of two systems by one crankshaft, if the first design of the present invention in FIG. 1a is be used to drive an heavy truck, perhabs is better if two systems of the first design of FIG. 1a are combined with each other to form one system to be the crankshaft of this system having a constant torque. If two gearboxes 36 of FIG. 3a are be used in the system of FIG. 13, as will be obvious that all components of crankshaft 35 in FIG. 3a will be installed on crankshaft 464 of FIG. 13, if two gearboxes 124 of FIG. 4a are be used in the system of FIG. 13, the components of crankshaft 127 in FIG. 4a will be installed on crankshaft 464 of FIG. 13. Brake disk 34 is installed on crankshaft 464 and may braking device 33 be installed on the body of the gearbox or on the system's base 46 and the hydraulic line of 33 can be connected with the main master of the vehicle's brake so the operator does not need use the clutch's pedal to decrease the speed or stop the car. Crankshaft journals 466, 468 and 470 for installation crankshaft 464 on the system's base by shaft bearings. Crank journal 471 is be interconnected with the upper end 40 of connecting rod 41 in FIG. 1a and the crank journal 469 is be interconnected with the upper end 21 of connecting rod 20 so the motion of the both two crank journals 471 and 469 is be controlled by the right gearbox 36 or 124. On reaching of crank journal 469 to the upper extreme position, the crank journal 471 having the lower extreme position because the angle of two crank arms 321 and 365 having 180 degrees so the two crank journals 469 and 471 are on a straight line. The crank journal 467 is be interconnected with the upper end 40 of connecting rod 41 in FIG. 1a for conversion the reciprocative movement of the short arm 176 of lever 2 to rotary motion of crankshaft 464, crank journal 465 is be interconnected with the upper end 21 of connecting rod 20 for conversion the reciprocative movement of the short arm 174 of lever 1 to rotary motion of crankshaft 464. The angle between crank arm 380 and crank arm 381 is 180 degrees and the reciprocative movement of the two levers 1 and 2 which are be interconnected with 467 and 465, the left gearbox 36 or 124 regulates the reciprocative movement of each lever is be interconnected with crank journal 467 or crank journal 465. The angle of crank arm 379 and crank arm 378 is 90 degrees for stabilizing the momentum of crankshaft 464.

The left gearbox 36 or 124 which for convenience may also be referred to as a first gearbox.

The right gearbox 36 or 124 which for convenience may also be referred to as a second gearbox.

The crank journal 465 which for convenience may also be referred to as a first crank journal.

The crank journal 467 which for convenience may also be referred to as a second crank journal.

The crank journal 469 which for convenience may also be referred to as a third crank journal.

The crank journal 471 which for convenience may also be referred to as a fourth crank journal.

The crank arm 381 which for convenience may also be referred to as a first crank arm.

The crank arm 380 which for convenience may also be referred to as a second crank arm.

Crank arm 379 which for convenience may also be referred to as a third crank arm.

Crank cam 378 which for convenience may also be referred to as a fourth crank arm.

Crank arm 365 which for convenience may also be referred to as a fifth crank arm.

Crank arm 321 which for convenience may also be referred to as a sixth crank arm.

Referring FIG. 14.

FIG. 14 is the perspective view of the third design of the present invention comprises. Lever 1 is suspended by U-joint 15 to be a suitable space between lever 1 and the system's base, the short arm 174 and the long arm 47 are free to move reciprocally to up and down on the running of the system. Arciform gear 173 is installed on the short arm 174, 173 engaged with gear 170. Gear 170 is interconnected with working shaft 169 by a ratchet device so gear 170 to one direction only causes the rotation of working shaft 169 but on the rotation of gear 170 to the reverse rotary direction, the working shaft 169 remain stationary, gear 170 convert the arciform reciprocative movement of gear 173 to rotary motion of the working shaft 169. Leaf spring 178 having an acute angle and it's installed on the stand of U-joint 15 by one end and the second end of leaf spring 178 is installed to lever 1 for dropping the long arm 47 to down and prevention the shaking of the long arm 47 to up upon the effective stroke of 47 to down while the vehicle is driven is this system is be used to drive a vehicle. Weight 5 is installed on the long arm 47 and 5 is free to slide on the long arm for increasing or decreasing the distance between weight 5 and the suspension point by U-joint 15 to be the operator able to control the system's momentum. Worm 3 is installed on the long arm 47 of lever 1 by two bearings 7 and 8, worm 3 is free to rotate on its two bearings and 3 is engaged with weight 5 for sliding a weight 5 on lever 1. Ratchet device 11 is installed on the end of worm 3 for rotation worm 3 to the both two directions as FIG. 11a shows and cogged pulley 13 is installed on ratchet device 11 for turning the rotary direction of worm 3 as the manual mechanism of FIG. 11a shows. Guiding device 473 is a rectangular frame is installed on the vertical post 477 and the system's base 46, 473 for limitation the reciprocative movement of the long arm 47 and also protection the long arm 47 and bolt 475 to fixing a guiding device 473 on the system's base 46. Rubber pad 474 is installed in the guiding device 473, 474 acts as silencer and for protection the long arm 47. Vertical post 477 is installed on the system's base 46 and pulley 472 is installed on 477 by its axle, pulley 472 is free rotating on its axle and chain 181 is trained on pulley 472. Lever 2 is suspended on U-joint 16 to be a suitable distance between lever 2 and the system's base 46, the long arm 45 and the short arm 176 are free to move reciprocally to up and down on the running of the system, lever 1 and lever 2 are identical. Leaf spring 179 having an acute angle and it's installed on the standing of U-joint 16 by one end and its second end is installed to the lever 2 and leaf springs 179 and 178 are identical. Arciform gear 175 is installed on the short arm 176 of lever 2 and 175 engaged with gear 171. Gear 171 is interconnected with working shaft 169 by ratchet device to be gear 171 to one direction only causes the rotation of working shaft 169 but on the rotation of gear 171 to the opposite direction, the working shaft 169 remain stationary, gear 171 convert the reciprocative movement of the short arm 176 to rotary motion of working shaft 169. Small arm 172 for change the work of ratchet device of gear 171 to be this ratchet device into two directions causes the rotation of working shaft 169 for remaining the system stopping after the operator stopped the working shaft 169 by braking device 33 and braking disk 34. Worm 4 is installed on the long arm 45 of lever 2 by two bearings to be 4 is free to rotate on its two bearings. Ratchet device 12 is installed on the end of worm 4 for rotation worm 4 to the both two directions as FIG. 11a shows. Cogged pulley 14 is installed on ratchet device 12 for change the rotary direction of worm 4 as FIG. 11a shows. Weight 6 is installed on long arm 45 of lever 2, 6 is free sliding on lever 2 and weight 6 is engaged with worm 4 for decrease or increase the distance between weight 6 and the suspension point by U-joint 16 as FIG. 11a shows. Guiding device 479 is a rectangular frame is installed on the vertical post 478 and the system's base 46 for limitation the reciprocative movement of the long arm 45 and protection the long arm 45. Rubber pad 480 is installed on the guiding device 479 for protection the long arm 45 and also 480 acts as silencer. Vertical post 478 is installed on the system's base 46 for bearing a pulley 476 which is installed on the top of 478 by its axle to be pulley 476 is free rotating into the both two directions and chain 184 is trained on pulley 476, chain 184 is installed on drive pulley 183 by one end and its second end is fixed on the upper end of coil spring 63 and the lower end of coil spring 63 is fixed on the long arm 45, on the rotation of drive pulley 183, chain 184 coils round drive pulley 183 for lifting the long arm 45 from down to up. Chain 181 and chain 184 are identical. Chain 181 is installed on drive pulley 180 by one end and its second end is fixed on the upper end of coil spring 48 and the lower end of coil spring 48 is fixed on the long arm 47 and chain 181 trained on pulley 472, on the rotation of the drive pulley 180, chain 181 coils round drive pulley 180 for lifting the long arm 47 from down to up.

On the operation, before the system starts its work, the long arm 47 having upper extreme position and the long arm 45 having the lower extreme position, the operator uses the braking device 33 and brake disk 34 for prevention the rotation of working shaft 169 suddenly, and then the operator turns an arm 172 for change the work of the ratchet device which is interconnected a gear 171 with working shaft 169 to be the said ratchet device to one direction only causes the rotation of working shaft 169. The operator may leaves an arm 172 installed on the ratchet device or loose it before the system starts its work, the operator release the braking device gradually for starting the system's work. The long arm 47 descends to down, the short arm 174 moves to up, the arciform gear 173 imparts the movement of the short arm 174 to working shaft 169 through gear 170, the automatic transmission mechanism inside gearbox 168 is disimparting the rotary motion to drive pulley 180, the long arm 47 trains chain 181, drive pulley 180 is driven to be rotating into the reverse rotary direction than that of drive pulley 183 by chain 181, at this time the automatic transmission mechanism of gearbox 168 imparts rotary motion to drive pulley 183 for training chain 184 which coil on drive pulley 183 for lifting the long arm 45 from down to up, before the long arm 47 reaches to the lower extreme position with distance about one inch or a suitable distance according to the system's size must be the long arm 45 is reached to the upper extreme position and also is started its descent from up to down before the long arm 47 reaches to the system's base 46 for remaining the system working so the two cam wheels in gearbox 168 each one of them having about 57% heel and 43% toe. Coil spring 48 its upper end is connected with the end of chain 181 and the lower end of coil spring 48 is connected with the part of long arm 47 and coil spring 48 is gauged to strain about one inch of a suitable distance on the training of chain 181 is equal to three times the total weights or forces which drop the long arm 47 to down including the weight 5 and the weight of the long arm 47 and the weight of worm 3 and the force of leaf spring 178 for straining the coil spring 48 one inch on the reaching of long arm 47 to upper extreme position for remaining the distance between the upper extreme position and the lower extreme position is constant. Coil spring 63 and coil spring 48 are identical. The upper end of coil spring 63 is connected with chain 184 and the lower end of coil spring 63 is connected with the part of long arm 45.

Lever 1 which for convenience may also be referred to as a first lever.

Long arm 47 which for convenience may also be referred to as a first long arm.

Short arm 174 which for convenience may also be referred to as a first short arm.

Arciform gear 173 which for convenience may also be referred to as a first arciform gear.

Gear 170 which for convenience may also be referred to as a first gear.

U-joint 15 which for convenience may also be referred to as a first U-joint.

Leaf spring 178 which for convenience may also be referred to as a first leaf spring.

Worm 3 which for convenience may also be referred to as a first worm.

Weight 5 which for convenience may also be referred to as a first weight.

Guiding device 473 which for convenience may also be referred to as a first guiding device.

Rubber pad 474 which for convenience may also be referred to as a first rubber pad.

Pulley 472 which for convenience may also be referred to as a first pulley.

Coil spring 48 which for convenience may also be referred to as a first coil spring.

Chain 181 which for convenience may also be referred to as a first chain.

Cogged pulley 13 which for convenience may also be referred to as a first cogged pulley.

Ratchet device 11 which for convenience may also be referred to as a first ratchet device.

Vertical post 477 which for convenience may also be referred to as a first vertical post.

Drive pulley 180 which for convenience may also be referred to as a first drive pulley.

Lever 2 which for convenience may also be referred to as a second lever.

Long arm 45 which for convenience may also be referred to as a second long arm.

Short arm 176 which for convenience may also be referred to as a second short arm.

Weight 6 which for convenience may also be referred to as a second weight.

Worm 4 which for convenience may also be referred to as a second worm.

Arciform gear 175 which for convenience may also be referred to as a second arciform gear.

U-joint 16 which for convenience may also be referred to as a second U-joint.

Leaf spring 179 which for convenience may also be referred to as a second leaf spring.

Ratchet device 12 which for convenience may also be referred to as a second ratchet device.

Cogged pulley 14 which for convenience may also be referred to as a second cogged pulley.

Pulley 476 which for convenience may also be referred to as a second pulley.

Chain 184 which for convenience may also be referred to as a second chain.

Drive pulley 183 which for convenience may also be referred to as a second drive pulley.

Coil spring 63 which for convenience may also be referred to as a second coil spring.

Guiding device 479 which for convenience may also be referred to as a second guiding device.

Rubber pad 480 which for convenience may also be referred to as a second rubber pad.

Vertical post 478 which for convenience may also be referred to as a second vertical post.

Gear 171 which for convenience may also be referred to as a second gear.

Rockshaft 258 which for convenience may also be referred to as a first rockshaft.

Rockshaft 177 which for convenience may also be referred to as a second rockshaft.

I claim:

1- A power generating system converts the gravity and the force of the leaf springs to continuous rotary motion for driving a car, a ship, an airplane, an industrial machine,
an agricultural machine and AC generator and also the said system convert the force of the leaf springs only to continuous rotary motion to be the said system having a light weight to drive an airplane, a car, a truck, a ship and AC generator therefore the said system having three different designs to be the said system suitable for the different purposes, the first design of the system of the present invention comprises.
the first lever is suspended on the system's base by the third U-joint to be the first long arm and the short arm of the first lever are free to move reciprocally to up and down.
the first weight is installed on the first long arm for driving the first long arm from up to down and moving the short arm of the first lever from down to up and this arciform movement of the said short arm is be imparted to the gearbox by the first connecting rod and the first crank, the first weight is free to slide on the first long arm by the first worm for increase or decrease the distance between the first weight and the third U-joint for controlling to the system's torque.
the first worm is installed on the first long arm and the said first worm is engaged with the first weight so on the rotation of the first worm by a manual mechanism of a boom causes the sliding of the first weight to increase or decrease the distance between the said first weight and the suspension point of the first lever for controlling to the system's torque.
a first U-joint is installed on the short arm of the first lever and it's interconnected with the lower end of the first connecting rod for conversion the reciprocative movement of the short arm of the first lever to rotary motion of the crankshaft of the gearbox through the first crank.
a first connecting rod its upper end is interconnected with the first crank and its lower end is interconnected with the first U-joint for conversion the reciprocative movement of the short arm of the first lever to the rotary motion of the crankshaft.
a first crank is installed on the crankshaft of the gearbox for conversion the reciprocating movement of the first U-joint and the first connecting rod to rotary motion of the crankshaft which imparts rotary motion to the gearbox of the system.
a first guiding device its shape is a rectangular frame is installed on the system's base for limitation the reciprocative movement of the first long arm and protection the first long arm and prevention the noise by a rubber pad is installed on the upper side of the said first guiding device.
a system's body having a system's base thereon a vertical post is installed for bearing a horizontal post which thereon the first and the second pulleys are installed.
a second lever is suspended on the system's base by the fourth U-joint to be the second long arm and the short arm of the said second lever are free to move reciprocally to up and down.
a second weight is installed on the second long arm and it's free sliding on the second long arm by the second worm to increase or decrease the distance between the said second weight and the fourth U-joint for controlling to the system's torque and the said second weight for driving the second long arm to down for conversion the potential energy of the second weight to rotary motion of the crankshaft of the system's gearbox.
second worm is identical with the first worm and it's installed on the second long arm by two bearings to be the said second worm is free rotating on is bearings by a manual mechanism and it's engaged with the second weight for sliding the said second weight on the second long arm on the rotation of the second worm by a manual mechanism.
a manual mechanism for rotation the said first worm and the second worm for sliding the said the first weight on the first long arm and the second weight on the second long arm.
a second U-joint is installed on the short arm of the second lever and it's interconnected with the lower end of the second connecting rod for imparting the reciprocative movement of the short arm of the second lever to the second crank through the second connecting rod for conversion the reciprocating movement of the short arm of the second lever to rotary motion of the crankshaft of the system's gearbox.
a second connecting rod its lower end is interconnecting with the said second U-joint and the upper end of the said second connecting rod is interconnected with the second crank for conversion the reciprocative movement of the short arm of the second lever to rotary motion of the crankshaft.
a crankshaft for conversion the reciprocative motion of the first and the second connecting rods to rotary motion of the said crankshaft.
a braking rotary member is installed on the said crankshaft for stop the said crankshaft by a braking device.
a braking device is installed on the system's gearbox or may the said braking device be installed on the system's base for stop the system.
a gearbox with two different designs each one of them having an automatic transmission mechanism for imparting rotary motion of the said crankshaft to a rockshaft for regulation the reciprocative movement of the first and the second long arms and also the said gearbox imparts kenetic energy of the said crankshaft to a working shaft for driving a load such as a vehicle, a ship, an airplane and AC generator.
a rockshaft is installed to the said gearbox by one end and its other end is installed on the said vertical post of the system's body for imparting rotary motion of the said gearbox to the third and fourth drive pulleys which are installed on the end of the said rockshaft for regulation the reciprocative movement of the first and the second long arms.
a working shaft is installed to the said gearbox for imparting rotary motion of the said gearbox to a load such as AC generator.
a flywheel is installed on the said working shaft for stabilizing the momentum inertia of the said working shaft.
a ring gear is installed on the said flywheel for imparting rotary motion of the pinion gear of the electric starter to the working shaft for starting the work of the said system.
a drive pulley is installed on the said working shaft for imparting rotary motion of the said working shaft to an alternator through a drive belt.
an alternator is installed on the system's base and is driven to be rotating by the said drive pulley which is installed on the said working shaft for generation an electric power for recharging the battery of the electric starter.
an electric starer is installed on the said gearbox or on the system's base for starting the system's work.
a third drive pulley is installed on the said rockshaft and it's interconnected with the second long arm by the second chain and a coil spring for lift the second long arm to up.
a fourth drive pulley is installed on the end of the said rockshaft and it's driven to be rotating by the said rockshaft and it's interconnected with the said first long arm by the first chain and a coil spring fir lift the said first long arm to up.
a first chain is connected with the fourth drive pulley by one end and its second end is connected with the first long arm through a coil spring and the said first chain to coil round the fourth drive pulley for lift the first long arm to up.
a second chain is identical with the first chain and the said second chain is connected with the third drive pulley by one end and its second end is connected with the second long arm through a coil spring for lift the second long arm to up.
an additional lever for more than one additional lever can be used with the first lever and the second lever for increasing the momentum of the said system and the number of the additional lever for the first lever and the second lever must be equal number for stabilizing the momentum of the system.
a plurality of the leaf springs can be used in one leaf spring assembly is installed with each long arm for driving the first and the second long arms to down with or without using the first and the second weights.
a vise can be used instead of the said first and the second worms for decrease or increase the straining strength of the leaf springs in case of leaf springs are be used with or without the said first and the second weights.
the second design of the present invention includes.
a first lever is suspended on the system's base by a first U-joint to be the first long arm and the first short arm are free to move reciprocally to up and down.
a first weight is installed on the first long arm to be the first weight is free sliding on the first long arm for descent the free end of the first long arm from up to down.
a first leaf spring having an acute angle is fixed on the first long arm by one end and its second end is fixed on the vertical stand of the first U-joint for dropping the first long arm to down.
a first worm is installed on the first long arm by two bearings to be the said first worm is free rotating on its bearings and it's engaged with the first weight for decrease or increase the distance between the said first weight and the first U-joint for controlling to the system's torque.
a first arciform gear is installed on the free end of the first short arm for imparting the reciprocative movement of the first short arm to the first gear.
a first gear is be interconnected with the working shaft by a ratchet device, to one direction only causes the rotation of the said working shaft for conversion the reciprocative arciform movement of the first arciform gear to rotary motion of the said working shaft.
a working shaft for imparting the rotary motion of the first gear and the second gear to the system's gearbox.
a braking rotary member is installed on the said working shaft for stopping the system.
a braking device is installed on the gearbox of the system or it's installed on the system's base for stop the system.
a second lever is suspended on the system's base by the second U-joint to be the second short arm and the second long arm are free to move reciprocally to up and down.
a second weight is installed on the second long arm for dropping the second long arm to down and the said second weight is free sliding on the second long arm.
a second worm is installed on the second long arm by two bearings to be the second worm is free rotating on its bearings and it's engaged with the second weight for decrease or increase the distance between the said second weight and the second U-joint on the rotation of the second worm by using a manual mechanism or a boom for rotation the second worm.
a manual mechanism for rotation the said first worm and the second worm.
a second leaf spring having an acute angle and is upper end is fixed to the second long arm and the other end of the second leaf spring is installed to the stand of the second U-joint for dropping the long arm to down.
a vise can be used instead of the first and the second worms for decrease or increase the straining strength of the leaf springs if one leaf spring assembly is be used with each long arm to drive the first long arm and the second long arm to down with or without the said first and the second weights.
a system's base for installation the various ones of the components of the system thereon.
a system's body having the first vertical post and the second vertical post for bearing a horizontal post which thereon four pulleys are installed.
a first guiding device is a vertical arm is installed on the said horizontal post by one end and the other end of the first guiding device is installed on the system's base for limitation the reciprocative movement of the first long arm and protection the first long arm.
a second guiding device for limitation the reciprocative movement of the second long arm and protection the second long arm and the both two first and the second guiding devices are identical.
a gearbox having two different designs for regulation the reciprocative movement of the first long arm and the second long arm through the first rockshaft and the second rockshaft and imparting the kinetic energy of the said system to a load such as AC generator or a vehicle through the said working shaft.
a first drive pulley is installed on the first rockshaft and it's driven to be rotating by the rotation of the first rockshaft and it's connected with the first chain.
a second drive pulley is installed on the second rockshaft and the said second drive pulley is driven to be rotating by the rotation of the second rockshaft and the end of the eighth chain is connected with the second drive pulley and the eight chain coils round the second drive pulley for lift the first long arm to up during the descent of the second long arm to down.
a second arciform gear is installed on the end of the second short arm and the said second arciform gear is engaged with the second gear for conversion the arciform movement of the second short arm to rotary motion of the said working shaft.
a second gear is be interconnected with the said working shaft by a ratchet mean so the second gear to one direction only causes the rotation of the working shaft but on the rotation of the second gear to the opposite direction, the said working shaft remain stationary and the said second gear is engaged with the second arciform gear for conversion the reciprocative movement of the second short arm to rotary motion of the working shaft.
a small arm is installed on the ratchet device of the second gear so the operator can use if for change the work of the said ratchet device to be this ratchet device can rotate the working shaft to the both two directions for remaining the system stopped after the operator stopped the rotation of the working shaft by the said braking device and the braking rotary member.
a third pulley is installed on the horizontal post of the system's body and it's free to rotate on its axle and the second chain is trained thereon.
a fourth pulley is installed on the horizontal post of the system's body and it's free to rotate on its axle and the third chain is trained on the said fourth pulley.
a fifth pulley is installed on the horizontal post of the system's body and it's free to rotate on its axle and the sixth chain is trained thereon.
a sixth pulley is installed on the horizontal post of the system's body and the seventh chain is trained thereon.
a seventh pulley is installed on the system's base and it's free to rotate on its axle and the second chain is trained thereon.
an eighth pulley is installed on the system's base and it's free to rotate on its axle and the seventh chain is trained thereon.
a ninth pulley is installed on the system's base and it's free to rotate on its axle and the fourth chain is trained thereon.
a tenth pulley is installed on the system's base and it's free to rotate on its axle and the fifth chain is trained thereon.
a first chain is installed on the first drive pulley by one end and the other end of the first chain is connected with the end of the second chain so on the rotation of the said first drive pulley during the descent of the first long arm, the first chain coils round the first drive pulley for training the second chain, the fourth chain, the fifth chain, the seventh chain and the eighth chain, the eighth chain which drives the second drive pulley to be rotating to the opposite rotary direction than that of the first drive pulley and also the sixth chain lifts the second long arm from down to up upon the descent of the first long arm to down.
a second chain for connection the first chain with the third chain and the fourth chain through a linkage and the second chain is trained on the seventh pulley and the third pulley.
a third chain is connected the two ends of the second and the fourth chains with the free end of the first long arm for lift the first long arm from down to up upon the descent of the second long arm from up to down.
a fourth chain is trained on the ninth pulley, one end of the fourth chain is connected with the two ends of the second and the third chains and the second end of the fourth chain is connected with a coil spring.
a coil spring is connected the end of the fourth chain with the end of the fifth chain to be the said coil spring strained about two inches or a suitable distance before the first long arm or the second long arm reaches to the lower extreme position with a distance about one inch or a suitable distance and the other long arm starts the descent from up to down for continuation the system's work.
a fifth chain having one end is connected with the said coil spring and the second end is connected with the end of the sixth chain and the end of the seventh chain through a linkage and the fifth chain is trained on the tenth pulley for training the sixth chain which lifts the second long arm to up upon the descent of the first long arm to down and also the said fifth chain to train the seventh chain and the eighth chain, the eighth chain drives the second drive pulley to be rotating to the reverse rotary direction than that of the first drive pulley on the descent of the first long arm to down and lifting the second long arm to up.
a sixth chain is connected with the free end of the second long arm and the other end of the sixth chain is connected with the end of the fifth chain and the end of the seventh chain through a linkage for lifting the second long arm from down to up upon the descent of the first long arm to down.
a seventh chain is trained on the sixth pulley and the eighth pulley for connection the two ends of the sixth chain and the fifth chain with the end of the eighth chain for training the eighth chain which drives the second drive pulley to be rotating to the reverse rotary direction than that of the first drive pulley during the descent of the first long arm to down.
an eighth chain having one end is fixed on the second drive pulley and the second end of the eighth chain is connected with the end of the seventh chain, the eighth chain coils round the second drive pulley on the rotation of the second drive pulley for lifting the first long arm from down to up and descent the second long arm to down and the said eighth chain drives the second drive pulley to be rotating to the reverse rotary direction than that of the first drive pulley on the descent of the first long arm to down and lifting the second long arm to up.
two arms can be used instead of the two levers each one of them is interconnected with the working shaft by a ratchet mean for rotation the said working shaft to one direction only and the first weight is installed on one arm and the second weight is be installed on the other arm and also the first worm installed on one arm and the second worm installed on the other arm and also leaf springs can be used in one leaf spring assembly installed to the free end of each arm for driving the free end of each arm to down for rotation the said working shaft.
an additional lever or more than one additional lever can be used with the first lever and the second lever for increasing the momentum of the said system and the number of the additional levers of the first lever and the second lever must be equal number for stabilizing the momentum of the system.
a plurality of the leaf springs can be used in one leaf spring assembly and installed with each long arm for driving the first and the second long arms to down with or without using the said first and the second weights.
a first rockshaft for imparting a rotary motion of the said gearbox to the first drive pulley for training the first chain which coils round the said first drive pulley for training the second chain, the fourth chain, the fifth chain and the sixth chain, the sixth chain which lifts the second long arm from down to up upon the descent of the first long arm to down and the fifth chain trains the seventh chain and the eighth chain for driving the second drive pulley to be rotating to the reverse rotary direction than that of the first drive pulley and lifting the second long arm to up.
a second rockshaft for imparting a rotary motion of the said gearbox to the second drive pulley for training the eighth chain to coil round the second drive pulley for training the seventh chain, the fifth chain, the fourth chain and the third chain, the third chain lifts the first long arm from down to up upon the descent of the second long arm from up to down, the first chain and the second chain are be trained by the third chain for driving the first drive pulley to be rotating into the reverse rotary direction than that of the second drive pulley.
the third design of the present invention includes.
a first lever is suspended on the system's base by the first U-joint to be the first long arm and the first short arm are free to move reciprocally to up and down on the running of the system.
a first arciform gear is installed on the first short arm and it's engaging with the first gear.
a first gear is interconnected with the working shaft of the gearbox of the system by a ratchet mean so the first gear to one direction only causes the rotation of the working shaft but on the rotation of the first gear to the opposite direction, the said working shaft remain stationary and the first gear engaged with the first arciform gear for conversion the reciprocative movement of the first short arm from down to up into rotary motion of the working shaft.
a first weight is installed on the first long arm for driving the first long arm from up to down for imparting this movement to the said working shaft through the first short arms the first arciform gear, the first gear and a ratchet device, the said ratchet device to convert the reciprocative movement of the first arciform gear to the rotary motion of the working shaft and the first weight is free sliding on the first long arm by the first worm for increase or decrease the distance between the first weight and the first U-joint for controlling to the system's torque.
a first worm is installed on the first long arm by two bearings to be the first worm is free rotating on its bearings and the said first worm is engaging with the first weight for sliding the first weight on the first long arm for decrease or increase the distance between the first weight and the first U-joint for controlling to the system's torque and the first worm is be rotated by a manual mechanism or a boom.
a second lever is suspended on the system's base by the second U-joint to be the second long arm and the second short arm are free to move reciprocally on the running of the system and the both two first and the second levers are identical.
a second arciform gear is installed on the end of the second short arm for imparting the reciprocative movement of the second short arm to the second gear.
a second gear is be interconnected with the said working shaft by a ratchet mean so the second gear to one direction only causes the rotation of the working shaft but on the rotation of the second gear to the opposite direction the working shaft remain stationary for conversion the reciprocative movement of the second arciform gear to rotary motion of the said working shaft.
a second weight is mounted on the second long arm for driving the second long arm to down and the second weight is free to slide on the second long arms the second and the first weights are identical.
a second worm is installed on the second long arm by two bearings to be the second worm is free rotating to the both two directions by a manual mechanism or a boom and the second worm is engaged with the second weight for sliding the second weight on the second long arm for decrease or increase the distance between the second weight and the second U-joint for controlling to the system's torque, the second and the first worms are identical.
a manual mechanism for rotation the first worm and the second worm for sliding the first weight on the first long arm and the second weight on the second long arm for controlling to the system's torque.
a first leaf spring having an acute angle is fixed to the first long arm by one end and its second end is fixed on the stand of the first U-joint by an U-linkage for driving the first long arm to down with the said first weight.
a second leaf spring is identical with the first leaf spring and the second leaf spring is mounted on the second long arm by U-linkage and the second end of the second leaf spring is mounted on the stand of the second U-joint by U-linkage for driving the second long arm to down.
a braking device is installed on the system's base for stopping the system.
a braking rotary member is installed on the working shaft for stop the system.
a system's base thereon the gearbox, the stand of the first U-joint, the stand of the second U-joint, the first vertical post, the second vertical post, the first guiding device, the second guiding device and the braking device are installed.
a first vertical post is installed on the system's base for bearing the first pulley.
a first guiding device is a rectangular frame installed on the first vertical pot for limitation the reciprocative movement of the first long arm and protection the first long arm.
a first coil spring is connected the end of the first chain with the free end of the first long arm and the first coil spring strains about one inch or a suitable distance on the training of the first chain equal to three times the total forces which drive the first long arm to down.
a first rubber pad is installed on the first guiding device and it acts as silencer.
a first pulley is installed on the top of the first vertical post and it's free rotating on its axle and the first chain is trained thereon.
a second vertical post is installed on the system's base for bearing the second pulley.
a second pulley is installed on the top of the second vertical post and it's free rotating on its axle and the second chain is trained thereon.
a second guiding device is installed on the second vertical post for limitation the reciprocative movement of the second long arm and protection the second long arm.
a second rubber pad is installed on the second guiding device for protection the second long arm and also it acts as silencer.
a second coil spring is connected the end of the second chain with the free end of the second long arm and the second coil spring is be strained about one inch or a suitable distance on the training of the second chain equal to three times the total forces which drive the second long arm to down.
a first drive pulley is installed on the first rockshaft of the gearbox and it's connected with the end of the first chain so on the rotation of the first drive pulley, the first chain coils round it for lift the first long arm to up upon the dropping of the second long arm to down.
a second drive pulley is installed on the second rockshaft and the end of the second chain is connected with the second drive pulley so on the rotation of the said second drive pulley, the second chain coils round it for lifting the second long arm to up upon the descent of the first long arm to down.
a first chain having an end is connected with the first drive pulley and the second end of the first chain is connected with the free end of the first long arm through the first coil spring and the first chain is trained on the first pulley for lifting the first long arm to up upon the descent of the second long arm to down.
a second chain having an end is connected with the second drive pulley and the second end of the second chain is connected with the free end of the second long arm through the second coil spring so upon the rotation of the second drive pulley, the second chain coils round the second drive pulley for lifting the second long arm to up upon the dropping of the first long arm to down.
a plurality of the leaf springs can be used in one leaf spring assembly for driving the first long arm to down and another one leaf spring assembly for driving the second long arm to down for conversion the force of the leaf springs to rotary motion with or without using the first and the second weights.
an additional lever or more than one additional lever can be used with the first lever and the second lever for increase the system's momentum and each additional lever is be interconnected with the first lever or with the second lever by a transfer linkage and the number of the additional levers of the first and the second levers must be equal number for stabilizing the momentum of the system.
a vise can be used instead of the first worm and the second worm for decrease or increase the straining of the leaf springs for controlling to the system's torque.
two arms can be used instead of the two levers and one end of each arm is interconnected with the said working shaft by a ratchet mean for conversion the reciprocative movement of the free end of each arm to rotary motion of the working shaft and the first weight will be installed on the free end of one arm and the second weight will be installed on the free end of the second arm for driving the free end of each arm to down and one leaf spring assembly can be used with each arm for driving the free end of the arm to down for conversion the force of the leaf springs to rotary motion of the said working shaft.
a first rockshaft is installed on the gearbox of the system for imparting rotary motion of the gearbox to the first drive pulley for rotation the first drive pulley which trains the first chain for lifting the first long arm from down to up upon the dropping of the second long arm to down.
a second rockshaft for imparting rotary motion of the gearbox to the second drive pulley for rotation the second drive pulley which trains the second chain for lift the second long arm to up upon the dropping of the first long arm to down.
a gearbox having two different designs for controlling the reciprocative movement of the first long arm and the second long arm through the first rockshaft and the second rockshaft and imparting the kenetic energy of the said system to a load such as AC generator or a vehicle.

2- The power generating system-three designs of claim 1 where the first lever and the second lever and the said additional levers perhaps having different shapes according to the general form of the vehicle's body to be all the levers are free movement reciprocally in a hollow wall on the left side or at the longitudinal middle of the vehicle.

3- The power generating system-three designs of claim 1 wherein the said mechanical linkage which is interconnecting the said additional lever with the first lever on the second lever includes,
a first arciform gear is installed on the short arm of an additional lever and engaged with the second gear which is installed on a rockshaft for conversion the reciprocative movement of the short arm of the said additional lever to rotary motion of the said rockshaft.
a rockshaft is installed on the system's base and it's free rotating for imparting the rotary motion of the second gear which is installed on its end to the first drive pulley on the descent of the long arm of the said additional lever from up to down by the first or the second weight which is installed on the long arm of the said additional lever.
an additional lever is installed on the second U-joint and it's parallel the said first or the second lever to be the additional lever is free movement reciprocally to up and down on the second U-joint.
a first drive pulley is installed on the end of the said rockshaft and the said first drive pulley is be interconnected with the free end of the long arm of the first or the second lever by a chain is fixed on the first drive pulley by one end and its second end is connected with an end of connecting rod and the second end of this connecting rod is connected with a chain is trained on the second pulley for interconnection the said connecting rod with the long arm of the first or the second lever for driving the long arm of the first or the second lever to down on the descent of the long arm of the additional lever to down and the first arciform gear move to up for rotation the second gear, the said rockshaft and the first drive pulley, the first drive pulley is rotating to train the said chain which coils round the first drive pulley for driving the long arm of the first or the second lever to down.
a side arm is installed on the free end of the long arm of the said additional lever and is contacted with the under surface of the free end of the long arm of the first or the second lever for lifting the long arm to up upon the lifting of the long arm of the additional lever from down to up.

4- The power generating system-first design of claim 1 wherein the first design of the said gearbox comprises.
a crankshaft is installed to the gearbox and it's free to rotate on its shaft bearings and the said crankshaft having the twelfth gear which is engaging with the thirteenth gear of the third cogged wheel which is driven to be rotating by the said crankshaft and also the said third cogged wheel is free to slide to the both two directions on the said crankshaft.
the first crank is installed on the crankshaft and it's interconnected with the short arm of the first lever by the said first connecting rod for conversion the reciprocative movement of the said short arm to rotary motion of the said crankshaft.
the second crank is installed on the crankshaft and it's interconnected with the short arm of the second lever by the second connecting rod for conversion the reciprocative movement of the short arm of the second lever to rotary motion of the said crankshaft.
the sixth gear is installed on the said crankshaft and it's driven to be rotating by the said crankshaft for imparting rotary motion to the second gear which is engaging with the said sixth gear.
a braking rotary member is installed on the said crankshaft for stopping the system.
a first cylindrical cam is installed on the left surface of the said third cogged wheel by its flate end and its peripheral edge having 50% toe and 50% heel and the peripheral edge is contacted with the first guiding device for sliding the third cogged wheel into the right on the said crankshaft for engagement the fifth gear with the eleventh gear for imparting rotary motion of the said crankshaft to the second rockshaft for lifting to up the long arm of the second lever which reached to the lower extreme position.
a first guiding device it looks like a leaf spring having a base for fixing it on the bottom of the said gearbox and its upper end is bent towards the peripheral edge of the first cylindrical cam and the upper end of the said first guiding device is contacting with the peripheral edge of the first cylindrical cam all the time during the running of the system for pushing the toe of the first cylindrical cam to slide the said third cogged wheel to the right for disengagement the fourth gear and the seventh gear and engagement the fifth gear and the eleventh gear for turning the rotary direction of the second rockshaft to regulate the reciprocative movement of the first and the second long arms of the two levers.
a second cylindrical cam is identical with the first cylindrical cam and the said second cylindrical cam is a cylinder having a flate edge is installed on the right surface of the said third cogged wheel and the peripheral edge of the second cylindrical cam having 50% toe and 50% heel and it's touched the upper end of the second guiding device which pushes the second cylindrical cam's toe for sliding the said third cogged wheel to the left for disengagement the fifth gear and the eleventh gear and engagement the seventh gear with the fourth gear for turning the rotary direction of the second rockshaft to control the reciprocative movement of the two levers of the system.
a second guiding device is identical with the first guiding device and the second guiding device looks like a leaf spring having a base is installed on the bottom of the said gearbox and the upper end of the second guiding device is bent towards the peripheral edge of the second cylindrical cam for pushing the toe of the second cylindrical cam on the rotation of the third cogged wheel for sliding the third cogged wheel to the left for disengagement the fifth gear and the eleventh gear and engagement the fourth gear with the seventh gear for turning the rotary direction of the second rockshaft to control the reciprocative movement of the first and the second long arms of the two levers.
a first shaft it's a working shaft having one end is be installed in the said gearbox by two shaft bearings to be the said first shaft is free rotating and the second gear is installed on this end for imparting rotary motion with faster rotational speed than that of the sixth gear and the said first shaft imparts the rotary motion of the gearbox to drive a load such as AC generator or a vehicle.
a second gear is installed on the end of the first shaft inside the said gearbox and the said second gear engaged with the sixth gear for imparting rotary motion of the said crankshaft to the first shaft through the sixth gears the second gear having a small diameter than that of the sixth gear so the second gear acts as speed-increasing device for imparting rotary motion to the first shaft with faster rotational speed.
a flywheel is installed on the said first shaft for stabilizing the momentum inertia of the said first shaft and the first gear is installed on the said flywheel.
a first gear is a ring gear installed on the said flywheel for imparting rotary motion of the electric starter through its pinion gear to the said gearbox through the said flywheel and the first shaft for starting the system's work.
a first rockshaft is installed in the said gearbox by two shaft bearings to be the said first rockshaft is free rotating on its bearings and the seventh gear and the eight gear are installed on the said first rockshaft for imparting rotary motion of the fourth gear to the second rockshaft through seventh gear, eighth gear, ninth gear and tenth gear for turning the rotary direction of the second rockshaft upon the contacting of the second guiding device with the toe of the second cylindrical cam for controlling to the reciprocative movement of the first and the second levers.
a second shaft it's a axle shaft of the ninth gear and it's free rotating on its bearings.
an eleventh gear is installed on the end of the second rockshaft for imparting rotary motion of the fifth gear to the second rockshaft to impart rotary motion to the third drive pulley and the fourth drive pulley for controlling to the reciprocative movement of the first long arm and the second long arm and the rotary motion of the eleventh gear is reverse the rotary motion which is be imparted from the fourth gear to the said second rockshaft by the seventh gear, the first rockshaft, the eighth gear, the ninth gear and the tenth gear for turning the rotary direction of the second rockshaft for performance the desired controls.
a seventh gear installed on the end of the said first rockshaft for imparting rotary motion of the fourth gear to the second rockshaft through the first rockshaft, the eighth gear, the ninth gear and the tenth gear which is installed on the second rockshaft for rotation the second rockshaft on the contacting of the second guiding device with the toe of the second cylindrical cam for rotation the third drive pulley and the fourth drive pulley for lifting the said first long arm to up and descent the said second long arm to down.
an eighth gear it having the same diameter of the seventh gear, the ninth gear, the eleventh gear and the tenth gear, the said eighth gear is installed on the first rockshaft and it engaged with the ninth gear for imparting rotary motion of the first rockshaft to the second rockshaft through the ninth gear and the tenth gear upon the contacting of the second guiding device with the toe of the second cylindrical cam for imparting opposite rotary motion to the second rockshaft than that imparted of the fifth gear to the eleventh gear for lifting the first long arm to up and descent the second long arm to down.
a ninth gear is installed on the second shaft and it engaged with the eighth gear and the tenth gear and the said ninth gear acts as reverse gear for reverse the rotary motion which is imparted of eighth gear to the tenth gear to change the rotary direction of the second rockshaft.
tenth gear is installed on the second rockshaft and it's engaged with the ninth gear for imparting rotary motion of the fourth gear to the second rockshaft through the seventh gear, first rockshaft, eighth gear and ninth gear.
a second rockshaft for imparting rotary motion of the said gearbox to the said third drive pulley and the said fourth drive pulley or controlling to the reciprocative movement of the first long arm and the second long arm of the two levers of the said system and the eleventh gear is installed on the end of the said second rockshaft for imparting rotary motion of the fifth gear to the second rockshaft on the contacting of the first guiding device with the toe of the first cylindrical cam for descent the first long arm to down and lifting the second long arm of the second lever to up and the tenth gear is installed on the said second rockshaft for imparting rotary motion of the fourth gear to the second rockshaft through the seventh gear, the first rockshaft, the eighth gear and the ninth gear for rotation the second rockshaft to the reverse rotary direction for driving the third drive pulley and the fourth drive pulley for lifting the first long arm to up and descent the second long arm to down on the contacting of the second guiding device with the toe or the second cylindrical cam.

5- The power generating system-first design of claim 1 wherein the second design of the said gearbox comprises.
a crankshaft mounted to the said gearbox and it's free to rotate on its two shaft bearings and the first crank is installed on one end of the said crankshaft for conversion the reciprocative movement of the short arm of the first lever through the first connecting rod to rotary motion of the said crankshaft and the second crank is installed on the other end of the said crankshaft for conversion the reciprocative movement of the short arm of the second lever through the second connecting rod to rotary motion of the said crankshaft and the fourth gear is installed on the crankshaft for imparting rotary motion to the second rockshaft through the twelfth gear, an eleventh gear, the thirteenth gear, the first rockshaft, the fourteenth gear and the fifteenth gear for lifting the first long arm of the first lever and descent the second long arm of the second lever and the third gear is installed on the said crankshaft.
a third gear is installed on the said crankshaft and it's driven to be rotating by the said crankshaft and it's engaged with the second gear for imparting rotary motion of the said crankshaft to the first shaft for imparting rotary motion to a load such as AC generator and also the said third gear is engaged with the seventh gear for imparting a reverses rotary motion to second rockshaft through the eighth gear, the ninth gear, the tenth gear, the eleventh gear, the thirteenth gear, the first rockshaft, the fourteenth gear and the fifteenth gear for change the rotary motion of the said second rockshaft on the contacting of the first cam wheel's toe with the right surface of the eleventh gear for lifting the second long arm of the second lever to up and descent the first long arm of the first lever to down.
a first shaft it's a working shaft for imparting kinetic energy of the said system to a load such as AC generator or a vehicle through a second gear which is installed on the internal end of the first shaft inside the said gearbox and a flywheel mounted on the first shaft for stabilizing the momentum inertia of the said first shaft.
a second gear installed on the end of the first shaft and the said second gear engaged with the third gear for imparting rotary motion of the said crankshaft to the said first shaft with faster rotational speed because the said second gear having a small diameter than that of the third gear so the said second gear acts as speed-increasing device.
a flywheel is installed on the said first shaft for stabilizing the momentum inertia of the said first shaft and the first gear is installed on the said flywheel for imparting rotary motion of the pinion gear of the electric starter for starting the system's operation.
a fourth gear is installed on the said crankshaft and it's driven to be rotating by the crankshaft for imparting rotary motion to the second rockshaft through the twelfth gear, the eleventh gear, the thirteenth gear, the first rockshaft, the fourteenth gear, the fifteenth gear for rotation the second rockshaft on the contacting of the first cam wheel's heel with the right surface of the eleventh gear for lifting the first long arm of the first lever to up and descent the second long arm to down and the shape of each cog of the said fourth gear is right angle for engagement with the twelfth gear which is identical with the fourth gear.
a fifth gear may be a ring gear is installed on the right surface of the fourth gear for imparting rotary motion of the fourth gear to the first cam wheel through the sixth gear and the first cam shaft for rotation the first cam wheel which changes the rotary direction of the second rockshaft for performance the desired controls to the reciprocative movement of the first and the second long arms of the two levers and the fifth gear having the same diameter of the sixth gear.
a first crank is installed on the end of the said crankshaft and it's be interconnected with the short arm of the first lever by the said first connecting rod for conversion the reciprocative movement of the first long arm to rotary motion of the said crankshaft, the said first crank and the second crank are identical and the angle between the crank arm of the first crank and the crank arm of the second crank is 180 degrees.
a second crank is installed on the other end of the said crankshaft and it's be interconnected with the short arm of the second lever by the said second connecting rod for conversion the reciprocative movement of the second long arm to rotary motion of the said crankshaft.
a braking device installed on the body of the said gearbox or may the said braking device be installed on the system's base for stop the system.
a braking rotary member is installed on the said crankshaft for stop the system by the said braking device.
an electric starter installed on the said gearbox or may the said electric starter be installed on the system's base for imparting kenetic energy to first gear through its pinion gear for starting the system's work and after the system started its work the electric starter is be turned off by the operator.
a seventh gear it's a reverse gear for reverse the rotary motion of the third gear and imparting this rotary motion to the eighth gear which is engaged with the seventh gear for imparting rotary motion of the third gear to the second rockshaft through the eighth gear, ninth gear, tenth gear, eleventh gear, thirteenth gear, first rockshaft, fourteenth gear and the fifteenth gear upon the contacting of the first cam wheel's toe with the right surface of the eleventh gear for lifting the second long arm to up and descent the first long arm of the first lever to down.
a second shaft is installed to the said gearbox by two shaft bearings to be the said second shaft is free rotating on its bearings and the eighth gear mounted on the second shaft and upon the rotation of the eighth gear causes the rotation of the second shaft and the eleventh gear is installed on the second shaft and on the rotation of the seventh gear do not cause rotation the said second shaft and a coil spring installed on the said second shaft among the said eighth gear and the eleventh gear for sliding an eleventh gear to the right to disengage the ninth gear and the tenth gear and engagement the twelfth gear and the fourth gear upon the contacting of the heel of the first cam wheel with the right surface of the eleventh gear for imparting rotary motion to the second rockshaft for lift the first long arm of the first lever and descent the second arm to down.
an eighth gear mounted on the second shaft and upon the rotation of the eighth gear causes the rotation of the second shaft and the ninth gear is installed on the right surface of the eighth gear for imparting the rotary motion of the eighth gear to the tenth gear.
a ninth gear it's a side gear installed on the right surface of the eighth gear and may the ninth gear be a ring gear for imparting rotary motion of the eighth gear to the tenth gear upon the contacting of the toe of the first cam wheel with the right surface of the eleventh gear for imparting rotary motion to the second rockshaft through the tenth gear, eleventh gear, thirteenth gear, the first rockshaft and the fifteenth gear for lift the second long arm of the second lever to up and descent the first long arm of the first lever to down and the shape of each cog of the said ninth gear is right triangle.
a tenth gear it's a side gear is installed on the left side of the eleventh gear and the said tenth gear engages with the ninth gear upon the contacting of the toe of the first cam wheel with the right surface of the eleventh gear so the eleventh gear is be slided by the first cam wheel's toe against the force of the coil spring which is installed on the second shaft among the eighth gear and the eleventh gear this causes sliding the eleventh gear to the left for engagement the said tenth gear with the ninth gear for imparting rotary motion of the crankshaft to the second rockshaft through the third gear, seventh gear, eighth gear, ninth gear, tenth gear, eleventh gear, thirteenth gear, first rockshaft, fourteenth gear and fifteenth gear which is installed on the end of the second rockshaft for rotation the second rockshaft for driving the third drive pulley and the fourth drive pulley for lifting the second long arm of the second lever to up and descent the first long arm of the first lever to down.
a coil spring having two end plates for installation the said coil spring on the second shaft by a hole to the center of each plate to be each plate is free sliding on the second shaft for pushing the eleventh gear to the right against the first cam wheel which is contacting with the right surface of the eleventh gear so the said coil spring pushes the eleventh gear to slide upon the contacting of the heel of the first cam wheel with the right surface of the eleventh gear for disengagement the ninth gear and the tenth gear and engagement the fourth gear and the twelfth gear for imparting rotary motion of the fourth gear to the second rockshaft for driving the third drive pulley and the fourth drive pulley which are installed on the second rockshaft for lift the first long arm to up and descent the second long arm to down.
an eleventh gear mounted on the second shaft and it's free to rotate on the second shaft without rotation the second shaft and also it free to slide towards the first cam wheel by the force of the said coil spring which is installed on the second shaft among the eighth gear and the eleventh gear for disengagement the ninth gear and the tenth gear and engagement the twelfth gear with the fourth gear for imparting rotary motion of the crankshaft to the second rockshaft through the twelfth gear, the thirteenth gear, the first rockshaft, the fourteenth gear and the fifteenth gear to rotate the second rockshaft for driving the third drive pulley and the fourth drive pulley which are installed on the end of the second rockshaft for lift the first long arm and descent the second long arm and also the said eleventh gear is be slided to the left on the second shaft by the toe of the first cam wheel against the force of the said coil spring for disengagement the fourth gear and the twelfth gear and engagement the ninth gear with the tenth gear for change the rotary direction of the second rockshaft for lift the second long arm to up and descent the first long arm to down and the said eleventh gear engaged with the thirteenth gear and on the sliding of the eleventh gear to the right or the left the eleventh gear remain engaging with the thirteenth gear because the thirteenth gear is wide.
a twelfth gear is a side gear installed on the right surface of the said eleventh gear and may the twelfth gear be a ring gear and the shape of each cog is right triangle for engagement with the fourth gear for imparting rotary motion of the crankshaft to the second rockshaft through the eleventh gear, thirteenth gear, first rockshaft, fourteenth gear and fifteenth gear for rotation the second rockshaft to lift the first long arm to up and descent the second long arm to down.
a sixth gear is installed on the end of the first cam shaft and it's engaging with the fifth gear which having the same diameter of the sixth gear for imparting rotary motion of the crankshaft through the fifth gear, sixth gear, the first cam shaft to the first cam wheel for rotation the first cam wheel a half revolution on the movement of the first or the second long arm from upper extreme position to the lower extreme position.
a first cam shaft installed to the said gearbox by two shaft bearings to be the said first cam shaft is free rotating on its bearings for imparting rotary motion of the sixth gear to the first cam wheel for disengagement the fourth gear and the twelfth gear on the movement of the first long arm of the first lever to down and lifting the second long arm to up.
a first cam wheel having 50% toe and 50% heel and it installed on the end of the said first cam shaft to be the peripheral edge of the first cam wheel contacting with the right surface of the eleventh gear for sliding the said eleventh gear on the second shaft to the left by the pressure of the first cam wheel's toe against the force of the said coil spring for disengagement the fourth gear and twelfth gear and engagement the ninth gear and tenth gear for imparting rotary motion of the crankshaft to the second rockshaft through the third gear, seventh gear, eighth gear, ninth gear, tenth gear, eleventh gear, thirteenth gear, first rockshaft, fourteenth gear and fifteenth gear for rotation the second rockshaft for driving the third drive pulley and fourth drive pulley which are installed on the end of the said second rockshaft for lifting the second long arm of the second lever to up and descent the first long arm of the first lever to down.
a second cam shaft having one end is installed on the bottom of the said gearbox by shaft bearing and the upper end of the said second cam shaft is installed to the upper cover of the said gearbox by a shaft bearing to be the second cam shaft is free rotating on its bearings and the second cam is installed on the second cam shaft for stopping the system, upon the rotation of the second cam shaft by an arm is interconnected with the upper end of the second cam shaft by an U-joint this causes the rotation of the second cam for pushing the right surface of the eleventh gear by the toe of the second cam for remaining the fourth gear and the twelfth gear disengaged so the system remain stationary.
a second cam is installed on the second cam shaft on the right side of the eleventh gear and on the rotation of the second cam by an arm is interconnected with the upper end of the second cam shaft so the toe of the second cam pushes the right surface of eleventh gear for prevention the twelfth gear engage with fourth gear for stop the system.
a thirteenth gear is a wide gear for remaining the engagement with the said eleventh gear, the thirteenth gear having a small diameter so it acts as speed-increasing device and it installed on the first rockshaft and engaged with the eleventh gear for imparting rotary motion of the said eleventh gear to the second rockshaft through the first rockshaft, fourteenth gear, and fifteenth gear for performance the desired control to the reciprocative movement of the first and the second long arms of the said two levers.
a first rockshaft installed on the bottom of the gearbox by two shaft bearings to be the first rockshaft is free rotating on its bearings for imparting rotary motion of the thirteenth gear which is installed on its end to the fourteenth gear which is installed on the other end of the said first rockshaft for imparting rotary motion to the second rockshaft through the fifteenth gear for rotation the second rockshaft to perform the desired control to the reciprocative movement of the first long arm and the second long arm of the both two levers of the said system.
a fourteenth gear is installed on the end of the said first rockshaft and it's driven to be rotating by the first rockshaft for imparting rotary motion of the first rockshaft to the second rockshaft through the fifteenth gear which is engaging with the fourteenth gear.
a fifteenth gear installed on the end of the second rockshaft and it engaging with the fourteenth gear and the fifteenth gear is driven to be rotating by the said fourteenth gear for rotation the second rockshaft which drives the third drive pulley and the fourth drive pulley for performance the desired controls to the reciprocative movement of the first long arm and the second long arm.
a second rockshaft having one end installed to the gearbox and the fifteenth gear installed thereon and the other end of second rockshaft thereon the third drive pulley and the fourth drive pulley are installed and the second rockshaft imparts rotary motion of the fifteenth gear to the third drive pulley and the fourth drive pulley for performance the desired controls to the reciprocative movement of the first long arm and the second long arm.

6- A power generating system-second design of claim 1 wherein may the second chain be interconnected with the first chain through a first connecting rod and may the seventh chain be interconnecting with the eighth chain through a second connecting rod.

7- A power generating system-three designs of claim 1 wherein each pulley comprises.
a first pulley component having one end plate or flange and two tooth sockets for installation the second pulley component on the first pulley component.
a second pulley component it's a rubber pulley having two teeth for installation the second pulley component on the first pulley component and the second pulley component acts as silencer for prevention the noise on the running of the system.
a third pulley component it's an end plate or flange having central hole for installation the pulley on its axle and four small holes for installation the third pulley component on the first pulley component by bolts.

8- A power generating system-second design of claim 1 wherein the first design of the gearbox includes,
a first common shaft installed to the gearbox for imparting the rotary motion of the said system to a vehicle or AC generator and the first common shaft thereon the first gear, a braking rotary member, a third gear, a fourth gear, a fifth gear and a second gear are installed.
a first gear is interconnected with the said first common shaft by a ratchet mean therefore the first gear to one direction only causes the rotation of the first common shaft but on the rotation of the first gear to the opposite direction, the first common shaft remain stationary for conversion the reciprocative movement of the first arciform gear which is engaging with the first gear to rotary motion of the first common shaft.
a second gear having the same diameter of the first gear and it's installed on the other end of first common shaft and the second gear is be interconnected with the first common shaft by a ratchet mean so the second gear to one direction only causes the rotation of the first common shaft but on the rotation of the second gear to the opposite direction, the first common shaft remain stationary for conversion the reciprocative movement of the second arciform gear which is engaging with the said second gear to rotary motion of the first common shaft and the said ratchet mean of the second gear having a small arm can be used by the operator for change the work of this ratchet device for stop the system.
a braking rotary member is installed on the first common shaft for stop the system by a braking device.
a braking device installed on the said gearbox or on the system's base and the hydraulic line of the said braking device can be connected with the main master of the vehicle's brake for controlling to the car's speed without using the clutch's pedal.
a third gear installed on the first common shaft and the third gear having a double diameter more than that of the first gear and the second gear, the third gear engaging with sixth gear for imparting rotary motion of the first common shaft to the first cam wheel through the first cam shaft for rotation the first cam wheel a half revolution on the movement of the first long arm or the second long arm from upper extreme position to the lower extreme position.
a fifth gear having the same diameter of the third gear and it installed on the first common shaft for imparting rotary motion to the second cam wheel through the seventh gear and the second cam shaft for rotation the second cam wheel a half revolution on the movement of the first long arm or the second long arm from the upper extreme position to the lower extreme position.
a fourth gear installed on the first common shaft and the fourth gear is driven to be rotating by the first common shaft and the fourth gear engaged with the eleventh gear for imparting rotary motion of the first common shaft to the first drive pulley through the eleventh gear, tenth gear, ninth gear, eighth gear, fifteenth gear and first rockshaft which drives the first drive pulley to be rotating for training the first chain for lifting the second long arm of the second lever and descent the first long arm of the first lever to down upon the contacting of the first cam wheel's toe with the left surface of the eighth gears and the fourth gear imparts rotary motion of the first common shaft to the second drive pulley through the eleventh gear, twelfth gear, thirteenth gear, fourteenth gear, sixteenth gear and second rockshaft to drive the second drive pulley to train the eighth chain for lifting the first long arm of the first lever to up and descent the second long arm of the second lever to down upon the contacting of the second cam wheel's toe with the right surface of the fourteenth gear.
a sixth gear installed on the end of the first cam shaft and the said sixth gear engaging with the third gear for imparting rotary motion of the third gear to the first cam wheel for rotation the first cam wheel a half revolution upon the rotation of the first gear or the second gear a quarter revolution because of dropping any one of the first long arm or the second long arm from upper extreme position to the lower extreme position and the diameter of the sixth gear, first gear and second gear are identical.
a first cam shaft installed on the gearbox by two shaft bearings to be the first cam shaft is free rotating for imparting rotary motion of the sixth gear to the first cam wheel.
a first cam wheel is installed on the end of the first cam shaft and the first cam wheel is driven to be rotating by a rotary motion is be imparted from the first common shaft to the first cam wheel through the third gear, sixth gear and the first cam shaft for rotation the first cam wheel a half revolution on the descent of the first long arm or the second long arm from upper extreme position to the lower extreme position and the first cam wheel having about 57% toe and 43% heel but if the said gearbox is be used in the third design of the present invention, the first cam wheel having about 43% toe and 57% heel and the peripheral edge of the first cam wheel is contacting with the left surface of the eighth gear, the toe of the first cam wheel pushes the eighth gear which is axially slidable towards the eleventh gear for engagement the ninth gear with the tenth gear for imparting rotary motion of the first common shaft to the first drive pulley through the fourth gear, eleventh gear, tenth gear, ninth gear, eighth gear, fifteenth gear and first rockshaft to drive the first drive pulley to be rotating for training the first chain for lifting the second long arm to up and training the eighth chain to drive the second drive pulley to be rotating to the reverse rotary direction than that of the first drive pulley because the heel of the second cam wheel is contacting with the right surface of the fourteenth gear and the twelfth gear is disengaged with the thirteenth gear and the first long arm is dropping to down.
a seventh gear installed on the end of the second cam shaft and it engaging with the fifth gear for imparting rotary motion of the first common shaft to the second cam wheel through the second cam shaft and the seventh gear having the same diameter of the sixth gear, first gear and the second gear, the seventh gear having a half diameter of the fifth gear so on the descent of the first long arm or the second long arm from upper extreme position to the lower extreme position this causes the rotation of the first gear or the second gear a quarter revolution and the fifth gear also rotate a quarter revolution and because the seventh gear having a half diameter of the fifth gear so the seventh gear rotate a half revolution and also the second cam wheel rotate a half revolution for pushing the fourteenth gear to slide towards the twelfth gear for engagement the twelfth gear with the thirteenth gear for imparting rotary motion of the first common shaft to the second drive pulley through the fourth gear, eleventh gear, twelfth gear, thirteenth gear, fourteenth gear, sixteenth gear and second rockshaft to drive the second drive pulley for training the eighth chain for lifting the first long arm to up and descent the second long arm of the second lever to down.
a second cam shaft installed to the gearbox by two shaft bearings for imparting rotary motion of the seventh gear to the second cam wheel for rotation the second cam wheel for performance the desired controls.
a second cam wheel is identical with the first cam wheel and it having about 57% toe and 43% heel and the peripheral edge of the second cam wheel is contacting with the right surface of the fourth gear which is axially slidable on the second common shaft so the toe of the second cam wheel pushes the fourteenth gear for slide the fourteenth gear on the second common shaft for engagement the twelfth gear and the thirteenth gear for imparting rotary motion of the first common shaft to the second drive pulley through the fourth gear, eleventh gear, twelfth gear, thirteenth gear, fourteenth gear, sixteenth gear and second rockshaft to drive the second drive pulley for training the eighth chain for lift the first long arm to up and dropping the second long arm to down and before the reaching of the descent second long arm to the lower extreme position with one inch or a suitable distance this causes rotation the second cam wheel a half rotation for contacting the heel of the second cam wheel with the right surface of the fourteenth gear to slide the fourteenth gear towards the second cam wheel by the force of the second coil spring for disengagement the twelfth gear and the thirteenth gear.
a second common shaft installed to the gearbox by two shaft bearings to be the second common shaft is free rotating on its bearings and the eleventh gear, eighth gear, fourteenth gear, first coil spring and second coil spring are installed on the second common shaft.
an eighth gear installed on the second common shaft and it's axially slidable on the second common shaft and the peripheral edge of the first cam wheel is contacting with the left surface of eight gear and first coil spring is contacting with the right surface of eighth gear and the eighth gear is engaging with fifteenth gear and the ninth gear is installed on the right surface of the eighth gear for imparting rotary motion of the tenth gear to the first drive pulley through the ninth gear, eighth gear, fifteenth gear and first rockshaft which drives the first drive pulley for training the first chain for lift the second long arm to up and descent the first long arm to down upon the contacting of the toe of the first cam wheel with the left surface of the eighth gear.
a ninth gear is a side gear installed on the right surface of the eighth gear and the shape of each cog is right triangle for imparting rotary motion of the tenth gear to the first drive pulley on the contacting of the first cam wheel's toe with the left surface of the eighth gear for lifting the second long arm of the second lever to up and descent the first long arm to down and may the ninth gear be a ring gear is installed on the right surface of the eighth gear.
a first coil spring is installed on the second common shaft among the eighth gear and the eleventh gear by two end plates each one of them having an hole to its center for installation the plate on the second common shaft to be the both plates are axially slidable on the second common shaft and the first coil spring for sliding the eighth gear towards the first cam wheel upon the contacting of the first cam wheel's heel with the left surface of the eighth gear for disengagement the ninth gear and the tenth gear for lifting the first long arm to up and the first drive pulley is be driven to be rotating to the reverse rotary direction than that of the second drive pulley by the training of the first chain.
a tenth gear is a side ring gear installed on the left surface of the eleventh gear and the tenth gear engages with the ninth gear upon the contacting of the first cam wheel's toe with the left surface of the eighth gear for imparting rotary motion of the eleventh gear to the first drive pulley through the ninth gear, eighth gear, fifteenth gear and first rockshaft to drive the first drive pulley for performance the desired control to the reciprocative movement of the both two long arms of the two levers. an eleventh gear is fixedly secured to the second common shaft and upon the rotation of the eleventh gear causes the rotation of the second common shaft and the eleventh gear engaging with the fourth gear for imparting rotary motion of the first common shaft to the first drive pulley upon the engagement of the ninth gear with the tenth gear by the first cam wheel's toe and the eleventh gear impart rotary motion to the second drive pulley upon the engagement of the twelfth gear with the thirteenth gear by the second cam wheel's toe for performance the desired controls to the reciprocative movement of the first long arm and the second long arm.
a twelfth gear is a side ring gear installed on the right surface of the eleventh gear and the twelfth gear engages with the thirteenth gear upon the contacting of the second cam wheel's toe with the right surface of the fourteenth gear for imparting rotary motion to the second drive pulley through the thirteenth gear, fourteenth gear, sixteenth gear and second rockshaft which drive the second drive pulley for lift the first long arm of the first lever to up upon the descent of the second long arm to down.
a second coil spring is be installed on the second common shaft among the eleventh gear and the fourteenth gear by two end plates each one of them having a hole to its center so each plate is axially slidable on the second common shaft for sliding the fourteenth gear towards the second cam wheel on the contacting of the second cam wheel's heel with the right surface of the fourteenth gear to disengagement the twelfth gear and the thirteenth gear so the second drive pulley is free to rotate into the reverse rotary direction than that of the first drive pulley for lifting the second long arm of the second lever to up and descent the first long arm of the first lever to down.
a thirteenth gear is a side ring gear mounted on the left surface of the fourteenth gear and the thirteenth gear engages with the twelfth gear on the contacting of the second cam wheel's toe with the right surface of the fourteenth gear for imparting rotary motion to the second drive pulley through the fourteenth gear, sixteenth gear and second rockshaft which drive the second drive pulley for training the eighth chain for lifting the first long arm of the first lever to up and descent the second long arm to down.
a fourteenth gear is coaxially mounted with the eleventh gear and the eighth gear on the second common shaft, fourteenth gear is axially slidable for engagement the twelfth gear and thirteenth gear on the contacting of the second cam wheel's toe with the right surface of the fourteenth gear for imparting rotary motion to the second drive pulley through the sixteenth gear and the second rockshaft and upon the contacting of the second cam wheel's heel with the right side of the fourteenth gear causes slide the fourteenth gear towards the heel of the second cam wheel for disengagement the twelfth gear and the thirteenth gear so the second drive pulley is free to rotate to the reverse rotary direction than that of the first drive pulley by the training of the eighth chain for lifting the second long arm to up and descent the first long arm of the first lever to down.
a first rockshaft installed to the said gearbox for imparting rotary motion of the fifteenth gear to the first drive pulley which is installed on the end of the first rockshaft and the fifteenth gear installed on the other end of first rockshaft.
a first drive pulley is mounted on the external end of the first rockshaft for training the first chain which winds round the first drive pulley for lift the second long arm of the second lever and descent the first long arm of the first lever and the first drive pulley is driven to be rotating by the first rockshaft.
a fifteenth gear is mounted on the end of first rockshaft and engaged with the eighth gear and the fifteenth gear is driven to be rotating by the eighth gear for imparting rotary motion to the first drive pulley through the first rockshaft on the contacting of the toe of the first cam heel with the left side of the eighth gear and also the fifteenth gear is driven to be rotating to the reverse rotary direction by the first drive pulley upon the contacting of the heel of the first cam wheel with the left side of the eighth gear for unwinding the first chain and lifting the first long arm to up and the said fifteenth gear is a wide gear for remaining the engagement with the eighth gear.
a second rockshaft installed to the gearbox for imparting rotary motion of the sixteenth gear to the second drive pulley for training the eighth chain for descent the second long arm and lifting the first long arm to up and before the second long arm reaches to the lower extreme position with one inch or a suitable distance the second drive pulley is driven to be rotating to the reverse rotary direction by the training of the eighth chain so this reverse rotary motion is be imparted of the second drive pulley to the sixteenth gear by the second rockshaft.
a sixteenth gear installed on the end of the second rockshaft for imparting rotary motion of the fourteenth gear to the second drive pulley through the second rockshaft and the sixteenth gear is wide for remaining the fourteenth gear engaging with the sixteenth gear on the sliding of the fourteenth gear on the second common shaft.
a second drive pulley is mounted on the external end of the second rockshaft and it's connected with the end of the eighth chain for training the eighth chain which coils round the second drive pulley for lifting the first long arm of the first lever to up and descent the second long arm of the second lever to down and on the contacting of the second cam wheel's heel with the right side of the fourteenth gear for disengagement the twelfth gear and the thirteenth gear, the second drive pulley is be driven to be rotating into the reverse rotary direction by the training of the eighth chain for descent the first long arm of the first lever to down and lifting the second long arm of the second lever to up.

9- A power generating system of claim 8 wherein,
the first cam shaft and the second cam shaft, each one of them is installed to the gearbox by two shaft bearings one of them installed on the top of the first vertical post of a H-frame and the other bearing is installed on the top of the second vertical post of the said H-frame and the lower end of the first vertical post is articulated with the first base by the first joint and the lower end of the second vertical post of the said H-frame is articulated with the second base by the second joint to be the said H-frame can be slanted to one side only if happened a difficulty on the engagement of the twelfth gear and the thirteenth gear or the ninth gear with tenth gear for protection the said gears of the damage and the horizontal post of the said H-frame is be pushed by a leaf spring for remaining the H-frame stand vertically and the said leaf spring having a base installed on the bottom of the gearbox by bolts.

10- A power generating system of claim 8 wherein,
a ring of a durable material having four arms for installation the said ring on the left surface of the eighth gear and another identical ring is installed on the right surface of the fourteenth gear for protection the two said gears of wear.

11- A power generating system-second design of claim 1 wherein the second design of the gearbox comprises,
a first shaft, it's a working shaft installed to the gearbox by three shaft bearings to be the first shaft is free rotating for imparting the rotary motion of the system to a vehicle or AC generator and installed on the said first shaft are a plurality of drive gears as the first gear, a second gear, a third gear, a fourth gear, a seventh gear, an eighth gear and also a braking rotary member is installed on the first shaft.
a first gear is interconnected with the first shaft by a ratchet mean so the first gear to one direction only causes the rotation of the first shaft but on the rotation of the first gear to the opposite direction, the first shaft remain stationary and the first gear engaging with the first arciform gear for conversion the reciprocative movement of the first shaft arm to rotary motion of the first shaft.
a second gear is similar the first gear and it's interconnected with the first shaft by a ratchet mean so the second gear to one direction only causes the rotation of the first gear but on the rotation of the second gear to the reverse rotary direction the shaft remain stationary and the second gear engaging with the second arciform gear for conversion the reciprocative movement of the second short arm to rotary motion of the first shaft.
a third gear installed on the first shaft and it having a big diameter and engaging with the fifth gear which having a small diameter than that of the third gear for imparting rotary motion of the first shaft to the second drive pulley with faster rotational speed through the third gear, fifth gear, second shaft, the first clutch and first rockshaft to drive the first drive pulley for training the first chain on the contacting of the heel of the first cam wheel with the first cam plate for descent the first long arm of the first lever to down and lifting the second long arm of the second lever to up.
a fourth gear is similar the third gear and it installed on the first shaft and it engaging with the sixth gear which having a small diameter than that of the fourth gear for imparting rotary motion of the first shaft to the second drive pulley with faster rotational speed through the fourth gear, sixth gear, third shaft, second clutch and second rockshaft to drive the second drive pulley for training the eighth chain upon the contacting of the second cam wheel's heel with the second cam plate for descent the second long arm of the second lever to down and lifting the first long arm of the first lever to up.
a seventh gear having a double diameter of the first gear or the second gear and it's installed on the first shaft for imparting rotary motion to the first cam wheel through the ninth gear which is engaging with the seventh gear and the first cam shaft for rotation the first cam wheel a half revolution on the descent of the first long arm or the second long arm from upper extreme position to the lower extreme position cause rotation the first gear or the second gear a quarter rotation and because the seventh gear having a double diameter of the ninth gear so the rotation of the seventh gear a quarter rotation cause the rotation of the ninth gear a half rotation for performance the desired control to the reciprocative movement of the first long arm and the second long arm.
an eighth gear is identical with the seventh gear and the eighth gear installed on the first shaft and it's driven to be rotating by the first shaft for imparting rotary motion to the second cam wheel through the tenth gear and the second cam shaft for performance the desired controls to the reciprocative movement of the first and the second levers.
a braking rotary member installed on the first shaft for stop the system.
a braking device installed on the system's base or on the body of the gearbox and the hydraulic line of the said braking device is connected with the main master of the vehicle's brake so the operator does not need to use the clutch's pedal for stop the vehicle or decrease its speed.
a ninth gear installed on the first cam shaft and it's engaging with the seventh gear and the ninth gear is driven to be rotating by the seventh gear for imparting rotary motion to the first cam wheel through the first cam shaft for regulation the reciprocative movement of the first long arm and the second long arm.
a first cam shaft installed to the gearbox by two shaft bearings and it's driven to be rotating by the ninth gear which is installed on its end for imparting rotary motion to the first cam wheel which is installed on the other end of the first cam shaft.
a first cam wheel installed on the end of the first cam shaft and it's driven to be rotating by the first cam shaft and the first cam wheel having 57% heel and 43% toe and its peripheral edge is contacting with the first cam plate so the toe of the first cam wheel pushes the first cam plate and the first connecting rod impart the pressure of the first cam wheel's toe to the first clutch to disimpart the rotary motion of the second shaft to the first rockshaft and the first drive pulley which is driven to be rotating to the reverse rotary direction than that of the second drive pulley for lifting the first long arm of the first lever to up and descent the second long arm of the second lever to down and on the contacting of the first cam wheel's heel with the first cam plate for prevention the pressure of the first connecting rod on the first clutch for imparting rotary motion of the second shaft to the first rockshaft to drive the first drive pulley for training the first chain to coil the first chain round the first drive pulley for lifting the second long arm of the second lever to up and descent the first long arm of the first lever to down.
a tenth gear installed on the end of second cam shaft and it's engaging with the eighth gear for imparting rotary motion of the eighth gear to the second cam wheel through the second cam shaft and the eighth gear having a double diameter of the tenth gear so upon the descent of the first long arm or the second long arm from upper extreme position to the lower extreme position cause the rotation of the first gear or the second gear a quarter rotation and also the first shaft rotates a quarter rotation and because the tenth gear's diameter is a half the eighth gear's diameter this cause the rotation of the second cam wheel a half revolution for performance the desired controls to the reciprocative movement of the first long arm of the first lever and the second long arm of the second lever.
a second cam shaft installed to the gearbox by two shaft bearings for imparting rotary motion of the tenth gear to the second cam wheel for performance the desired controls to the reciprocative movement of the first long arm and the second long arm of the system.
a second cam wheel is mounted on the end of the second cam shaft and the second cam wheel is identical with the first cam wheel and it having about 57% heel and 43% toe and the peripheral edge of second cam wheel is contacting with the second cam plate so the second cam wheel's toe pushes the second cam plate so the second connecting rod imparts this pressure to the second clutch for disimparting the rotary motion of the third shaft to the second rockshaft so the second drive pulley is free rotate to the reverse rotary direction than that of the first drive pulley by the training of the eighth chain for lifting the second long arm and descent the first long arm and on the contacting of the heel of the second cam wheel with the second cam plate, so the second coil spring pushes the second cam plate towards the heel of the second cam wheel for prevention the pressure on the second clutch for imparting rotary motion of the third shaft to the second rockshaft to drive the second drive pulley for training the eighth chain to coil round the second pulley for descent the second long arm of the second lever and lifting the first long arm of the first lever.
a first cam plate is mounted on the end of the first connecting rod and it's contacting with the peripheral edge of the first cam wheel for imparting the pressure of the first cam wheel's toe to the first clutch through the first connecting rod.
a first coil spring is installed on the end of the first connecting rod among the first cam plate and the first cylindrical bearing for pushing the first cam plate towards the peripheral edge of the first cam wheel for remaining the first cam plate contacting with the peripheral edge of the first cam wheel.
a first connecting rod is mounted to the gearbox by the first cylindrical bearing so the first connecting rod is free to slide inside the first cylindrical bearing for imparting the pressure of the first cam wheel's toe to the first clutch for disimparting the rotary motion of the second shaft to the first rockshaft so the first drive pulley is free rotating to the reverse rotary direction than that of the second drive pulley for lifting the long arm to up and descent the second long arm of the second lever to down.
a fifth gear installed on the end of the second shaft and it's engaging with the third gear for imparting rotary motion of the third gear to the first drive pulley through the second shaft, first clutch and first rockshaft with faster rotational speed because the diameter of the fifth gear is smaller than the diameter of the third gear.
a second shaft for imparting rotary motion of the fifth gear to the first clutch.
a first clutch for imparting and disimparting the rotary motion of the second shaft to the first rockshaft, upon the contacting of first cam wheel's toe with the first cam plate, the first connecting rod imparts the pressure of the first cam wheel's toe to the first clutch for disimparting the rotary motion of the second shaft to the first rockshaft and then to the first drive pulley, the first drive pulley is free to rotate into the reverse rotary direction than that of the second drive pulley for lifting the first long arm of the first lever to up and descent the second long arm of the second lever to down and on the contacting of the first cam wheel's heel with the first cam plate, the first coil spring pushes the first cam plate towards the peripheral edge of the first cam wheel for prevention the pressure on the first clutch for imparting rotary motion of the second shaft to the first rockshaft which drive the first drive pulley for training the first chain to wind round the first drive pulley for descent the first long arm to down and lifting the second long arm of the second lever to up.
a first rockshaft having a shaft bearing on the system's base for imparting rotary motion of the first clutch to the first drive pulley which is installed on the end of the first rockshaft and also the first rockshaft is driven to be rotating into the reverse rotary direction by the first drive pulley for lifting the first long arm to up and descent the second long arm to down.
a first drive pulley is installed on the end of the first rockshaft and the first chain is connected with the first drive pulley so on the rotation of the first drive pulley, the first chain winds round the first drive pulley for lift the second long arm to up and descent the first long arm of first lever to down and upon the disimparting the rotary motion of the second shaft to the first rockshaft, the first drive pulley is driven to be rotating to the reverse rotary direction by the training of the first chain for lifting the first long arm to up and descent the second long arm to down.
a second cam plate is mounted on the end of the second connecting rod and the said second cam plate is contacting with the peripheral edge of the second cam wheel.
a second coil spring is installed on the second connecting rod among the second cam plate and the second cylindrical bearing for sliding the second connecting rod towards the heel of the second cam wheel for prevention the pressure of the second connecting rod on the second clutch for imparting rotary motion of the third shaft to the second rockshaft which drives the second drive pulley for lifting the first long arm and descent the second long arm.
a second connecting rod is mounted inside the second cylindrical bearing and it's free to slide into the both two directions for imparting the pressure of the second cam wheel's toe into the second clutch for disimparting the rotary motion of the third shaft to the second rockshaft to be the second drive pulley is free rotating to the reverse rotary direction than that of the first drive pulley for lifting the second long arm of the second lever to up and descent the first long arm of the first lever to down.
a sixth gear is installed on the end of the third shaft and the sixth gear engaging with the fourth gear for imparting rotary motion of the fourth gear to the third shaft with faster rotational speed than that of the fourth gear because the sixth gear having a small diameter than that of the fourth gear for imparting rotary motion to the second drive pulley through the third shaft, second clutch and second rockshaft for lift the first long arm to up and descent the second long arm of the second lever to down.
a third shaft installed to the gearbox for imparting rotary motion of the sixth gear to the second clutch.
a second clutch for imparting and disimparting the rotary motion of the third shaft to the second rockshaft so the said second clutch imparts rotary motion of the third shaft to the second drive pulley for training the eighth chain which coil round the second drive pulley for lift the first long arm to up and descent the second long arm to down on the contacting of the second cam wheel's heel with the second cam plate and the said second clutch disimpart the rotary motion of the third shaft to the second rockshaft on the contacting of the second cam wheel's toe with the second cam plate for rotation the second drive pulley to the reverse rotary direction by the training of the eighth chain which unwind off the second drive pulley for lift the second long arm of the second lever to up and descent the first long arm of the first lever to down.
a second rockshaft having a shaft bearing on the system's base and the second drive pulley is installed on its end, the second rockshaft for imparting rotary motion of the second clutch to the second drive pulley to train the eighth chain for performance the desired controls to the reciprocative movement of the two levers of the system.
a second drive pulley mounted on the end of the second rockshast and it's connected with the end of the eighth chain which coils round the second drive pulley for lift the first long arm to up and descent the second long arm of the second lever to down and the second drive pulley is driven to be rotating to the reverse rotary direction by the training of the eighth chain to unwind off the second drive pulley for lift the second long arm of the second lever to up and dropping the first long arm of the first lever to down.

12- A power generating system-three designs of claim 1 wherein the manual mechanism for change the distance between the weight and the suspension point of the lever comprises,
a first worm installed on the long arm of the first lever by two bearings to be the first worm is free rotating on its bearings and the first worm engaging with the first weight so on the rotation of the first worm causes slide the first weight on the long arm of the first lever for increase or decrease the distance between the first weight and the suspension point of the first lever for controlling to the system's torque.
a second worm installed on the long arm of the second lever by two bearings to be the second worm is free rotating on its bearings and the second worm engaging with the second weight so on the rotation of the second worm causes the sliding of the second weight on the long arm of the second lever for increase or decrease the distance between the second weight and the suspension point of the second lever for controlling to the system's torque and the second worm is identical with the first worm.
a first ratchet device is mounted on the end of first worm and it having a small arm is articulated with U-joint of first boom for rotation the first worm for slide the first weight on the long arm of first lever to increase or decrease the distance between the first weight and the suspension point of the first lever.
a first cogged pulley installed on the first ratchet device and it's interconnected with the third cogged pulley by a first belt for the manual change of the rotary direction of the first worm for increase or decrease the distance between the first weight and the suspension point of the first lever for controlling to the system's torque.
a first boom its lower end having U-joint for articulation with the small arm of the ratchet device and the upper end of first boom acts as male engaged with the female of the lower end of the second boom for rotation the first worm through the first ratchet device.
a second boom its lower end having a female engaging with the male of first boom and the upper end of the second boom having a handle is be used by the operator for rotation the first worm and the second worm through the first ratchet and the second ratchet, the second boom is interconnected with the fourth boom by an arm having the first U-joint which is articulated with the second boom and the other end of the said arm having the second U-joint which is articulated with the fourth boom for imparting the reciprocative movement of the operator's hand to the second ratchet device through the fourth boom and the third boom.
a second ratchet device is installed on the end of second worm which is mounted on the long arm of the second lever for rotation the second worm for sliding the second weight to increase or decrease the distance between the second weight and the suspension point of the second lever for controlling to the system's torque, the second ratchet device having a small arm articulated with the U-joint of the third boom for imparting the reciprocative movement of the operator's hand to the second ratchet device for rotating the second worm.
a third boom its lower end having U-joint for articulation with the small arm of the second ratchet device and the upper end of the third boom having a female engaged with the male of the lower end of fourth boom for imparting the reciprocative movement of the operator's hand to the second ratchet device for rotation the second worm for slide the second weight on the long arm of second lever so the operator can control to the system's torque.
a fourth boom its lower end having a male for engagement with the female of the third boom and the upper end of the fourth boom is articulated with the said second U-joint for interconnection the fourth boom with the second boom through the said arm for imparting the reciprocative movement of the operator's hand to the second ratchet device for rotation the second worm to slide the second weight on the long arm of the second lever for increase or decrease the distance between the second weight and the suspension point of the second lever for controlling to the system's torque.
a second cogged pulley is mounted on the second ratchet device and the said second cogged pulley is interconnected with the fourth cogged pulley by a second belt for change the rotary direction of the second worm by the manual rotation of the fourth cogged pulley for increase or decrease the distance between the second weight and the suspension point of the second lever.
a third cogged pulley is connected with the fourth cogged pulley and they are coaxially mounted so upon the rotation of one of them causes the rotation of the other pulley and a second handle is installed on the flange of the fourth cogged pulley for rotation the third cogged pulley and the fourth cogged pulley and the first belt impart the manual rotary motion of the third cogged pulley to the first cogged pulley for change the rotary direction of the first worm according to the operator's desire and the second belt impart the manual rotary motion of the fourth cogged pulley to the second cogged pulley for change the rotary direction of the second worm.
a first belt having cogs for engagement with the first cogged pulley and the third cogged pulley, two coil springs with equal force are connected the two pieces of the first belt.
a second belt is interconnecting the fourth cogged pulley with the second cogged pulley for imparting the manual rotary motion of the fourth cogged pulley to the second cogged pulley for change the rotary direction of the second worm through the second ratchet device and the second belt having cogs engaging with the cogs of the fourth cogged pulley and with the cogs of the second cogged pulley and it having two coil springs with equal force for remaining the second belt trained upon the reciprocative movement of the second lever.

13- A power generating system-first design of claim 1 wherein two systems of the first design can be combined with each other by a crankshaft which comprises,
a first crank journal is interconnected with the upper end of the first connecting rod for conversion the reciprocative movement of the short arm of the first lever to rotary motion of the said crankshaft and the reciprocative movement of the first lever which is interconnected with the first crank journal is be connected by the first gearbox.
a second crank journal is interconnected with the upper end of the second connecting rod for conversion the reciprocative movement of the second lever's short arm to rotary motion of said crankshaft and the reciprocative movement of the second lever which is interconnected with the second crank journal is be connected by the first gearbox.
a third crank journal is interconnected with the upper end of the second connecting rod and the lower end of the second connecting rod is interconnected with the short arm of the second lever which its reciprocating movement is be controlled by the second gearbox for conversion the reciprocative movement of the second lever to rotary motion of the crankshaft.
a fourth crank journal is interconnected with the upper end of the first connecting rod and the lower end of the first connecting rod is interconnected with the short arm of the first lever which its reciprocative movement is be controlled by the second gearbox for conversion the reciprocative movement of the short arm of the first lever to the rotary motion of the crankshaft.
a first crank arm having an angle 180 degrees with the second crank arm.
a fifth crank arm having an angle 180 degrees with the sixth crank arm.
a third crank arm having an angle 90 degrees with the fourth crank arm for stabilizing the momentum of the system.
a braking rotary member is installed on the said crankshaft for stop the system and also it act as flywheel for stabilizing the momentum inertia of the system.
a braking device installed on the first gearbox or on the system's base for stop the system and the hydraulic line of the said braking device can be connected with the main master of the vehicle's brake so the operator does not need use the clutch's pedal for decrease the vehicle's speed or stop the vehicle.
